(19) United States
(12) Patent Application Publication
(10) Pub. No.: US 2005/0018595 A1
(43) Pub. Date: Jan. 27, 2005

(54) System for applying markings to optical media

(75) Inventors: Jeffrey L. Conroy, Rumford, RI (US); Andrei Smuk, Providence, RI (US); Robert Afzal, Providence, RI (US); Dana Lewis, North Kingstown, RI (US); Allison Berube, Somerset, MA (US)

Correspondence Address: HARRINGTON & SMITH, LLP, 4 RESEARCH DRIVE, SHELTON, CT, 06484-6212, US

(73) Assignee: Spectra Systems Corporation

(21) Appl. No.: 10/665,837

(22) Filed: Sep. 18, 2003

Related U.S. Application Data
(63) Continuation-in-part of application No. 10/165,273, filed on Jun. 6, 2002.
(60) Provisional application No. 60/296,308, filed on Jun. 6, 2001.
(60) Provisional application No. 60/310,914, filed on Aug. 8, 2001.
(60) Provisional application No. 60/311,160, filed on Aug. 9, 2001.

(51) Int. Cl. B05D 5/06

(52) U.S. Cl. 369/288; 264/1.33; 427/162

(57) ABSTRACT

Disclosed herein is a system for recording a marking in the readout area of an optical media, wherein the marking does not interfere, or substantially interfere, with the readout of data from the optical media. The system disclosed herein is supportive of commercial production requirements. Markings may contain content as desired by the user of the system, including text, graphics, or other items. The marking is formed in a photosensitive coating that is applied to the optical media, and then cured with a first light. A second light, having a substantially separate band of wavelengths from the first light, is used to image a marking into the coating. The coating is robust to many external influences, such as ambient environmental conditions, and physical wear.

### CROSS REFERENCE TO RELATED APPLICATIONS

This patent application is filed under 35 U.S.C. §120 as a Continuation-In-Part of and claiming priority to co-pending U.S. patent application Ser. No. 10/165,273 filed Jun. 6, 2002; which in turn claims priority under 35 U.S.C. §119(e) to U.S. Provisional Application Ser. No. 60/296,308 filed Jun. 6, 2001, U.S. Provisional Application Ser. No. 60/310,914 filed Aug. 8, 2001, and U.S. Provisional Application Ser. No. 60/311,160 filed Aug. 9, 2001; this patent application further claiming priority under 35 U.S.C. §119(e) to U.S. Provisional Application Ser. No. 60/412,153 filed Sep. 18, 2002; and, U.S. Provisional Application Ser. No. 60/489,945 filed Jul. 22, 2003. The disclosures of these applications are incorporated by reference herein.

### FIELD OF THE INVENTION

This invention relates to a method and apparatus for rapid production of high quality images upon the read out side of optical media.

### BACKGROUND OF THE INVENTION

Optical media, as typically used today, includes a variety of supplementary information that is in addition to the data recorded in the optical media. The supplementary information is frequently presented in elaborate form, consistent with the marketing, advertising or other goals of the manufacturer. The supplementary information may be included in various fashions, such as through the use of stick on labels, inks or through other techniques.

Considering that approximately 1 billion DVDs and more than 4 billion CDs are produced annually (as estimated by the International Recording Media Association), the potential advertising space has been equated to 1 billion magazine advertising pages, 300 million newspaper advertising pages, or 3 million billboards. Accordingly, the value of incorporating markings into the readout side of optical media is very high.

Labeling or markings are typically applied to the “non-read” side of a disc, such as a CD ROM or a DVD, for indicating information such as the source of the disc and a listing of the information recorded thereon. The placement of markings on the non-readout side of optical media permits the use of a variety of marking technologies, ranging from simple to complex. Placement of markings on the read-side of optical media, particularly in the area where data is recorded, is a greater challenge, as the markings can interfere with the use of the optical media.

A need for further advanced marking schemes exists. This need is growing rapidly with changes in optical media technology. For example, certain embodiments of DVD optical media, DVD-10 and DVD-18, call for recordation and presentation of digital data on both sides of the optical media. As a result, manufacturers have therefore been unable to incorporate any traditional and durable label or marking on the optical media.

Prior attempts to accomplish this task have been made. Reference may be had to U.S. patents directed towards optical storage systems. For example, U.S. Pat. No. 5,549,953, entitled “Optical Recording Media Having Optically-Variable Security Properties” by Li Li, issued Aug. 27, 1996, discloses a technique to prevent counterfeiting of various substrates through introducing thin film structures having optically variable security properties and encoded optical data. Another U.S. Pat. No. 5,510,160, entitled “Optical Storage Media Having Visible Logos”, by Sullivan, et al., issued on Apr. 23, 1996. This patent also discloses a technique to prevent counterfeiting of optical storage media, specifically through producing a visible logo on the read side of the substrate. Although these patents provide for incorporation of markings that may have certain advantages, any advantages are limited. That is, for example, the markings are visible only under certain conditions, and complicated or expensive manufacturing processes are called for to produce finished product. Furthermore, the degree of control, or complexity of the marking may be less than desired for effective advertising or other information bearing schemes.

Other examples of a coating applied to an optical media, can be found in U.S. Pat. No. 6,051,298 “Optical Disc Having Protective Films.” This patent discloses an optical disc having a protective film, the film having good transmissivity and high hardness against abrasion, and in U.S. Pat. No. 6,322,868 B1 “Use and Manufacturing Applications of Polymer/Dye-Based Thin Layer Coatings for Enhancement of the Quality of Recording On and Readout From the Optical Storage Media,” which discloses use of a thin layer coating for the improvement of the quality of the encoded digital information. Another example includes commonly owned U.S. Pat. No. 6,338,933 “Methods and Apparatus for Rendering an Optically Encoded Medium Unreadable.” This patent discloses including optically activated materials to degrade the reflectivity of a surface.

However, the foregoing patents have not taken advantage of certain advances in materials. For example, reference may be had to International Patent Publication No.: WO 02/101462 A1 “Laser Marking Method” published on 19 Dec. 2002, applied for by Ciba Specialty Chemicals Holding Inc. This publication discloses a method of coloring a polymeric material containing a latent acid, a Colorformer, and optionally further ingredients by irradiation with UV-light. Another International Patent Publication No.: WO 02/100914 A2, applied for by Ciba Specialty Chemicals Holding Inc., is entitled “Polymeric Material, Containing a Latent Acid.” This publication discloses a polymeric material containing a latent acid which can be converted to an acid by irradiation by a laser and optionally further ingredients.

Another example is disclosed in U.S. Pat. No. 5,028,792 “System for the Visualization of Exposure to Ultraviolet Radiation,” issued Jul. 2, 1991 to Mullis. This patent discloses photochemical systems for the direct visualization of exposure to ultraviolet radiation, in which a photoacid is formed upon irradiation with ultraviolet light and causes a dye to undergo a visible color change. However, use of these materials is not suited for optical media, as these materials are polymerized with color formers subsequently added. Accordingly, these materials are not cured in place, which is necessary for aspects of manufacturing of optical media.

One further example is disclosed in U.S. Pat. No. 5,885,746 “Photosensitive Resin Composition, Photosensitive Printing Plate Using the Same and Method of Manufacturing Printing Master Plate,” issued Mar. 23, 1999 to Iwai, et al. This patent discloses a photosensitive resin composition comprising a high polymer binder, a monomer, a photopolymerization initiator generating a radical on exposure to visible light, and an optically activated acid generating agent, generating an acid on exposure to wavelengths of 200 nm to 380 nm, with a color former developing color in the presence of an acid. Among other things, this patent discloses use of dispersing agents, which indicate inhomogeneity, a property that would cause laser scatter in an optical media readout system. Also, the initiators disclosed in this patent are sensitive to visible light and require the use of an oxygen barrier layer to affect adequate curing. Use of an oxygen barrier layer is a substantial hindrance to the application of these materials to quantities of optical disc, as manufacturing environments do not typically provide for a dark and/or oxygen free environment. Further such additional steps present economic and production burdens that would serve to limit use of the marking system.

Therefore, a need exists to provide enhanced marking, identification, authentication and encoding capabilities for media containing optically readable information. More specifically, a need to rapidly produce images, text, or other optically encoded information on the label and/or read side of optical media exists. Furthermore, this method should not interfere with the performance of data readout from the optical media. The system providing these capabilities should further provide for markings that are robust and durable in environments where optical media may be used.

A need also exists to provide a system for manufacturing optical media or disks that addresses the foregoing need for enhanced marking, identification, authentication and encoding capabilities.

### SUMMARY OF THE INVENTION

The foregoing and other problems are overcome by methods and apparatus disclosed herein and in accordance with embodiments of this invention.

Method and apparatus for imparting images upon the readout and/or non-readout side of optical media such as CDs and DVDs are disclosed. Aspects of the invention include, but are not limited to: applying certain materials as a coating, or coatings, onto an optical media; curing the coatings with a first light, such as ultraviolet (UV) light; addressing each of the coatings with certain wavelengths of a second light, such as UV, infrared (IR), or near infrared (NIR); and using selective exposure of the coatings to the certain wavelengths of second light to record an image in the collective appearance of the coatings.

Aspects of the invention include application of the coating, or coatings, and the marking upon the read side or the non-read side of the optical media, without loss, or substantial loss, of the functionality of the media.

Further aspects of the invention include a single or multi-color image, or marking, formed in the collective appearance of the coatings, where the marking may be produced in a form that is transmissive, or substantially transmissive of wavelengths of interest. For example, the marking is transmissive to readout wavelengths used in the readout of the optical media marked with the color image.

Aspects of the invention may further include, but are not limited to, the use of coatings that absorb or reflect light at predetermined wavelengths, the use of multiple markings, and the use of the markings as security measures.

Further aspects of the invention include providing for the use of the read side of the optical media for marking with advertising, branding, and other markings normally associated with the non-readout side of the media.

Aspects of the apparatus involved in the production of coated optical media suited for receipt of a marking as disclosed herein include, but are not limited to, integrated optical media production equipment, where the integrated equipment incorporates appropriate modifications in support of the embodiments described herein. Alternatively, apparatus may involve use of manual or semi-automated techniques for generation of coated optical media, and the markings thereon.

Further aspects of the invention also include use of examination and inspection techniques for qualifying and/or controlling various facets of optical media production. For example, manufacturing may include processes for assessing the optical quality of the coating prior to marking. Alternatively, manufacturing may involve examining aspects of a statistically significant portion of finished product for quality. For example, a CCD camera and processor, or equivalent apparatus, may be employed to image and compare the appearance of various features in a production marking to data records describing the desired appearance quality of the respective features.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is a cross-sectional diagram of a prior art optical media;

FIG. 2 is a cross-sectional diagram of an optical media having a coating in accordance with the teachings herein

FIG. 3 depicts an absorbance curve for a color former in a coating formulation;

FIG. 4 compares background color formation in various compositions;

FIG. 5 depicts absorbance spectra for two photoacid generators;

FIG. 6 depicts a UV absorption spectra for a first photoinitiator;

FIG. 7 depicts a UV absorption spectra for a second photoinitiator;

FIG. 8 depicts a line spectrum for a medium pressure iron-doped lamp;

FIG. 9 depicts a line spectrum for a gallium iodide lamp;

FIG. 10 depicts a line spectrum for a xenon gas filled lamp;

FIG. 11 depicts transmission curves for various filters;

FIG. 12 depicts absorbance peaks at 540 nm for various concentrations of a color former;

FIG. 13 depicts absorbance peaks at 540 nm for various concentrations of triphenyl sulfonium triflate;

FIG. 14 average color decrease in a first environmental study;

FIG. 15 depicts reductions in surface tension as a function of concentrations of various wetting agents;

FIG. 16 depicts average absorbance of various formulations after environmental testing;

FIG. 17 depicts average decrease in optical density for various formulations after environmental testing;

FIG. 18 depicts a storage case laden with filter paper;

FIG. 19 depicts fading in color resulting from TEA exposure;

FIG. 20 depicts the development of color as a function of exposure wavelength;

FIG. 21 depicts development of color in samples containing UV absorbers;

FIG. 22 depicts the effect of adding UV absorbers on color generation;

FIG. 23 depicts color formation in UV stabilized formulations;

FIG. 24 depicts color formation in a particular sample of a UV stabilized formulation;

FIG. 25 depicts results of a study adjusting ratios of color former and photoacid generators;

FIG. 26 depicts color level and sensitivity as a function of photoacid generator concentration and film thickness;

FIG. 27 depicts the absorbance of a CN-120 based formulation;

FIG. 28 compares absorbance spectra for various UV absorbers;

FIG. 29 depicts color formation times for combinations having various photoacid generators;

FIG. 30 depicts aspects of color generation as a function of photoacid generator;

FIG. 31 depicts color formation as a function of illumination type;

FIG. 32 depicts color formation as a function of UV absorber;

FIG. 33 depicts color formation as a function of illumination fluence;

FIG. 34 depicts color formation as a function of additives for enhancement;

FIG. 35 depicts color formation in a buffered system;

FIG. 36 depicts film thickness as a function of spin speed;

FIG. 37 depicts film thickness and optical density as a function of spin speed;

FIG. 38 depicts film thickness and optical density as a function of spin speed;

FIG. 39 depicts color formation for varying ratios of photoacid generator to color former;

FIG. 40 depicts a cross section of an optical media having a color forming layer and a overcoat layer;

FIG. 41 depicts optical density for two coatings;

FIG. 42 depicts color formation as a function of time one geometry;

FIG. 43 depicts absorbance spectra for three embodiments of overcoat layers;

FIG. 44 depicts residual sensitivity in a two coating system;

FIG. 45 depicts lightfastness in exposed areas;

FIG. 46 depicts color development from environmental testing;

FIG. 47 depicts environmental color retention;

FIG. 48 depicts fading from an amine study;

FIG. 49 depicts film thickness as a function of spin speed;

FIG. 50 depicts viscosity as a function of temperature;

FIG. 51 depicts a shear rate profile;

FIG. 52 depicts a shear stress and shear rate profile;

FIG. 53 depicts viscosity for a constant shear rate;

FIG. 54 depicts color formation for a set of photoacid generators and color formers;

FIG. 55 depicts color formation for a set of photoacid generators and color formers;

FIG. 56 depicts color formation for a set of photoacid generators and color formers;

FIG. 57 depicts color formation for a set of photoacid generators and color formers;

FIG. 58 depicts a comparison of light sources;

FIG. 59 depicts a comparison of light sources;

FIG. 60 depicts color formation as a function of fluence;

FIG. 61 depicts residual sensitivity of coating with various UV absorbers;

FIG. 62 depicts the optical density of exposed regions as a function of UV absorber;

FIG. 63 is a cross section of an optical media having multiple layers applied over the reflective layer;

FIG. 64 is a cross section of an optical media having multiple layers applied over the reflective layer;

FIG. 65 is a cross section of an optical media having multiple layers applied over the reflective layer;

FIG. 66 is a graph depicting absorbance curves for orange and red color forming layers;

FIG. 67 is a graph depicting absorbance curves for a multicolor embodiment’

FIG. 68 is a graph depicting absorbance where only a top color forming layer is exposed;

FIG. 69 is a graph depicting absorbance in a multi-color system having a UV blocking layer;

FIG. 70 is a partial view of photomask showing a shading technique;

FIG. 71 depicts markings on an optical media formed by illumination with a marking lamp;

FIG. 72 depicts an inspection apparatus for evaluating markings;

FIG. 73 depicts aspects of the inspection apparatus;

FIG. 74 depicts test data for an uncoated disk;

FIG. 75 depicts test data for a coated disk;

FIG. 76 depicts test data for a coated disk with at least one image recorded thereon;

FIG. 77 depicts aspects of one embodiment for a production system for application of a single color forming layer;

FIG. 78 depicts aspects of another embodiment for marking an optical media;

FIG. 79 depicts aspects of a production system for applying a two coating system;

FIG. 80 depicts an apparatus for applying multiple coatings;

FIG. 81 depicts an apparatus for manual curing of a coating on an optical media;

FIG. 82 depicts an offline marking system for marking coated optical media; and,

FIG. 83 depicts test data for an optical media produced in a production system.

### DETAILED DESCRIPTION OF THE INVENTION

The teachings herein describe a coating, or a series of coatings, for application of at least one gray scale, single color or a multi-color marking to an optical media such as a CD (compact disc) or a DVD (digital versatile disc). Also disclosed are aspects of a system for the production of optical media characterized by these markings. Aspects of the invention include, but are not limited to: applying certain materials as a coating, or coatings, onto an optical media; curing the coatings with a first light, such as ultraviolet (UV) light; addressing each of the coatings with certain wavelengths of a second light, such as UV, and using selective exposure of the coatings to the certain wavelengths of second light to record an image in the collective appearance of the coatings. Additional layers of coatings may be added, and aspects of the process repeated, as warranted. Further aspects of the teachings herein include techniques for the inspection of coated optical media, and production thereof.

Preferably, the optical media marked in accordance with the teachings herein are produced in a mass production environment. Accordingly, the disclosure herein is directed toward accommodation to the demands of a mass production environment. For example, mass production environments typically demand minimal production time, and therefore require quick curing and image formation. It should be recognized that some of the embodiments disclosed herein may be further modified to accommodate other production models, such as single unit production, and make take advantage of longer curing times, or alternative imaging techniques. Such modified embodiments are considered to be a part of the teachings herein, and described by the appended claims.

The disclosure herein is presented in the following sections:

I. Coating for Optical Media

A. Single Coating Development
1. General Formulation
2. Photoacid Generator Screenings
3. Considerations for Curing
4. Oxygen Inhibition
5. Colors and Imaging
6. Environmental Influence
7. Triethyl Amine Fading Study
8. Accelerated Light Testing
9. Photoacid Generators Reexamined
10. Absorbance Spectra of Photoacid Generators and Films
11. Photoacid Generator Screening For Imaging Speed
12. Color Enhancing Additives
13. Spin Coating, Film Thickness and Optical Density.

B. Multiple Coating Development
1. Color Coating and Overcoat Development
2. Initial Testing
3. Environmental Testing
4. Adjustments to two coating formulations
5. Amine Testing
6. Quantitative Study
7. Physical properties of the coatings
8. Viscosity vs. Temperature
9. Viscosity vs. Shear Rate
10. Color formation with various lamps.
11. Photoacid Generator to Color Former Ratio
12. Lamp Effects
13. Overcoating: Light Fastness of the Overcoat with Various UV Absorbers

C. Embodiments of Coatings on Optical Media
1. Two Layer Coating
2. Multiple Layer Coating
3. Multi-Color Disc
   II. Forming a Marking

A. Equipment for Forming a Marking

B. Types of Markings

III. Coating Inspection

A. Exemplary Inspection Equipment

B. Coating Parameters and Radial Noise Study

C. Inspection Techniques

IV. Systems for Manufacturing

A. Exemplary Production Equipment

B. Exemplary Offline Production Equipment

C. Singulus Skyline Duplex Coating Parameters and Radial Noise

D. Singulus SKYLINE DUPLEX and Lamp Curing

1. Coating for Optical Media

The coating, as disclosed herein, is suited for incorporation into various components of optical media. It is recognized that a variety of optical media exist, and that many have a structure that differs, at least partially, from other optical media. Therefore, this disclosure teaches what are to be considered non-limiting embodiments of incorporating a coating into an optical media. That is, this disclosure does not provide an exhaustive disclosure of incorporation of the coating into optical media.

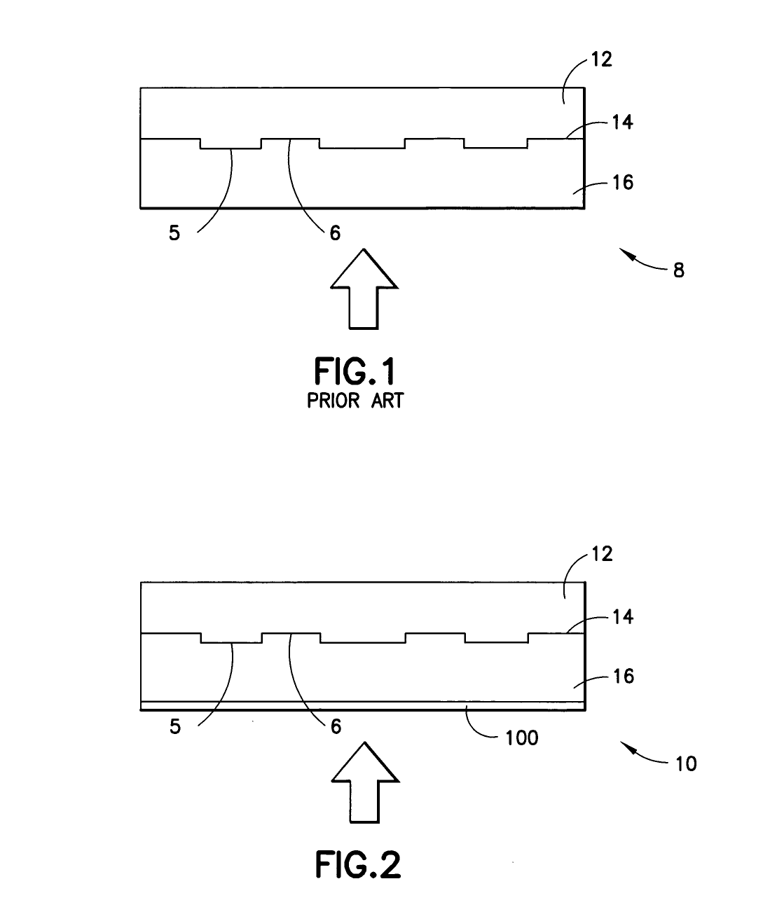

FIG. 1 discloses aspects of an exemplary optical media. In FIG. 1, a prior art optical media 8 is shown. The optical media 8 includes various layers, which may be referred to herein as “components” of the optical media 8. The substrate layer 16 is molded with pits 5 and lands 6 (data features), and is typically formed of polycarbonate or similar transmissive plastic material. A reflective layer 14 is deposited on the data features to enable readout by an interrogating laser. A protective layer 12 is one component that is typically included to ensure the integrity of the reflective layer 14 and is typically formed of a UV curable acrylate coating or similar material. The disc may be read through the substrate layer 16, as indicated by the directional arrow in FIG. 1. Typically, printing or other indicia are placed over the protective layer 12.

FIG. 2 provides an illustration of the cross section of an optical media 10 with a first and introductory embodiment of a coating 100 applied thereon. In this illustration, the optical media 10 includes a reflecting (reflective) layer 14 and a substrate layer 16. In typical embodiments, the substrate layer 16 is formed of polycarbonate, while the reflecting layer 14 is metallized (has a reflective metal applied thereon). It is recognized that aspects of the reflecting layer 14 and a substrate layer 16 are typically dictated by the specifications for the optical media 10, and therefore are generally not discussed further herein. The discs 10 typically contain pits 5 and lands 6 as data features. As disclosed herein, preferably, the coating 100 is applied over the substrate 16 of the optical media 8. In some embodiments, aspects of the substrate layer 16 may be adjusted to account for subsequent preparation of the coating 100. For example, the substrate layer 16 may be installed with a reduced thickness as determined by reference to a manufacturer's specification for the type of optical media 8. Subsequent installation of the coating 100 is then used to increase the thickness of the optical media 10 to meet the desired thickness specification.

The coating 100 contains color forming materials necessary for generation of a color image. The color forming materials may be configured in a variety of ways, to be discussed further herein. The color forming materials may be used to develop a gray scale, single color, or multi-color marking. The coating 100 does not interfere, or substantially interfere, with the readout of the optical media 10. That is, the coating 100 and any markings recorded in the coating 100, do not appreciably absorb or scatter light at the readout wavelength of the optical media readout laser. Likewise, the thickness and other aspects of the coating 100 do not substantially interfere with the readout mechanism. Accordingly, the coating 100 may be applied to the “play” side 16 or “non-play” side 12 of the optical media 10 depicted in FIG. 2.

The coating 100 contains what can be referred to as two “sets” of photosensitive materials. One set of photosensitive materials provides for curing of the coating 100 once the coating 100 is in place. That is, exposure to one set of wavelengths provides for curing of the first set of photosensitive materials. A second set of photosensitive materials in the coating 100 exhibits optical changes upon adequate exposure to a separate set of wavelengths. Thus, the coating 100 may contain photoinitiators to initiate crosslinking. The coating 100 may include, but is not limited to, compounds such as photoacid or photobase generators, acid or base sensitive dyes, leucodyes, metal chelates, fluorescent dyes, or laser dyes. The coating 100 may be colored or colorless to the eye, and may be fluorescent under certain electromagnetic radiation. Fluorescent emission wavelengths may include, but are not limited to, a wavelength in the visible region.

Commonly used readout light wavelengths for the optical media 10 include 408 nm, 440 nm, 630 nm, 650 nm, and 780 nm, while other readout wavelengths are possible.

Although disclosed herein in terms of photosensitive materials responsive to wavelengths of ultraviolet light (UV), the coating 100 may include materials that are photosensitive to any band of wavelengths (also referred to as a “set of wavelengths”). For example, the photosensitive materials may be responsive to UV-A, UV-B, UV-C, VIS (visible wavelengths), short wavelength infrared (IR), IR, or long wavelength IR. As one may surmise, having two sets of photosensitive materials provides for use of two sets wavelengths to initiate the changes in the coating 100 as described herein. It is considered that other formulations, not discussed herein, may advantageously make use of wavelength separation over the spectrum of useful wavelengths. Accordingly, the teachings herein are not limited to the exemplary embodiments herein, which merely provide one example of a system for applying markings to optical media.

“Optical media” are referred to herein in general terms, such as “CD” or “DVD.” However, it is considered that optical media 8 encompass many different media formats. For example, the many formats of optical media 8 include: DVD 5, DVD 9, DVD 10, DVD 14, DVD 18, DVD-R, DVD-RW, CD-Audio, CD-Video, CD-R, CD-RW, CD-ROM, CD-ROM/XA, CD-i, CD-Extra, CD-Photo, Super-Audio CD, Mini-Disc a hybrid format, which may include any-one or more of the foregoing, Blu-Ray, and others. It is recognized that this is not an exhaustive list, and should therefore only be considered illustrative of the variety of optical media formats that may benefit from the use of this invention.

A. Single Coating Development

Aspects of the development of the coating materials are now presented. Some embodiments disclosed herein are results of experimentation. One skilled in the art will recognize that some embodiments provide certain advantages in certain settings over other embodiments. Further embodiments may also be developed. Therefore, it should be recognized that the formulations and the processes for making and applying a coating are illustrative and not limiting of the invention herein.

1. General Formulation

Early attempts to make a photosensitive color forming lacquer originated with a combination of acrylates, a photoinitiator, a photoacid generator (PAG), and a color former. One of the first formulations that was considered to show desired properties was composed of about 3% of a photoacid generator (PAG), about 3% of a color former, and about 94% of a mixture, referred to as a “coating base.” The coating base was formed of a mixture that included an acrylate and a photoinitiator. Presently preferred embodiments of the coating base are generally a mixture of acrylated monomers and oligomers, wetting agents, and a photoinitiator. The color former and the photoacid generator, referred to as the “imaging components” are added to the coating base.

Initial experimentation with the development of suitable coating base materials involved an acrylate combination where SR-494 and SR-238 were mixed in about equal quantities. A photoinitiator, ESACURE KTO-46, was added to the acrylate combination so as to be about 10% of the first coating base.

The chemical equivalents of these materials being: SR-494 is an ethoxylated (4) pentaerythritol tetraacrylate; SR-238 is a 1,6 hexanediol diacrylate having a low viscosity, fast curing monomer with low volatility, a hydrophobic backbone, and good solvency for use in free radical polymerization; and, ESACURE KTO-46 is a stable liquid mixture of trimethylbenzoyldiphenylphosphine oxide, α-hydroxyketones, and benzophenone derivatives. ESACURE KTO-46 is a liquid photoinitiator that can be incorporated by simply stirring into a resin system, and is insoluble in water and is soluble in most common organic solvents and monomers. KTO-46 may also be referred to as including ESACURE KIP-150 and ESACURE TZT. The equivalent of ESACURE KIP-150 being an: oligo [2-hydroxy-2-methyl-1-[4-(1-methylvinyl) phenyl] propanone]; and ESACURE TZT being an eutectic liquid mixture of: 2,4,6 trimethylbenzophenone and 4 methylbenzophenone.

ESACURE KTO-46, ESACURE KIP-150 and ESACURE TZT are produced by Lamberti Spa, Gallarate-Va, Italy. SR-494 and SR-238 are products of Sartomer Corporation of Exton, Pa. KTO-46 is also marketed by Sartomer Corporation as SARCURE-1135 (therefore, KTO-46 and SR-1135 are used interchangeably herein).

Investigation of the properties of coatings 100 using the first coating base revealed certain disadvantages. That is, it was considered that a finished product formed from the first coating base did not exhibit a desired degree of surface hardness, and had a potential for skin irritation. Therefore, further components were evaluated for use in the coating base. Table 1 shows aspects of the components selected for the coating base, and includes certain performance characteristics thereof.

TABLE 1
Coating Base Components

| Component | Performance Characteristics |
|---|---|
| SR-494 | Fast cure response/good hardness |
| SR-238 | Fast cure response/good adhesion |
| SR-285 | Low viscosity/improves color |
| SR-9021 | Fast cure response/excellent hardness |
| KTO-46 | Good surface cure/good through cure |

SR-285 is tetrahydrofurfuryl acrylate that is a low viscosity, polar, monofunctional monomer, which contains a cyclic group, and promotes adhesion to numerous substrates; and SR-9021 is a highly propoxylated (5.5) glyceryl triacrylate, that is a low skin irritation trifunctional monomer offering low viscosity, good flexibility, fast curing, and excellent hardness. SR-285 and SR-9021 are products of Sartomer Corporation of Exton, Pa.

SR-494 and SR-9021 were selected for use in the coating base due to high functionality, low surface tension, fast surface and through cure response, adhesion, and hardness. These components were also considered advantageous as alkoxylation reduced a propensity to irritate skin. In contrast, SR-238 and SR-285 were skin irritants, but did offer desirable solvation of additives and swell polycarbonate for good adhesion. SR-238 and SR-285 also exhibit low viscosity, which provided an opportunity to tailor the viscosity of the coating base. KTO-46 was selected for use as a photoinitiator, as KTO-46 is considered to be substantially sensitive to long wavelengths of ultraviolet light (i.e., above about 320 nm up to about 400 nm).

Experiments further revealed that applying the coating 100 to an optical media 10 could be achieved by various techniques. Preferably, the coating 100 is applied by spin coating. However, during initial applications of the coating 100 by use of spin coating, the edges of the optical media 10 occasionally exhibited coverage that was less than desired. It was determined that this was due to the high surface tension of the lacquer (coating base). Therefore, wetting agents were added to the coating base to improve substrate wetting and lower the surface tension were.

Exemplary systems for spin-coating formulations onto the substrate 16 include those available from Headway Research, Inc. of Garland, Tex. Aspects of a system used herein for applying formulations by spin-coating processes includes: controls for adjusting formulation temperature, controls for varying spin speeds in increments, with a maximum spin speed of at least 10,000 (10K) rpm. Systems may further include aspects such as environmental controls for controlling ambient gases, as well as formulation recovery apparatus for recycling unused formulation. Other systems may be used for spin coating, and may further be integrated into mass production apparatus. One model suited for applications of the formulations herein, at least in small batches, is model PWM32-PS-R790 Spinner System, used for aspects of testing as described herein. As systems for spin coating are known, these systems are generally only described further herein in terms of application of the coating 100, and requirements thereof.

Formulations were made with all of the new components (Table 1) to see how they affected the performance of the coating 100. Wetting agents were included in the new formulations to improve distribution of the formulations over the discs 10. The wetting agents tested were BYK-307 and BYK-333, both agents being polyether modified poly-dimethyl-siloxanes, and exhibiting similar properties for reducing surface tension. BYK-307 and BYK-333 are products of BYK-Chemie, of Wesel Germany, and distributed in the US by BYK-Chemie USA, of Wallingford, Conn. Table 2 shows the formulations and results.

TABLE 2
Modified Coating Base Formulations

| Component | Control | 1 | 2 | 3 | 4 | 5 | 6 | 7 | 8 | 9 |
|---|---|---|---|---|---|---|---|---|---|---|
| SR-494 | 45.00 | 32.50 | 32.45 | 32.35 | 32.25 | 32.00 | 31.50 | 32.48 | 32.45 | 32.43 |
| SR-9021 | | 32.50 | 32.45 | 32.35 | 32.25 | 32.00 | 31.50 | 32.48 | 32.45 | 32.43 |
| SR-238 | 45.00 | 10.00 | 10.00 | 10.00 | 10.00 | 10.00 | 10.00 | 10.00 | 10.00 | 10.00 |
| SR-285 | | 15.00 | 15.00 | 15.00 | 15.00 | 15.00 | 15.00 | 15.00 | 15.00 | 15.00 |
| KTO-46 | 10.00 | 10.00 | 10.00 | 10.00 | 10.00 | 10.00 | 10.00 | 10.00 | 10.00 | 10.00 |
| BYK-333 | | | 0.10 | 0.30 | 0.50 | 1.00 | 2.00 | | | |
| BYK-307 | | | | | | | | 0.05 | 0.10 | 0.15 |
| Surface Tension | 42.67 | 42.83 | 30.67 | 28.33 | 27.00 | 26.67 | 26.67 | 31.50 | 30.33 | 30.67 |
| (dynes/cm) | | | | | | | | | | |
| Viscosity (cP) | 36.50 | 51.50 | 46.40 | 48.00 | 49.90 | 53.80 | 53.80 | 47.70 | 48.30 | 49.60 |

In Table 2, the composition of a total of ten formulations is shown. The first coating base is shown as the Control, with subsequent formulations shown as mixtures 1-9. Quantities of each component in each of the ten compositions are expressed in weight percent of the total mixture.

The results show that the formulations including wetting agents exhibited reduced surface tension over formulations without a wetting agent. This was considered to be advantageous since formulations having lower surface tensions should coat the substrate 16 better than those formulations with higher surface tension. It was noted that after the addition of 0.3% BYK-333 and after 0.05% BYK-307, the surface tension of the formulation did not change significantly. Therefore, formulations 3 and 7 were tested physically by spincoating the coating base onto various discs 10 and inspecting the edges of the substrate 10. Upon inspection, formulation 3 was found to coat the discs 10 the best while increasing the surface slip significantly. It was noted that the viscosities of the various formulations did not change drastically between samples 1 through 9. As a result, formulation 3 was selected as a preferred coating base.

Shortly after this experiment, it was found that SR-9021 could be used interchangeably with SR-9020, since both had similar properties. This was considered to be advantageous since SR-9020 offers higher thermal stability than SR-9021. Therefore, SR-9020 was substituted into formulation 3. SR-9020 is a 3 mole propoxylated glyceryl triacrylate, that is a trifunctional monomer offering low viscosity, good flexibility, fast curing, and excellent hardness. SR-9020 is a product of Sartomer Corporation.

At about the same time, a number of formulations with different acrylates were made in order to find a lacquer that would produce a harder coating. New components for formulations and aspects of their performance are shown in Table 3, while the formulations and viscosity results are shown in Table 4.

TABLE 3
Possible New Formulation Components

| Component | Performance Characteristics |
|---|---|
| SR-9020 | Higher Tg version of SR-9021 |
| SR-454 | Fast cure response/good hardness high Tg |
| SR-368 | Adhesion promoter/abrasion resistance |
| SR-355 | High Tg replacement for SR-494 |
| CN-983 | A hard urethane acrylate |

The components given in Table 3 are trade names of the Sartomer Corporation used for: propoxylated (3) glyceryl triacrylate (SR-9020); ethoxylated (3) trimethylolpropane triacrylate (SR-454); tris (2-hydroxyethyl) isocyanurate triacrylate (SR-368); di-trimethylolpropane tetraacrylate (SR-355); and, urethane acrylate (CN-983).

TABLE 4
Possible Formulations and Viscosity
Results for Improved Hardness

| | Control | | | | | | | |
|---|---|---|---|---|---|---|---|---|
| Component | (3) | 10 | 11 | 12 | 13 | 14 | 15 | 16 |
| BYK-333 | 0.3 | 0.3 | 0.3 | 0.3 | 0.3 | 0.3 | 0.3 | 0.3 |
| KTO/46 | 10 | 10 | 10 | 10 | 10 | 10 | 10 | 10 |
| SR-238 | 10 | 10 | 10 | | | 10 | 10 | |
| SR-285 | 15 | 15 | 15 | 10 | 10 | 15 | 15 | 15 |
| SR-494 | 32.35 | 32.35 | 32.35 | 34.85 | 34.85 | | | 25 |
| SR-9021 | 32.35 | | | | | | | |
| SR-9020 | | 32.35 | | | 34.85 | | 32.35 | |
| SR-454 | | | 32.35 | 34.85 | | 32.35 | | 29.7 |
| SR-368 | | | | 10 | 10 | | | |
| SR-355 | | | | | | 32.35 | 32.35 | |
| CN-983 | | | | | | | | 20 |
| Viscosity | 42.65 | 41.61 | 37.92 | 76.85 | 82.95 | 45.36 | 57.33 | 96.95 |
| (cP) | | | | | | | | |

Upon inspection of spun coat, cured samples, it was found that formulations 10 and 14 were significantly harder than the control (formulation 3) while still exhibiting similar viscosities. Formulations 10 and 14 were then subjected to a number of tests, which made up a New Formulation Screening Test shown in Table 5. In preferred embodiments, each formulation must pass this screening to be considered as a possible base for the coating 100. Table 5 shows the tests involved as well as the criteria.

TABLE 5
New Formulation Screening Tests

| Test | Description | Uncured | Cured | Notes |
|---|---|---|---|---|
| UV-VIS | 190-800 nm, quartz | X | X | Background color |
| | | | | (<0.05 AU at peak) |
| Viscosity | ASTM | X | | <100 cP @ 25 C. |
| Surface Tension | Tensiometer | X | | <33 dynes/cm |
| Pencil Hardness | ASTM | | X | >=2B |
| Curing Time | Xenon lamp ˜1″ | X | | <3 secs to full |
| | away with filter | | | hardness |
| Color Formation | Xenon lamp ˜10″ | | X | <10 secs to 0.5 AU |
| Time | away without filter | | | at peak, 3% CF/PAG |

Two new formulations passed the New Formulation Screening Test as Table 6 shows. Formulation samples 10 and 14 were considered for future use and more in-depth tests.

TABLE 6
Two Formulations Passing the New Formulation Screening Tests

| Test | 10 | | 14 | |
|---|---|---|---|---|
| UV-VIS | 0.0315 | AU at 3 sec | .0189 | AU at 2 sec |
| Viscosity | 41.61 | cP | 45.36 | cP |
| Surface Tension | 28.83 | dynes/cm | 28.33 | dynes/cm |
| Pencil Hardness | 2 | B | 2 | B |
| Curing Time | 3 | sec | 2 | sec |
| Color Formation | 0.5501 | AU at 10 sec | 0.5579 | at 10 sec |

2. Photoacid Generator Screenings

Photoacid generators (PAGs) are added to develop the color in the coating 100 once exposed to wavelengths of light. This process involves generation of acid by the PAG when exposed to the wavelengths of light. In turn, an acid sensitive color former (CF) interacts with the acid, and forms color. Preferably, the PAG is sensitive to ultraviolet light.

A number of photoacid generators were examined to find one that would work appropriately in the coating 100. In order to compare the various PAGs, each formulation was prepared the same way. Sought after aspects of PAG performance included adequate acid production for desired color formation, and stability in post color formed environments.

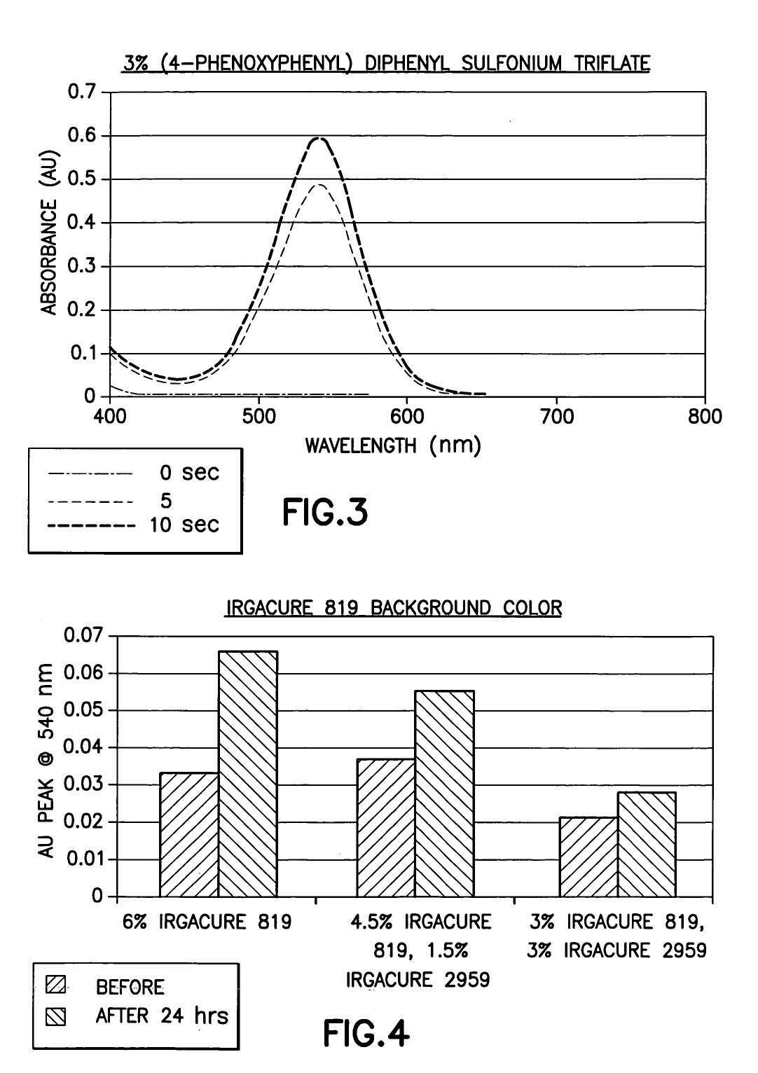

Coating base samples were made by mixing the original control formulation (45% SR494, 45% SR-238, and 10% KTO/46). This mixture was added at 94% to a 3% concentration of COPIKEM 16 Red (a color former) and a 3% concentration of each of the photoacid generators to be investigated. The lacquers were spun coat onto blank, un-metallized polycarbonate substrate 16 for 15 seconds at 4K rpm. Each disc 10 was then placed under a pulsing XENON lamp with a double paned window glass filter for 5 seconds. The resultant disc 10 had a coating that was clear, dry, and hard. A portion of the disc 10 was then exposed for 5 seconds. Another portion of the disc 10 was exposed for 10 seconds. This produced a red color on the clear disc 10 with intensities varying between the different portions of the disc 10. To quantitatively measure the intensity of the color formed in the exposed discs 10, absorbance curves were recorded on a spectrometer. The spectrometer used was a UV/VIS model called LAMBDA 2, produced by Perkin Elmer Corporation, of Boston, Mass. The data produced revealed that the absorbance peaks of formulations containing COPIKEM 16 Red occur at about 540 nm. A typical absorbance curve is shown in FIG. 3. The results are shown in Table 7. Note that in Table 7, zero seconds measured the intensity of the background color.

TABLE 7
Photoacid Generator Results Using Control Formulation

| | AU, 540 nm | AU, 540 nm | AU, 540 nm |
|---|---|---|---|
| 3% Photoacid Generator | 0 sec | 5 sec | 10 sec |
| Bis (4-tert-butylphenyl) iodonium p-toluenesulfonate | — | 0.0834 | 0.0864 |
| (tert-Butoxycarbonylmethoxynaphthyl) diphenyl sulfonium triflate | 0.0151 | 0.4896 | 0.6639 |
| (4-phenoxyphenyl) diphenyl sulfonium triflate | 0.0037 | 0.4826 | 0.5899 |
| (4-tert-Butylphenyl) diphenyl sulfonium triflate | 0.0047 | 0.3759 | 0.5262 |
| Diphenyliodonium hexafluorophosphate | | Turned red immediately | |
| Diphenyliodonium triflate | | Turned red and insoluble | |
| Triphenylsulfonium triflate | — | 0.5496 | 0.5989 |

| | |
|---|---|
| 2-methyl-4,6-bis(trichloromethyl)-s-triazine | Color fades within 24 hrs |
| tris(2,4,6-trichloromethyl)-s-triazine | Color fades within 24 hrs |
| 2-phenyl-4,6-bis(trichloromethyl)-s-triazine | Color fades within 24 hrs |
| 2-(4-chlorophenyl)-4,6-bis(trichloromethyl)-s-triazine | Color fades within 24 hrs |

The results showed that (tert-Butoxycarbonylmethoxynaphthyl) diphenyl sulfonium triflate, (4-phenoxyphenyl) diphenyl sulfonium triflate, triphenylsulfonium triflate, and (4-tert-Butylphenyl) diphenyl sulfonium triflate were decreasingly intense. However, since 0.5 AU was considered sufficiently visible, other factors such as cost were considered in selecting a preferred photoacid generator. Triphenylsulfonium triflate was selected as the preferred choice for the coating 100. It was noted that all the photoacid generators were soluble at 3% except Bis (4-tert-butylphenyl) iodonium p-toluenesulfonate and Diphenyliodonium triflate. Bis (4-tert-butylphenyl) iodonium p-toluenesulfonate required filtering to remove a substantial portion of the insoluble photoacid.

Table 8 shows the results for three photoacid generators (PAG). The three PAG were incorporated in the modified coating base formulation 10 (94% of 32.35% SR-494, 32.35% SR-9020, 15% SR-285, 10% SR-238, 10% KTO/46, and 0.3% BYK-333). A 3% concentration of each photoacid generators was mixed with the color former PERGASCRIPT Red 1-6B. The comparative solubility for of the three photoacid generators being (4-tert-butylphenyl) diphenyl sulfonium triflate is more soluble than (4-methylphenyl) diphenyl sulfonium triflate and is more soluble than triphenylsulfonium triflate. As the formulation for PERGASCRIPT Red I-6B is proprietary, this is not presented herein. However, further herein, various color formers suited for use with the teachings herein are presented.

TABLE 8
Photoacid Generator Results in Formulation 10

| | AU, 540 nm | AU, 540 nm | AU, 540 nm |
|---|---|---|---|
| 3% Photoacid Generator | 0 sec | 5 sec | 10 sec |
| Triphenylsulfonium triflate | 0.0176 | 0.4027 | 0.5289 |
| (4-tert-butylphenyl)diphenyl | 0.0093 | 0.3893 | 0.4908 |
| sulfonium triflate | | | |
| (4-methylphenyl)diphenyl | 0.0138 | 0.3921 | 0.4741 |
| sulfonium triflate | | | |

3. Considerations for Curing

Curing at this point warranted further investigation, so other photoinitiators were investigated, and were substituted in place of the 10% concentration of KTO/46. Table 9 shows the results of a first set of experiments with varying amounts of photoinitiators. Each sample was prepared by spincoating, then cured by illumination with a XENON lamp with a window glass filter for five seconds. The samples were then exposed under the XENON lamp for ten seconds. Each entry in Table 9 is given in the weight percentage of the photoinitiator as a part of the 94% coating base. The degree of cure was established by attempting physical smudging of the coating, with the scale for the degree of curing as follows: E (excellent)>G (good)>D (decent)>P (poor).

TABLE 9
Photoinitiator Experiment I

| | Formulation No. | | | | | | | | |
|---|---|---|---|---|---|---|---|---|---|
| Photoinitiator | 10 | 17 | 18 | 19 | 20 | 21 | 22 | 23 | 24 |
| ESACURE KTO-46 | 10 | 5 | | | | | | | |
| DAROCUR 4265 | | | 10 | | | | | | |
| IRGACURE 819 | | | | 5 | 5 | 7 | 9 | 10 | |
| IRGACURE 369 | | | | | | | | | 5 |
| ESACURE TZT | | | | 5 | | | | | |
| Degree of cure | G | P | P | D | G | G | — | — | G |

The results show that samples 20, 21, and 24 cured well. However, sample 24, with 5% IRGACURE 369 does not produce any color upon exposure to UV light. Also, samples 20 and 21, with 5% and 7% IRGACURE 819 cured slightly pink. Note that formulations 22 and 23 were thrown out because they turned red in lacquer form, in addition to being insoluble.

DAROCUR 4265 is a mixture of 50% 2,4,6-Trimethylbenzoyl-diphenyl-phosphineoxide and 50% 2-Hydroxy-2-methyl-1-phenyl-propan-1-one. IRGACURE 369 is 2-Benzyl-2-dimethylamino-1-(4-morpholinophenyl)-butanone-1, which is a highly efficient UV curing agent which is used to initiate the photopolymerisation of chemically prepolymers—e.g. acrylates—in combination with mono- or multifunctional monomers. IRGACURE 819 is Bis(2,4,6-trimethylbenzoyl)-phenylphosphineoxide, which is a versatile photoinitiator for radical polymerization of unsaturated resins upon UV light exposure. It is especially suited for white pigmented formulations, the curing of glass fiber reinforced polyester/styrene systems and for clear coatings subjected to outdoor use in combinations with light stabilizers. Thick section curing is also possible with this photoinitiator. All three are products of Ciba Specialty Chemicals of Basle, Switzerland, and Tarrytown, N.Y.

In order to further improve samples 20 and 21, CN-384, an amine synergist was added at 0.5% and 1%, respectively. These new additions succeeded in producing a very clear cured coating. However, at 1%, the exposed areas were not intense enough. Unfortunately, with the addition of CN-384, it was found that the exposed areas of the discs 10 exhibited considerable fading after about twenty four hours at room temperature. (CN-384 is a difunctional amine coinitiator which, when used in conjunction with a photosensitizer such as benzophenone, promotes rapid curing under UV light. Additional benefits include reduced odors, both at press side and in the cured film, and reduced blooming. CN-384 is a product of Sartomer Corporation of Exton, Pa.).

Another set of experiments was conducted with different combinations of the above experiment, as well as further photoinitiators. Again, the coating base was generally equivalent to formulation 10, with exceptions being that the photoinitiator KTO/46, was replaced as indicated in Table 10.

TABLE 10
Photoinitiator Experiment II

| | Formulation No. | | | | | | | | | | | | | | |
|---|---|---|---|---|---|---|---|---|---|---|---|---|---|---|---|
| Photoinitiator | 25 | 26 | 27 | 28 | 29 | 30 | 31 | 32 | 33 | 34 | 35 | 36 | 37 | 38 | 39 |
| ESACURE KTO-46 | 7.5 | | | | | | | | | | | | 10 | | |
| IRGACURE 819 | | 3 | 6 | 2.25 | 1.5 | 0.75 | 4.5 | 3 | 1.5 | | | | | | |
| IRGACURE 2959 | | | | 0.75 | 1.5 | 2.25 | 1.5 | 3 | 4.5 | | | | | | |
| DAROCUR 4265 | | | | | | | | | | 5 | 7 | 10 | | | |
| SARCURE SR-1124 | | | | | | | | | | | | | 2 | | |
| ESACURE TZT | | | | | | | | | | | | | | | 10 |
| ESACURE KIP100F | | | | | | | | | | | | | | 10 | |
| Degree of cure | D | D | G | P | P | P | G | G | P | P | P | D | E | P | D |

IRGACURE 2959 is 1-[4-(2-Hydroxyethoxy)-phenyl]-2-hydroxy-2-methyl-1-propane-1-one, which is a highly efficient non-yellowing radical photoinitiator for the UV curing of systems comprising of unsaturated monomers and prepolymers. It is especially suited where low odor is required and for use in water-borne systems based on acrylate or unsaturated polyester resins. The active hydroxy group can be reacted with suitable functionalized unsaturated resins; SARCURE 1124 is isopropyl thioxanthone, a photoinitiator that is used in combination with a suitable coinitiator, e.g., ethyl 4-(dimethylamino) benzoate (SARCURE SR1125), to initiate UV free radical polymerization. SARCURE SR1124 is used in inks, varnishes, and decorative coatings. ESACURE KIP100F is a liquid mixture of about 70% Oligo [2-hydroxy-2-methyl-1-[4-(1-methylvinyl) phenyl] propanone and about 30% 2-hydroxy-2-methyl-1-phenyl propan-1-one.

This experimental data in Table 10 shows that samples 27, 31, 32 and 37 cured well and warranted further investigation. Since samples 20 and 21 had cured to a slightly pink appearance, spectra were collected for selected formulations using IRGACURE 819 of the cured area immediately after the cure and twenty four hours later, as shown in FIG. 4.

This experiment shows that as the amount of IRGACURE 819 increases in the formulation, the color intensity of the cured coating increases and will continue to increase. It is theorized that the IRGACURE 819 may act as a sensitizer for the photoacid causing an increased sensitivity to longer wavelength light, leading to undesired color formation. Consequently, formulations 27 and 31 were disregarded because of the intensity of the cured background color.

Sample 37 cured quickly but was considered to have an undesirable amount of color formation after curing. Therefore, another formulation was made with a lower concentration of SR-1124. Other formulations were made with the addition of SR-1124, since SR-1124 seemed to promote rapid curing. Combinations for the third photoinitiator experiment are shown in Table 11.

TABLE 11
Photoinitiator Experiment III

Formulation No.

| Photoinitiator | 40 | 41 | 42 | 43 |
|---|---|---|---|---|
| ESACURE KTO/46 | 5 | | | |
| IRGACURE 819 | | | 3 | |
| IRGACURE 2959 | | 5 | | |
| SARCURE SR-1124 | 1 | 2 | 1 | 5 |
| Degree of cure | D | P | G | P |

Experiment III shows that samples 41 and 43 do not cure well. Sample 43 also turned pink very quickly. Although certain formulations containing SR-1124 appeared to so show promise, the sensitizing action of SR-1124 on the photoacid generator was considered a drawback to other properties, such as UV stability of the image. However, from these experiments conducted as set forth in Tables 9-11, potential combinations of photoinitiators were developed, and available in the case that the preferred use of KTO-46 (formulation 10) displayed drawbacks in future testing.

It is important to note additional aspects of curing the coatings 100 disclosed herein. These aspects include accounting for the filter spectra, the curing environment, and aspects of the curing lamp(s), some of which are now discussed.

It is considered that an important aspect of achieving both curing and imaging using lies in the ability to resolve areas of the spectrum that can be used for the respective steps. As stated elsewhere herein, preferably both curing and imaging are completed using wavelengths of ultraviolet light. It is recognized that other formulations than those disclosed herein may exhibit better response at other wavelengths, and therefore use of wavelengths specified herein on only exemplary. In preferred embodiments, deep UV light (wavelengths below about 320 nm) is used for imaging because photoacid generators are available which operate in this area and because deep UV light is not typically found at high intensities in natural illumination (sunlight, fluorescent or incandescent lighting). This tends to provide for a more durable image under ambient conditions when in use. For example, the absorbance spectra of two commercially available photoacid generators having little absorption above 290 nm is depicted in FIG. 5.

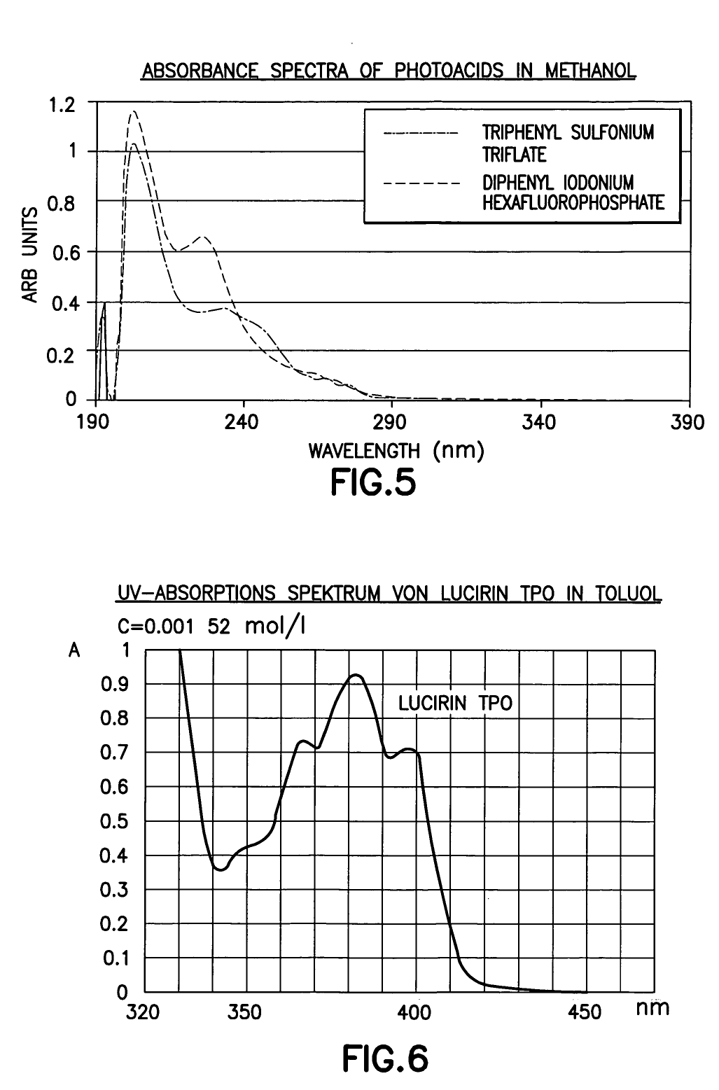

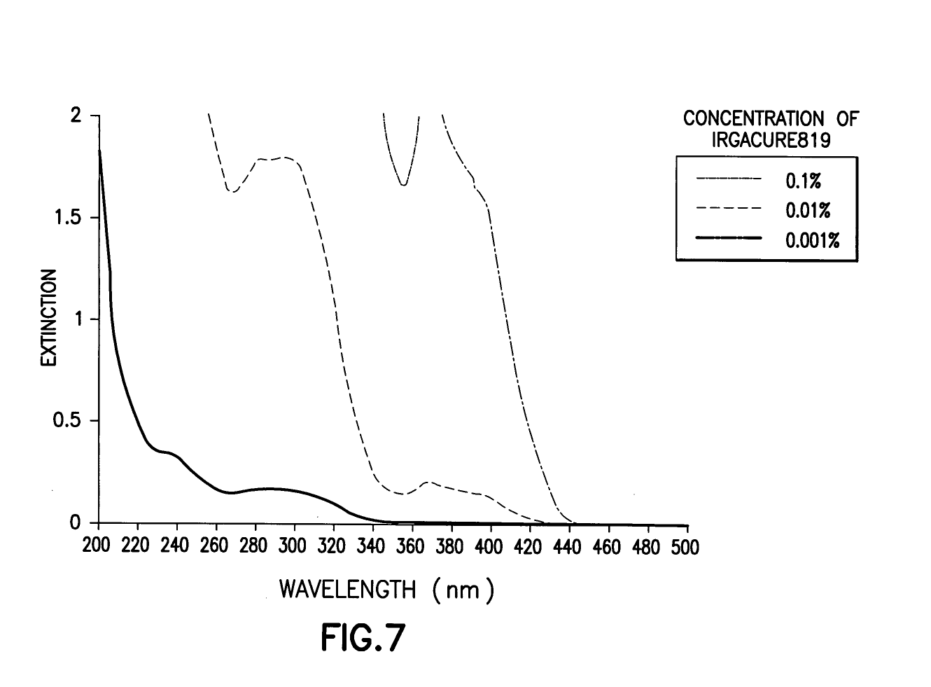

There are a number of commercially available photoinitiators whose primary absorption bands lie at wavelengths greater than 300 nm. Most notably, the phosphine oxide functionalized photoinitiators such as LUCIRIN TPO from BASF Corporation of Charlotte N.C., (the main component in KTO46) and IRGACURE 819, whose spectra are shown in FIGS. 6 and 7, respectively. Other photoinitiators may be used which also exhibit absorption for wavelengths above about 300 nm. It should also be noted that these initiators are of the direct fragmentation type of unimolecular initiators.

Bimolecular initiators typically consist of a sensitizing molecule capable of absorbing light and transferring it to a synergist molecule capable of forming a radical upon the energy transfer. One of the most common sensitizers to absorb visible light is ITX, or isopropylthioxanthone. ITX is commonly used with an amine synergist such as ethyl-p-dimethyl amino benzoate (EDAB) or octyl-p-dimethyl amino benzoate (ODAB). Both EDAB and ODAB are capable of forming radicals upon energy transfer from the ITX. These components are not considered appropriate for use in the coating for two reasons. The first is the ITX sensitizer also sensitizes the photoacid to visible light, thereby eliminating the spectral resolution between curing and writing. (To some extent this also happens when using certain unimolecular photoinitiators such as IRGACURE 819, which also causes a slight sensitization of the photoacid generate to long wave UV light). The second reason is that typical synergists such as amines (and to a lesser extent alkoxylated monomers such as SR-494, SR-9020, SR-9021) significantly reduce or even eliminate color formation or image stability through neutralization of the acid generated by the photoacid generator.

For a discussion of photoinitiator types and processes, reference may be had to: Chapters I and II in “Chemistry & Technology of UV & EB Formulation for Coatings, Inks, & Paints, Volume III Photointiators for Free Radical Cationic & Anioninc Photopolymerization” 2nd Edition, J. V. Crivello and K. Dietliker Eds, WILEY/SITA Series in Surface Coatings Technology, John Wiley and Sons, 1998.

In addition to a requirement for having the absorption spectra of the photoacid generators and the photoinitiators resolved (substantially separate from one another), mass production demands that sufficient intensity of the light in each band must be high enough to provide for curing and imaging in a minimum amount of time. Popular light sources for curing UV curable coatings include continuous wave (CW) sources such as metal and metal halide arc lamps (from Honle UV America, Inc of Marlboro, Mass.), as well as pulsed arc lamps such a XENON gas arc lamps (Xenon Corporation, of Woburn Mass.).

One advantage of using light filters, or other techniques, is that a narrow band of wavelengths may be produced, or that unwanted wavelengths may be substantially removed. Such techniques provide for better resolution (separation of curing and imaging wavelengths), thus increasing the availability or selection of photoinitiators and photoacid generators and combinations thereof.

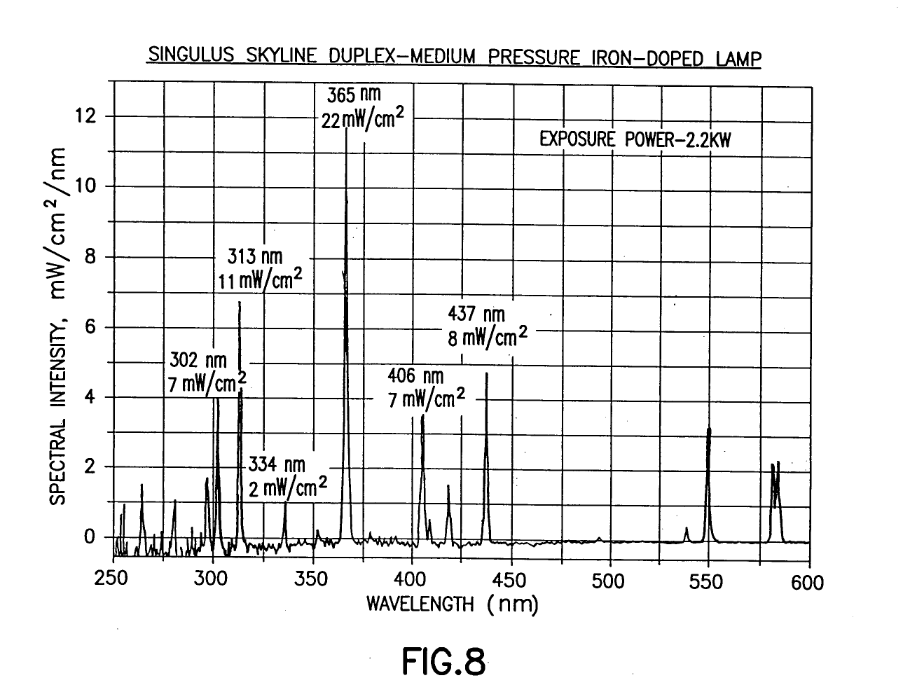

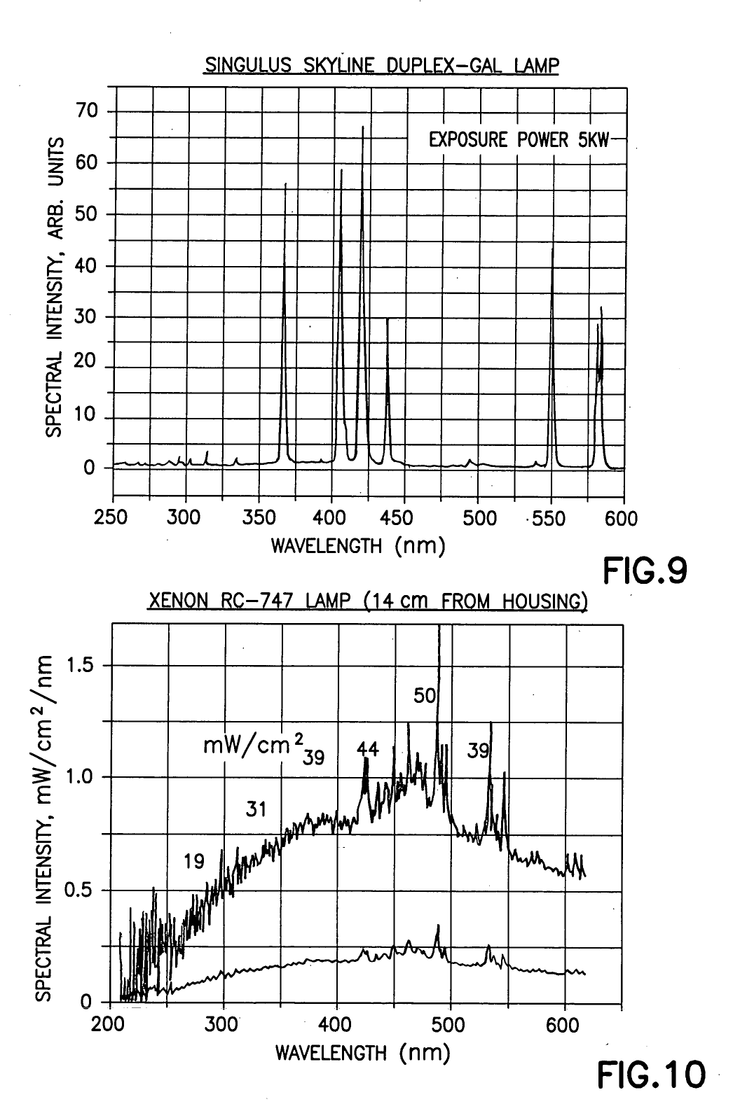

A typical mercury vapor lamp produces a spectrum that is predominately a line spectrum. For example, the spectrum in FIG. 8 shows the output from a medium pressure iron-doped mercury lamp typically used for UV curing lacquers applied to of optical media 10. Once can see how the majority of the output comes from discrete lines associate with electronic transition of the lamp dopant. A similar spectrum for a different metal halide lamp, gallium iodide, with different transition lines, is shown in FIG. 9.

These lamps typically work well for UV curing because the major lines are compatible with the photoinitiators used in UV curing systems. Another popular lamp is the pulse XENON gas filled lamp, such as those made by XENON Corporation of Woburn Mass. The spectrum for these lamps are much more “blackbody” in nature, with a spectrum derived from the color temperature of the plasma formed in the lamp during the pulse. A typical spectrum from a XENON RC-747 gas filled lamp is depicted in FIG. 10.

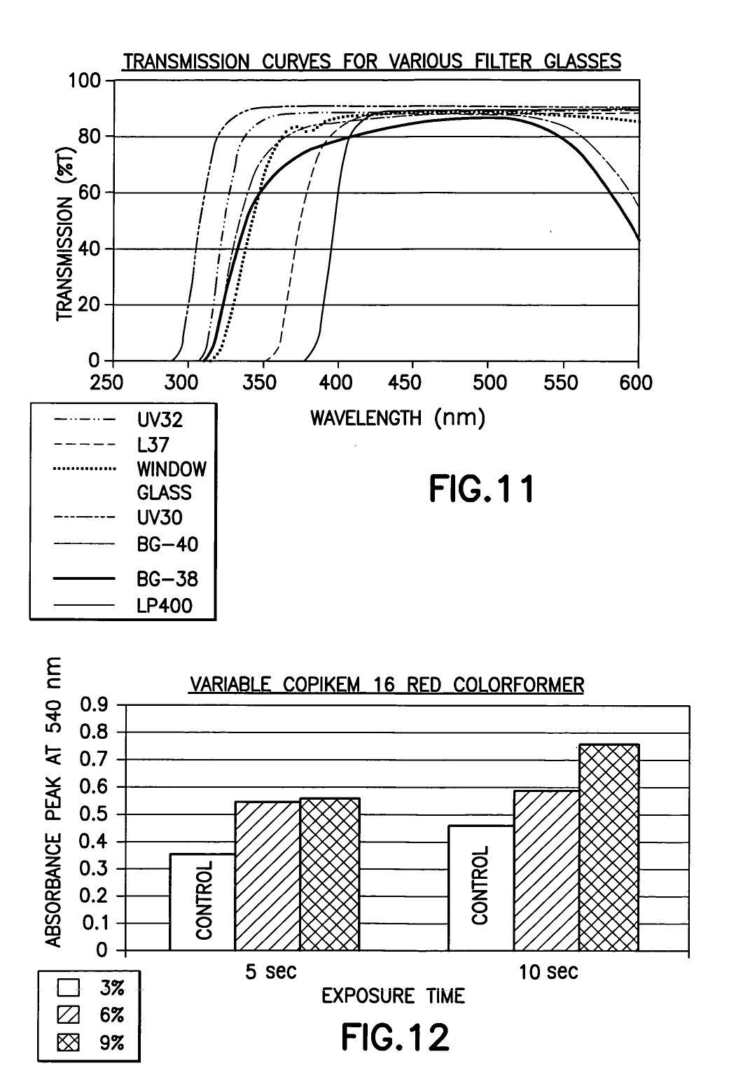

In addition to having an appropriate source of UV light, separation of the long UV from the short UV portion of the spectrum must be achieved in order to first cure the coating 100 without prematurely causing color formation. Preferably, this is achieved through the use of absorptive filters such as those whose transmission curves are shown in FIG. 11. During the development of the coating 100, a series of experiments were performed to find an acceptable combination of a lamp, a filter, and photoinitiators to provide for an adequately short cure time, where no premature color formation took place. As shown in FIG. 11, the L37 filter was substantially transmissive above about 370 nm.

The preferred method for curing the coating consists of using the KTO46 photoinitiator with a combination of a XENON bulb and an L37 filter glass. Typical mercury line lamps did not produce an intensity of light that was adequate in comparison to the XENON lamps, where both were outfitted with an L37 filter. As the high intensity of the XENON pulsed lamps leads to better properties in a cured coating, the XENON lamps were selected for curing of the coating 100.

In actual practice, filtering of wavelengths for curing could also be performed through the use of cold mirror technology, where a mirror which selectively reflected a portion of the UV spectrum and allowed the visible and infrared portions to pass would thus provide only the desired wavelengths. This technique would provide a benefit of reducing thermal loading in the coating 100, as well and the thermal management required to cool an absorptive filter. Another approach that is considered useful for curing would be to use different types of glasses with different UV transmission as the bulb material, thereby keeping the thermal load in the lamp housing. This is a well known approach used by most bulb manufacturers including Xenon Corporation, which offers five bulb types that differ only in the type of glass used.

4. Oxygen Inhibition

During UV curing of free radical systems, the presence of oxygen can have a detrimental effect on the cure response, especially for thin-film coatings. Accordingly, it is considered preferable to inhibit the ambient oxygen (air) in the curing environment. Oxygen inhibition is known, and described by Crivello and K. Dietliker (see chapter 2 page 83). When curing the coating 100 in ambient air, oxygen reacts with the free radical and forms peroxy radicals by reaction with the photoinitiator, monomer or propagating chain radical. The reactivity of the peroxy radicals is insufficient to continue the free radical polymerization process, leading to chain termination and resulting in an under cured system. Methods to overcome oxygen inhibition include (1) adding more photoinitiator or (2) increasing curing time. As the photoinitiator selected is relatively expensive, option (2) is considered to be preferable over option (1).

A further solution to the oxygen-inhibition problem is to replace the ambient air environment with an inert gas, such as nitrogen. This enables all the free radicals produced by UV exposure to be used in the polymerization process. Unfortunately, use of a purge gas, such as nitrogen, has a correlative economic impact due to the large volume of nitrogen needed. The expense of using a purge gas must therefore be weighed against various other requirements, such as the cure time, and desired end product.

A further method of overcoming oxygen inhibition is to use photoinitiators which are less reactive with oxygen. These initiators tend to require shorter UV light to work (<320 nm). Alternatively, the photoinitiators may include the sensitizing molecule and a synergist described earlier. As described earlier, the sensitizers also sensitize the photoacid generators to visible light. This has a propensity to reduce the spectral resolution between the bands of wavelengths for curing and for writing. Typical synergists, such as amines (and to a lesser extent alkoxylated monomers such as SR-494, SR-9020, SR-9021), significantly reduce or even eliminate color formation or image stability through neutralization of the acid generated by the photoacid generator. Therefore, this technique is not preferred for use with the coating 100.

A preferred method to overcome oxygen inhibition is to increase the intensity of the curing light, such as using a high intensity pulsed source, such as the model RC-747 lamp available from Xenon Corporation of Woburn Mass. In preferred embodiments of pulsed UV curing, the energy of each flash of light is so intense that very high concentrations of free radicals are created. This approach produces enough free radicals so that the oxygen at the surface of the coating 100 is depleted and additional free radicals are available for curing. In this approach, energy intensity is an important factor to provide for instantaneous curing. More information on the effect of light intensity on curing and overcoming oxygen inhibition may be obtained by reference to a technical paper “Secrets of the Dark,” produced by Fusion UV Systems, Inc. of Gaithersburg, Md.

The use of pulsed light has proven advantageous for curing of the coating 100 disclosed herein, because it provides high intensity light in a region of the spectrum that is compatible with the color formation process. Furthermore, use of pulsed light has reduced the oxygen inhibition problem greatly, so that nitrogen environments or excessive amounts of photoinitiators are not required while keeping curing time to as short a time as possible.

5. Colors and Imaging

A number of different color formers were explored for use in the coating 100. To provide for comparison of the color formers and their respective intensities, formulations were made by mixing a base coating of the original control formulation (45% SR494, 45% SR238, and 10% KTO/46). This coating base mixture was added at 94% to a 3% concentration of triphenylsulfonium triflate and a 3% concentration of the color former to be investigated. Since there was a wide-range of colors, absorbance peaks occurred at various wavelengths. FIG. 3 shows a typical curve recorded from the LAMBDA 2 UV-VIS spectrometer. Table 12 displays the significant results.

TABLE 12
Colorformer Experiment Results in SR494/SR238

| | | AU, nm peak | AU, nm peak |
|---|---|---|---|
| 3% Colorformer | nm peak | 5 sec | 10 sec |
| Copikem 16 Red | 540 | 0.3600 | 0.4607 |
| Copikem 6 Green | 440, | 0.2069, | 0.2211, |
| | 600 | 0.1722 | 0.1807 |
| Copikem 34 Black | 464, | 0.2551, | 0.2757, |
| | 586 | 0.2267 | 0.2448 |
| Pergascript Red I-6B | 540 | 0.4846 | 0.5729 |
| Pergascript Orange I-G | 493 | 0.1580 | 0.1600 |
| Pergascript Green I-2GN | 440, | 0.1956, | 0.2290, |
| | 602 | 0.1628 | 0.1862 |
| Pergascript Blue I-2RN | 613 | 0.0577 | 0.0677 |
| Pergascript Black I-2R | 460, | 0.2871, | 0.2830, |
| | 586 | 0.2553 | 0.2476 |
| BK-305 Black | 464, | 0.2757, | 0.2730, |
| | 586 | 0.2439 | 0.2350 |
| S-205 Black | 464, | 0.3049, | 0.2975, |
| | 586 | 0.2704 | 0.2623 |
| BK-400 | 464, | 0.2605, | 0.2684, |
| | 586 | 0.2314 | 0.2598 |
| Red 520 | 525 | 0.3070 | 0.4031 |

The reference to COPIKEM materials in Table 12 is considered to be illustrative of materials that may be introduced into formulations for the practice of this invention. Practically, as these materials are no longer commercially available, these materials are not preferred. BK-305 Black, S-205 Black, BK-400 and Red 520 are color former materials available from Yamada Chemical Co., Ltd. Of Japan and Arlington, Va. Preferred embodiments include the use of various PERGASCRIPT color formers, the structure and formulations of these color formers being proprietary. However, examples of color forming materials that are suited for practice of this invention are disclosed in U.S. Pat. No. 4,102,893, “Process for Manufacture of Color Formers of Indoles and Anhydrides of Aromatic or Heteroaromatic, Vicinal Dicarboxylic Acids, New Color Formers of These Classes of Substance and Their Use,” Jul. 25, 1978, Garner et al. The disclosure of U.S. Pat. No. 4,102,893 is incorporated herein by reference in its entirety. For example, one color forming material disclosed in U.S. Pat. No. 4,102,893, that of the formulation in Table 1, the sixth compound down, was tested in accordance with some of the experiments set forth herein, and shown to have at least some of the desired properties of color forming materials.

These results show that the red color formers, COPIKEM 16 Red and PERGASCRIPT Red I-6B, produced the best color intensities. Therefore, preferred embodiments of the coating 100 use a red color former, although it should be recognized that the above color formers, and other color formers not discussed herein, can be used to produce adequate color formation.

Further experiments primarily used the PERGASCRIPT Red I-6B color former. It was noted that in some instances, that the solubility of some color formers became an issue when added at 3%. The black and green color formers exhibited some solubility problems in the coating base used, and therefore, these formulations were filtered, reducing their concentration to slightly below 3%. However, it is considered that further testing of the green and black color formers, perhaps with various coating base formulations, will likely produce improved results. In addition to the color formers in Table 12, PERGASCRIPT Yellow I-3R was tested. However, this color former exhibited some color formation upon curing, and therefore it is considered that effective use of PERGASCRIPT Yellow I-3R will require further investigation.

The base formulation of the coating 100 was then changed to formulation 3 (0.3% BYK-333, 10% KTO/46, 10% SR-238, 15% SR-285, 32.35% SR-494, and 32.35% SR-9020). The color formers that worked well were then tested again to ensure the color formation was the same. Color formation differed only slightly with the results shown in Table 13.

TABLE 13
Color former Experiment Results in Formulation 3

| | | AU, nm peak | AU, nm peak |
|---|---|---|---|
| 3% Colorformer | Nm peak | 5 sec | 10 sec |
| Pergascript Red I-6B | 540 | 0.4027 | 0.5289 |
| Pergascript Orange I-G | 493 | 0.1937 | 0.2186 |
| Pergascript Green I-2GN | 440, | 0.2046, | 0.2126, |
| | 602 | 0.1716 | 0.1704 |
| Pergascript Blue I-2RN | 613 | 0.0814 | 0.0899 |
| Pergascript Black I-2R | 460, | 0.2636, | 0.3016, |
| | 586 | 0.2404 | 0.2696 |
| Red 520 | 525 | 0.4044 | 0.4888 |

Tables 14 and 15 show that in the 3% color former, 3% photoacid generator and 94% base coating (formulation control or formulation 3, respectively) the intensity of some colors was higher than others. The intensity of the colors, however, was not fixed. It was considered that it should be possible to increase the color intensity through various methods, such as increasing the concentration of the photoacid generator and/or color former, and by adding color enhancers.

Modifications to color intensity were then investigated. First, the amount of color former, COPIKEM 16 Red, was increased from 3% to 6% and to 9%. This was done while keeping the amount of photoacid generator fixed at 3%, with the coating base of the control formulation making up the remainder of the mixture. Absorbance curves were obtained using the UV-VIS LAMBDA 2 spectrometer. The results shown in FIG. 12 depict the absorbance peaks at 540 nm.

From FIG. 12, it was possible to determine that the 9% COPIKEM 16 Red, 3% triphenylsulfonium triflate, and 88% coating base at 10 seconds exposure, exhibits the highest optical density (OD). Only up to 9% COPIKEM 16 Red was tested, however, at 10 seconds. The results demonstrated that, at least to some extent, it was possible to increase the intensity of the color by adding more color former. Since different color formers behave differently at the same loading, specific experiments with other color formers are warranted to further examine changes in color intensity. However, it is considered that similar changes in color intensity should be realized so long as the color formers used are soluble.

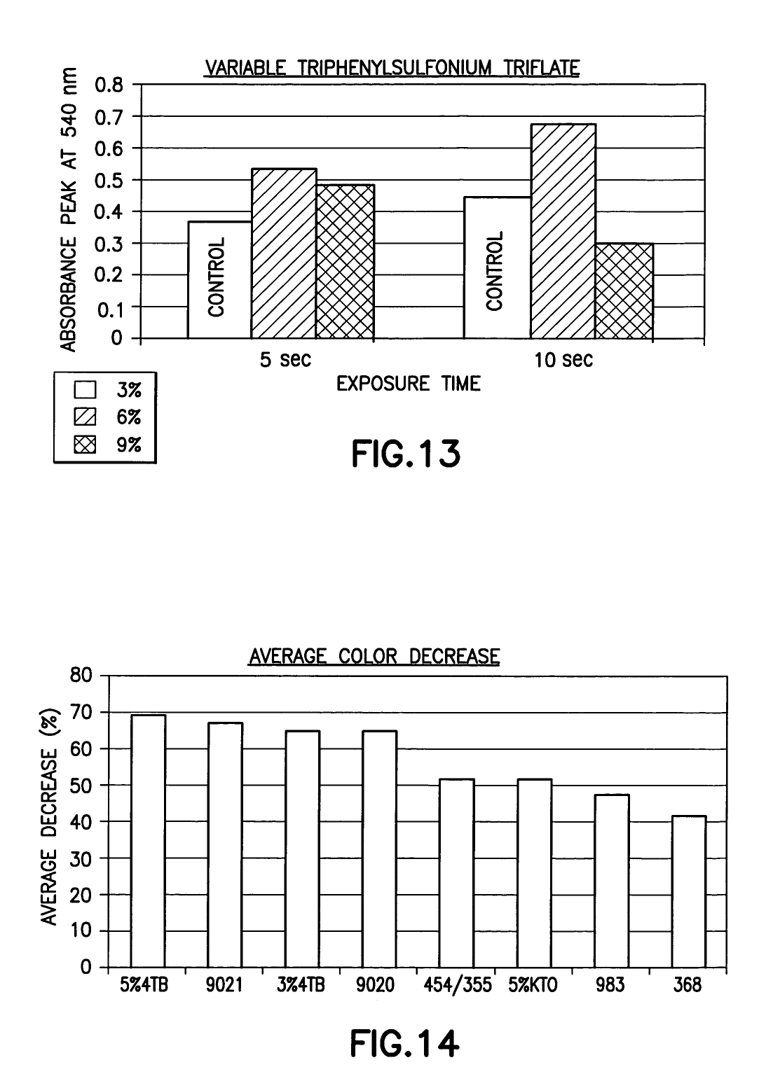

In another experiment, the amount of photoacid generator was increased in the same manner as the color former experiment. FIG. 13 depicts effects in color intensity after increasing the amount of photoacid generator (in this experiment, triphenylsulfonium triflate was used) in the coating 100. FIG. 13 shows that the combination using 6% photoacid generator, 3% color former, and 91% coating base formulation, with an exposure time of 10 seconds, produced the most color. It may also be possible to increase the optical density (OD), in this case by adding more than the 6% photoacid generator. However, with 9% photoacid generator, the color intensity exhibited a marked decrease. For that reason, it might prove favorable to test concentrations of triphenylsulfonium triflate (TPST) between 6% and 9%. Overall, it appears that adding more color former than photoacid generator produces preferable results, and is more economic.

In a further experiment, photoacid generators and color formers were increased simultaneously at 6% and at 9%, with an 88% and 82% coating base, respectively. However, these formulations were not soluble and no further investigation was completed.

6. Environmental Influence

Initial studies performed showed that the coating 100 is susceptible to environmental influence. More specifically, the imaged or colored areas of the disks 10 fade upon significant exposure to humidity and temperature. Therefore, another study was performed to quantitatively measure color reduction resulting from environmental influence.

Eight different formulations were tested for color reduction and their formulations are shown in Table 14. (Note that formulations are generally identified and referred to herein according to the constituents of the base coating formulation). Samples of each formulation were spun coat onto three disks 10 for 15 seconds at 4000 rpm. The disks 10 were then cured under the L37 filter for 2 seconds in the presence of nitrogen. Half of each disk 10 was then exposed for 10 seconds. Absorbance curves of each disk 10 were taken prior to and after the test to reflect the average color reduction. The humidity and temperature test involved placing the disks into an environmental oven at 70° C. with 90% humidity for 96 hours.

TABLE 14
Formulations for Environmental Study I

| | Base Coat Formulation No. | | | | | | |
|---|---|---|---|---|---|---|---|
| | 3 | 10 | 14 | 44 | 45 | 46 | 47 |
| | Formulation Name: | | | | | | |
| COMPONENT | 9021 | 9020 | 3% 4TB | 454/355 | 5% KTO | 983 | 368 |
| Wetting Agent BYK-333 | 0.3 | 0.3 | 0.3 | 0.3 | 0.3 | 0.3 | 0.3 |
| Photoinitiator KTO/46 | 10 | 10 | 10 | 10 | 5 | 10 | 10 |

Diluents

| | | | | | | | |
|---|---|---|---|---|---|---|---|
| SR-238 | 10 | 10 | 10 | 10 | 10 | 10 | 10 |
| SR-285 | 15 | 15 | 15 | 15 | 15 | 15 | 15 |
| SR-506 | | | | | | | |

Main Components

| | | | | | | | |
|---|---|---|---|---|---|---|---|
| SR-494 | 32.35 | 32.35 | 32.35 | | | | |
| SR-9021 | 32.35 | | | | | | |
| SR-9020 | | 32.35 | 32.35 | | | | |
| SR-454 | | | | 32.35 | 34.85 | 27.35 | 27.35 |
| SR-368 | | | | | | | 10 |
| SR-355 | | | | 32.35 | 34.85 | 27.35 | 27.35 |
| CN-983 | | | | | | 10 | |
| CN-120 | | | | | | | |
| TOTAL | 100 | 100 | 100 | 100 | 100 | 100 | 100 |

Photoacid generator

| | | | | | | | |
|---|---|---|---|---|---|---|---|
| TPST | 3 | 3 | | 3 | 3 | 3 | 3 |
| t-butylphenyl DPST | | | 3 | | | | |

Color former

| | | | | | | | |
|---|---|---|---|---|---|---|---|
| Pergascript Red 6B | 3 | 3 | 3 | 3 | 3 | 3 | 3 |
| Fading % | 66.74 | 64.5 | 65.0 | 52.3 | 51.8 | 47.6 | 45 |
| Viscosity (cP) | 58.5 | 58.7 | | 72.0 | 67.8 | 109.9 | 90.7 |

The test results shown in FIG. 14 demonstrate that some formulations retain their color better than others in the presence of temperature and humidity. Specifically, the addition of non-alkoxylated monomers such as SR-355 (formulation 14), CN-983 (formulation 45), and SR-368 (formulation 46) all increase performance. This could be as a result of decreased alkoxy content (decreased hydrophilicity), and increased Tg or crosslink density. The use of the tert butyl derivative of triphenylsulfonium triflate (TPST) or higher concentrations of the photoacid generator did not impact performance significantly.

A second set of formulations were designed and prepared to expand upon the previous observations. The second set is described in Table 15. All base components were added and mixed before the addition of the photoacid generator and color former. Components SR-368, CN-983 and CN-120 were liquefied on a hot plate prior to addition. Once the base components were mixed and homogeneous, 3% photoacid generator was added to each batch. Formulations 53, 55 and 57 would not go in to solution and these batches were discarded. Components of the formulation based on the base coating formulation 10 did not dissolve as readily as others, but these did eventually go in to solution. Once all of the photoacid generator was dissolved, the color former was added to an amount of 3% total weight for each batch. All formulations went in to solution without difficulty, and there were no mixing issues with the addition of color former. Each formulation was then filtered through a 5 micron nylon syringe filter. Initially, all formulations had a pale to light rose or yellow color.

SR-506 is isobornyl acrylate, which is an excellent reactive diluent for oligomers. CN-120 is a difunctional bisphenol A based epoxy acrylate. Both are products of Sartomer Corporation.

Five clear polycarbonate disks 10 were coated by hand with each formulation. Each disk 10 was then cured under a Xenon pulse lamp at a distance of about 5 inches using a nitrogen environment and an L-37 filter. Formulation 56 was extremely thick but coated nicely. Formulation 10 cured in 2 seconds. The remaining samples of formulations were cured for 4 seconds as they contained only 5% photo-initiator. Half of each disk 10 was then exposed under the lamp for 10 seconds to form a red color. All disks 10 were subsequently scanned (both cured and exposed sides) using a UV-Spectrometer to measure the optical density at 540 nm.

TABLE 15
Formulations for Environmental Study II

| | Base Coating Formulation No. | | | | | | | | | | | | |
|---|---|---|---|---|---|---|---|---|---|---|---|---|---|
| | 10 | 48 | 49 | 50 | 51 | 52 | 53* | 54 | 55* | 56** | 57* | 58 | 59 |
| Component | 9020 | 355-5% | 355-Tego | 983 | 368-1 | 368-2 | 368-3 | 368-4 | 506-1 | 506-2 | 506-3 | 120-1 | 120-2 |

Wetting Agent

| | | | | | | | | | | | | | |
|---|---|---|---|---|---|---|---|---|---|---|---|---|---|
| BYK-333 | 0.3 | 0.3 | | | | | | | | | | | |
| TEGO RAD 2200 N | | | 1 | 1 | 1 | 1 | 1 | 1 | 1 | 1 | 1 | 1 | 1 |

Photoinitiator

| | | | | | | | | | | | | | |
|---|---|---|---|---|---|---|---|---|---|---|---|---|---|
| KTO/46 | 10 | 5 | 5 | 5 | 5 | 5 | 5 | 5 | 5 | 5 | 5 | 5 | 5 |

Diluents

| | | | | | | | | | | | | | |
|---|---|---|---|---|---|---|---|---|---|---|---|---|---|
| SR-238 | 10 | 10 | 10 | 15 | 15 | 24 | 10 | 50 | 10 | 10 | 10 | 15 | 20 |
| SR-285 | 15 | 15 | 14 | 15 | 15 | | | | | | | 15 | |
| SR-506 | | | | | | | 50 | | 24 | 24 | 24 | | 14 |

Main Components

| | | | | | | | | | | | | | |
|---|---|---|---|---|---|---|---|---|---|---|---|---|---|
| SR-494 | 32.35 | | | | | | | | | | | 22 | |
| SR-9021 | | | | | | | | | | | | | |
| SR-9020 | 32.35 | | | | | | | | | | | 22 | |
| SR-454 | | 34.85 | 35 | 22 | 22 | 40 | | | 35 | 25 | 25 | | |
| SR-368 | | | | | 20 | 30 | 44 | 44 | | | 20 | | |
| SR-355 | | 34.85 | 35 | 22 | 22 | | | | 35 | 25 | 25 | | 30 |
| CN-983 | | | | 20 | | | | | | 40 | | | |
| CN-120 | | | | | | | | | | | | 20 | 30 |
| TOTAL | 100 | 100 | 100 | 100 | 100 | 100 | 110 | 100 | 110 | 130 | 110 | 100 | 100 |

Photoacid

| | | | | | | | | | | | | | |
|---|---|---|---|---|---|---|---|---|---|---|---|---|---|
| TPST | 3 | 3 | 3 | 3 | 3 | 3 | 3 | 3 | 3 | 3 | 3 | 3 | 3 |
| t-butylphenyl DPST | | | | | | | | | | | | | |

Colorformer

| | | | | | | | | | | | | | |
|---|---|---|---|---|---|---|---|---|---|---|---|---|---|
| Pergascript Red 6B | 3 | 3 | 3 | 3 | 3 | 3 | 3 | 3 | 3 | 3 | 3 | 3 | 3 |
| Fading % | 56.95 | 43.22 | 49.42 | 48.19 | 45.85 | 41.92 | | 44.04 | | 44.46 | | 54.25 | 21.01 |
| Viscosity (cP) | 56.7 | 65 | 68 | 113.4 | 82.8 | 106.7 | | 72.6 | | 385 | | 116.5 | 370.9 |
| Optical Density | 0.42 | 0.49 | 0.50 | 0.62 | 0.56 | 0.61 | | 0.61 | | 0.75 | | 0.65 | 0.79 |
| Film Thickness (um) | 3.6 | 3.9 | 3.7 | 4.6 | 4.6 | 4.5 | | 4.8 | | 8.9 | | 5.0 | 8.9 |

*Remained insoluble even after addition of 238
**Did not cure well

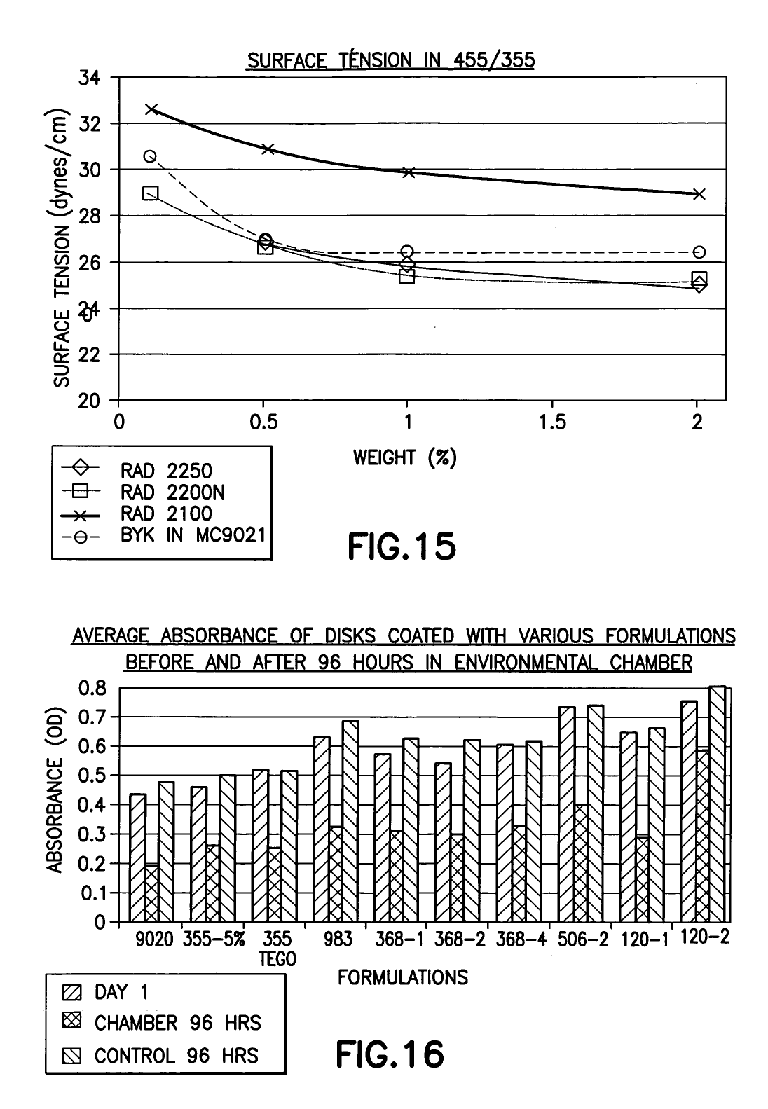

This study also evaluated changing the wetting agent from BYK-333 to a crosslinkable siloxane. Several candidate reactive wetting agents were examined, including three RAD products from TEGO (RAD 2250, RAD 2200N, RAD2100). The performance of these products was examined using formulation 48. TEGO RAD 2200N was selected as it gave the best surface tension reduction and clarity performance. Results of the examination are shown in FIG. 15. TEGO RAD 2250 and RAD 2200N are each a crosslinkable silicone polyether acrylate, while TEGO RAD 2100 is a crosslinkable silicone acrylate. TEGO products are available from Tego Chemie Service GmbH, and distributed in the United States by Degussa Tego Coating & Ink Additives of Hopewell, Va.

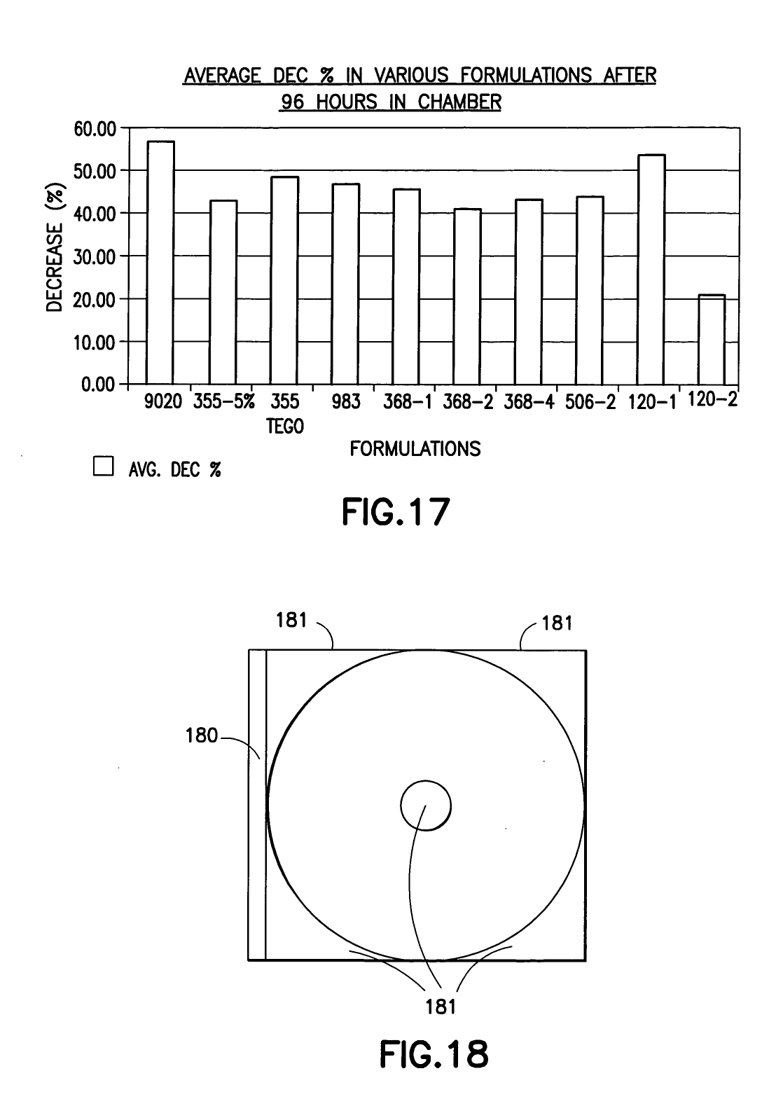

Three discs 10 of each formulation were placed in an environmental chamber for 96 hours, at 70° C. and 100% relative humidity. Disks 10 containing formulations 4 and 5 were stored in an opaque disk container as controls. Once the disks 10 were removed from the chamber, all disks 10 of each formulation (10, 48-51) were again scanned at 540 nm to measure any differences in optical density. Comparative data is provided in FIGS. 16 and 17.

From the data, it was clear that variation of the viscosity played a role in film thickness and the color generated for a constant exposure. Therefore, it is considered that color reduction is not necessarily a clear indicator of performance since a thicker, and therefore darker coating 100, may fade more but still retain more color than a thin application of the coating 100. However, to a first approximation, the percentage color reduction is an indicator of the relative stability of the imaging chemistry in the particular matrix.

Formulation 59, based on bisphenol A diacrylate and SR-355 (Di-TMPTA), was considered to exhibit the best performance from the group tested. Once applied, a coating 100 formed from formulation 59 should be highly crosslinked, high Tg, film with no alkoxylation. All the remaining formulations contained significant amount of alkoxylated monomers which lead to lower Tg's, hydrophilicity, and possibly basic environments. Accordingly, a third set of formulations was designed to explore the CN-120 formulation and the effect of alkoxylation on image stability.

The best non-CN-120 containing formulations were tested side by side with a series of CN-120 formulations. Aspects of the compositions of these formulations, and their respective performance, are depicted in Table 16. Also tried was CN-132, a low viscosity aliphatic diacrylate manufactured by Sartomer Corporation. Finally, CN-983, an aliphatic urethane acrylate was tested to determine if it could be used like CN-120. The results show that only the CN-120 formulations give the outstanding image retention. Of particular interest was formulation CN-120-4, the only formulation to use an alkoxylated monomer, SR-454. The formulation did not perform well, again indicating alkoxylation as a negative for image retention. CN-132 as a rule failed, and the CN-983 formulation did not give results like CN-120. CN-132 is a low viscosity aliphatic diacrylate oligomer, and is a product of Sartomer Corporation.

From this study, formula 61 was selected for further development because it gave an excellent combination of cure speed, film hardness, and outstanding image stability. The CN-120 and SR-368 monomers were difficult to work with, so liquid versions CN-120-B60 (60% CN-120 in SR-238) and SR-368D (approximately 85% SR-368 in TMPTA) were substituted for ease of handling and subsequent manufacturing.

TABLE 16
Formulations for Environmental Study III

| | Base Coating Fomulation No. | | | | | | | | | | | | |
|---|---|---|---|---|---|---|---|---|---|---|---|---|---|
| | 49 | 60 | 58 | 59 | 61 | 62 | 63 | 64 | 65 | 66 | 67 | 68 | 69 |
| | Formulation Name | | | | | | | | | | | | |
| Component | 355/454 | 355/454-2 | 120-1 | 120-2 | 120-3 | 120-4 | 120-5 | 132-1 | 132-2 | 132-3 | 132-4 | 132-5 | 983-1 |

Wetting Agent

| | | | | | | | | | | | | | |
|---|---|---|---|---|---|---|---|---|---|---|---|---|---|
| TEGO RAD 2200 N | 1 | 1 | 1 | 1 | 1 | 1 | 1 | 1 | 1 | 1 | 1 | 1 | 1 |

Photoinitiator

| | | | | | | | | | | | | | |
|---|---|---|---|---|---|---|---|---|---|---|---|---|---|
| KTO/46 | 5 | 5 | 5 | 5 | 5 | 5 | 5 | 5 | 5 | 5 | 5 | 5 | 5 |

Diluents

| | | | | | | | | | | | | | |
|---|---|---|---|---|---|---|---|---|---|---|---|---|---|
| SR-238 | 10 | 24 | 20 | 34 | 34 | 34 | 44 | 24 | 30 | 30 | 40 | 40 | 44 |
| SR-285 | 14 | | | | | | | | | | | | |
| SR-506 | | | 14 | | | | | | | | | | |

Main Components

| | | | | | | | | | | | | | |
|---|---|---|---|---|---|---|---|---|---|---|---|---|---|
| SR-454 | 35 | 20 | | | | 30 | | | | | 20 | | |
| SR-368 | | | | | 30 | | | | | | | 20 | |
| SR-355 | 35 | 50 | 30 | 30 | | | | 35 | 14 | 50 | | | |
| CN-983 | | | | | | | | | | | | | 50 |
| CN-120 | | | 30 | 30 | 30 | 30 | 50 | | | | | | |
| CN-132 | | | | | | | | 35 | 50 | 14 | 34 | 34 | |
| TOTAL | 100 | 100 | 100 | 100 | 100 | 100 | 100 | 100 | 100 | 100 | 100 | 100 | 100 |
| Photoacid | | | | | | | | | | | | | |
| TPST | 3 | | 3 | 3 | 3 | 3 | 3 | 3 | 3 | 3 | 3 | 3 | 3 |
| t-butylphenyl DPST | | | | | | | | | | | | | |

Colorformer

| | | | | | | | | | | | | | |
|---|---|---|---|---|---|---|---|---|---|---|---|---|---|
| Pergascript Red 6B | 3 | | 3 | 3 | 3 | 3 | 3 | 3 | 3 | 3 | 3 | 3 | 3 |
| Fading % | 57 | 56 | 30 | 36 | 22 | 52 | 31 | 57 | 69 | 53 | 69 | 68 | 51 |
| Viscosity (cP) | 66 | 96 | 375 | 315 | 504 | 177 | 330 | 197 | 162 | 112 | 67 | 116 | 260 |
| Optical Density | 0.45 | 0.50 | 0.63 | 0.59 | 0.60 | 0.56 | 0.55 | 0.58 | 0.60 | 0.50 | 0.42 | 0.54 | 0.68 |
| Film Thickness (um) | 3.7 | 4.3 | 7.8 | 6.9 | 9.3 | 5.3 | 8.9 | 5.7 | 4.3 | 4.0 | | | 6.5 |

Could not remove film from 67, 68
Optical denisties all measured after same exposure interval

The final development of the CN-120 formulation coincided with the initiation of an effort to reduce the sensitivity of the coating to sunlight and fluorescent lighting by the optimization of the photoacid generator concentration and addition of UV absorbers (the addition of UV absorbers is described further elsewhere herein). Accordingly, a fourth environmental study included several formulations which varied photoacid generator concentration and UV absorber concentration for subsequent light exposure testing. Aspects of the compositions of these formulations are presented in Table 17.

In addition, two spin speeds (4 k and 6K) were used to examine the effect of varying the coating 100 thickness on image stability. In addition to being darker, it was expected that thicker film of the coating 100 would give better color retention in the environmental testing. The formulations without UV absorbers were prepared as before, which included being cured for two seconds in a nitrogen environment, with a L37 filter glass under the XENON “C” bulb at a distance of about 1 inch. The disks 10 were imaged by illumination for about 10 seconds at a distance of about 5 inches. Formulations with UV blockers were imaged for a total of about 30 seconds (15 seconds×2 imaging sessions), also at a distance of about 5″ from the lamp. These formulations were given a longer exposure time due to their slower color formation time.

The results show that substitution of the liquid components (CN-120-B60 and SR-368D) have substantially little effect on image stability or color formation at either 2% or 3% loadings of the photoacid generator. It was noted that a lower photoacid generator concentration did appear to give better percentage of color retention, although the higher loadings lead to more intense color at all times. The addition of UV stabilizers appeared to lead from substantially little degradation of environmental stability (at 5% loading) to mild degradation of environmental stability (at 10% loading). However, the ultimate color of these formulations was less intense.

SR-368D, is tris (2-hydroxy ethyl) isocyanurate triacrylate, and is a clear liquid triazin compound which is used in free radical polymerization. CN120B60 is a difunctional bisphenol A based epoxy acrylate blended with 40% SR-238, hexane diol diacrylate. CN120B60 provides a good balance of water properties and high reactivity. Both are products of Sartomer Corporation.

TABLE 17
Formulations for Fourth Environmental Study

| | Base Coating Fomulation No. | | | | | | | | | |
|---|---|---|---|---|---|---|---|---|---|---|
| | 70 | 71 | 72 | 73 | 74 | 75 | 76 | 77 | 78 | 79 |
| | Formulation Name: | | | | | | | | | |
| Component | Base-2 | Base-3 | 368D3 | 368D2 | 368D1.5 | UV1 | UV2 | UV3 | UV4 | UV5 |

Wetting Agent

| | | | | | | | | | | |
|---|---|---|---|---|---|---|---|---|---|---|
| TEGO RAD 2200 N | 1 | 1 | 1 | 1 | 1 | 1 | 1 | 1 | 1 | 1 |

Photoinitiator

| | | | | | | | | | | |
|---|---|---|---|---|---|---|---|---|---|---|
| KTO/46 | 5 | 5 | 5 | 5 | 5 | 5 | 5 | 5 | 5 | 5 |

UV Blockers

| | | | | | |
|---|---|---|---|---|---|
| UV-24 | 5 | | 2.5 | 5 | 10 |
| MC80 | | 5 | 2.5 | 5 | |

Diluents

| | | | | | | | | | | |
|---|---|---|---|---|---|---|---|---|---|---|
| SR-238 | 18 | 18 | 18 | 18 | 18 | 13 | 13 | 13 | 14 | 14 |

Main Components

| | | | | | | | | | | |
|---|---|---|---|---|---|---|---|---|---|---|
| SR-368 | 10 | 10 | | | | | | | | |
| SR-368D | | | 10 | 10 | 10 | 10 | 10 | 10 | 10 | 10 |
| CN-120 | | | | | | | | | | |
| CN120B60 | 66 | 66 | 66 | 66 | 66 | 66 | 66 | 66 | 60 | 60 |
| TOTAL | 100 | 100 | 100 | 100 | 100 | 100 | 100 | 100 | 100 | 100 |

Photoacid

| | | | | | | | | | | |
|---|---|---|---|---|---|---|---|---|---|---|
| TPST | 2 | 3 | 3 | 2 | 1.5 | 2 | 2 | 2 | 2 | 2 |

Colorformer

| | | | | | | | | | | |
|---|---|---|---|---|---|---|---|---|---|---|
| Pergascript Red 6B | 3 | 3 | 3 | 3 | 3 | 3 | 3 | 3 | 3 | 3 |

Absorbance

| | | | | | | | | | | |
|---|---|---|---|---|---|---|---|---|---|---|
| 4K | 0.38 | 0.5 | 0.5 | 0.38 | 0.25 | 0.33 | 0.55 | 0.43 | 0.25 | 0.23 |
| 6K | 0.32 | 0.47 | 0.43 | 0.31 | 0.22 | 0.33 | 0.43 | 0.38 | 0.25 | 0.23 |

Fading %

| | | | | | | | | | | |
|---|---|---|---|---|---|---|---|---|---|---|
| 4K | 19.3 | 25.5 | 25 | 26 | 16.3 | 22.3 | 27.2 | 24.1 | 30.5 | 38.6 |
| 6K | 27 | 40 | 40 | 30 | 29 | 28 | 36 | 34 | 39 | 35 |

2 seconds under L37 Xenon “C” lamp with nitrogen environment, imaged for 10 seconds at 5 inches, UV blockers 30 sec (15 × 2)

7. Triethyl Amine Fading Study

It was noted that the exposed color of the formulation based on SR-9021 (formulation 3) faded when in a basic environment. This was first realized when coated commercial disks were put back into their original packaging. Due to the basic nature of the paper and/or inks, the acid in the coating 100 that turns on the color neutralized thus making the color fade drastically. Another problem was noted when labels produced in an ink jet printer were put onto the label side of a coated disk 10 and into a storage case. Again, the images faded. Therefore, to quantitatively measure the amount of fading, a test was devised where a coated disk 10 would be put into the presence of triethyl amine (TEA) to simulate a basic environment. The disks 10 could then be measured to reveal the amount of fading.

Five disks 10 having a coating base including SR-9021 were spun coat, cured, and exposed for 10 seconds with L37 filter and nitrogen. Absorbance curves for each of the disks 10 were collected. The disks 10 were then put into storage cases 180 where filter paper 181 was placed in the open corners and center, as FIG. 18 shows.

FIG. 18 depicts a typical storage case 180 for an optical media wherein the grey areas denote locations where filter paper 181 was placed. One hundred μL of triethyl amine was deposited onto each section of the filter paper 181. Each case 180 was then closed and put into a dark drawer for 2 hours, after which time absorbance curves were taken to determine the amount of fading that had taken place.

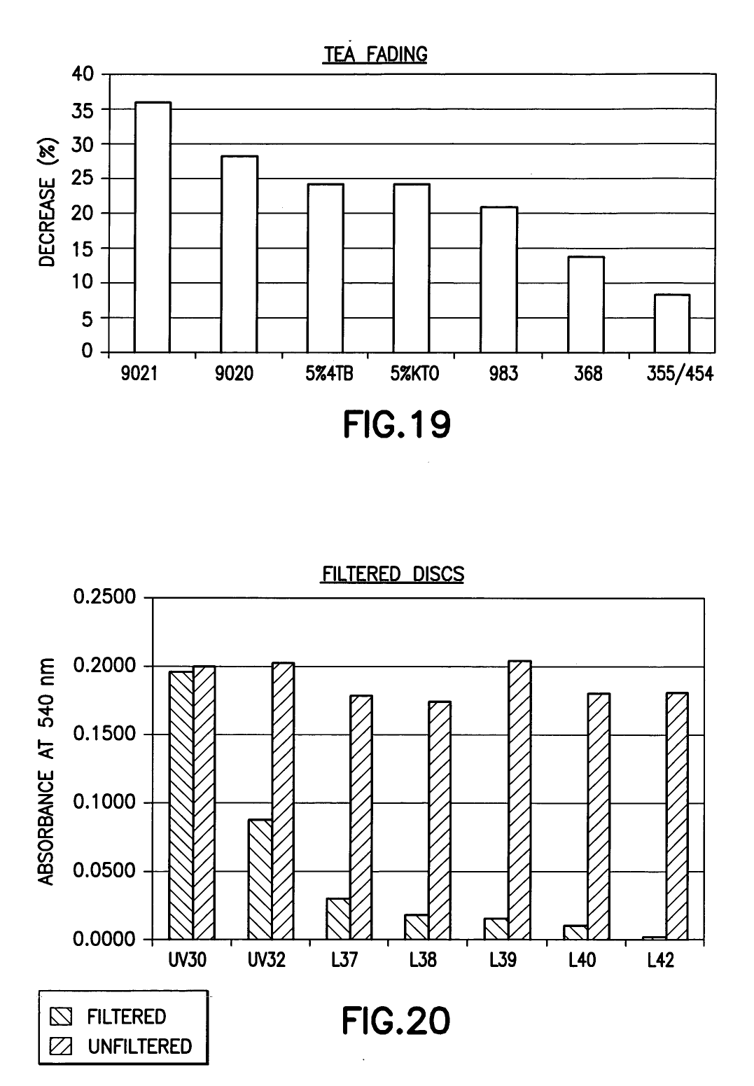

The results showed that the average amount of fading in the formulation tested was 36.0%. Since this was considered to be less than desired, other formulations were examined to determine if better results could be achieved. The formulations tested were based on 9020, 355/454, 5% 4TB, 5% KTO, 368, and 983 and the results are shown in FIG. 19. Note that all the formulations have 3% triphenylsulfonium triflate present except for 5% 4TB, which has 5% (4-tert-butylphenyl) diphenyl sulfonium triflate. FIG. 19 shows that some formulations are more resistant to fading in a basic environment, and that they generally trend with the environmental performance

8. Accelerated Light Testing

It was noted that the background color of the discs 10 having a coating 100 containing 9020 turned slightly red over time when in the presence of fluorescent room light. Therefore, another set of experiments was devised to evaluate the effect of ambient lighting upon images in the coating 100.

First, a test fixture consisting of a four foot long two-bulb fluorescent lamp fixture was fabricated. The lamp used was a Philips ECON—O-WATT F40-CW 37 watt, from Philips Lighting Co. of NJ. The fluence produced was approximately 250 mw/m² in the UV-A band, as measured by commercially available equipment.

To examine which wavelengths of light most effected background color formation, a set of discs 10 were prepared using formulation 10, based upon SR-9020. The discs 10 were cured and left unexposed to imaging wavelengths. The discs 10 were then set under the fluorescent light fixture with a portion of each disc 10 covered by a 2″×2″ filter glass to determine which wavelengths of light led to the greatest color formation. The discs 10 were then exposed to develop about 0.2 AU in an uncovered region. As shown in FIG. 20, the most damaging wavelengths appear to have been below about 370 nm, with wavelengths below about 320 nm being the most problematic. This seemed to indicate that the UVB portion of the spectrum was the bandwidth where UV protection would be most beneficial. FIG. 20 depicts results of illuminations, where UV-30, L-37, L-38, L-39, L-40 and L-42 denotes model names for commercially available UV filters from HOYA Corporation of Tokyo Japan.

In general, the name of the cutoff filter describes the 50% transmission point. For example, the UV-30 filter, which is rated for wavelengths at 300 nm, has a 50% transmission point at 300 nm. It is recognized that the 50% transmission point is approximate and can move slightly with thickness, so a thin piece of a L-37 filter might look very similar to a thick piece of UV-36, etc. So, while a 1 mm thick L-37 is generally preferred for applications herein, (having about 50% transmission at 370 nm), a thicker UV-36 filter can also work well, as well as a UV-34 filter in addition to some of the other filters. UV-32 is considered to be at about the lower limit, and above UV-39, curing becomes slow. Therefore, preferred cutoff filters provide for 50% transmission between about 320 nm to about 380 nm, and, most preferably, between about 340 nm to about 370 nm.

In an effort to fix color formation by background light, UV absorbers were added to samples of the formulation to see if color formation would slow or cease when the samples were subjected to ambient room light. The UV absorbers used were TINUVIN 327, TINUVIN 171, TINUVIN 213, and TINUVIN 571. TINUVIN 327 is 2,4-di-tert-bu tyl-6-(5-chlorobenzotria zol-2-yl) phenol; TINUVIN 171 is (2-(2H-benzotriazol-2-yl)-6-dodecyl-4-methyl-phenol); TINUVIN 213 is a mixture of reaction products of methyl 3-(3-(2H-benzotraizole-2-yl)-5-t-butyl-4-hydroxyphenyl) proprionate/PEG 300; and TINUVIN 571 is branched and linear 2-(2H-benzotriazol-2-yl)-6-dodecyl-4-methylphenol. The TINUVIN products are produced by Ciba Specialty Chemicals.

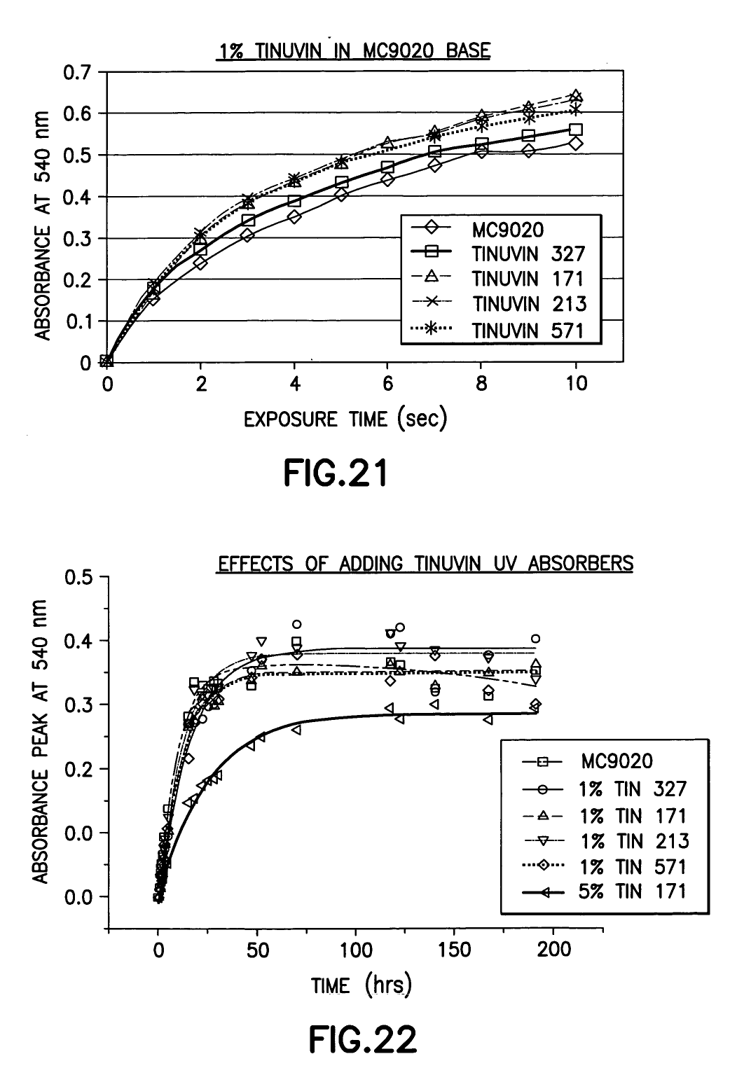

Each of the samples of TINUVIN were in liquid form, with the exception of TINUVIN 327 which was a powder. Testing was performed by adding one percent of each UV absorber to formulation 10, except one sample was made with 5% TINUVIN 171. However, since the point of the UV absorbers was to slow color formation, another step was performed to ensure that each sample could still produce enough color when imaged. FIG. 21 shows that the samples produced adequate color. In fact, samples incorporating UV absorbers produced more color than the sample without any UV absorbers (denoted as MC9020 in FIG. 21). Color formation in the sample containing 5% TINUVIN 171 was not confirmed, but a quick check was performed after 10 seconds of exposure, and showed that the absorbance at 540 nm was 0.40 OD.

Three cured (background color) disks 10 of each formulation were then illuminated by the fluorescent light test fixture. Absorbance curves were collected for the samples before the start of illumination, and throughout the test, usually daily, to monitor the background color formation. The condensed results are shown in FIG. 22, which depicts effects of adding UV absorbers as determined in an accelerated fluorescent light study.

FIG. 22 shows some types of TINUVIN work better than others but the comparative difference at 1% concentration is minimal. The sample containing 5% concentration of TINUVIN 171 exhibited better performance at reducing the color formation, but the difference was considered to be only a moderate effect. Use of the 5% concentration also caused a significant increase in the writing time required to produce an image. Attempts were made to prepare a formulation containing 10% of TINUVIN 171, however, the materials bloomed after curing (displayed color formation without exposure to an imaging light). The sample containing a 5% concentration of TINUVIN 171 showed the same effect after a longer time. Therefore, TINUVIN 171 was ruled out as most likely not being a good candidate for use as a UV absorber.

Combined with results from environmental testing, UV absorbers were tested in what was becoming the preferred formulation, one based upon CN-120 and SR-368. A series of three UV absorbers were used at 5% loading as shown in Table 18. Discs 10 were coated with formulation 80-82 by spincoating at a speed of 6K rpm, cured for two seconds about one inch away from the lamp, in a nitrogen environment. The discs 10 were exposed through a L37 filter for ten seconds, also about one inch away from the lamp. These discs 10 were compared to the base 9020 formulation without stabilization.

TABLE 18
Formulations for Testing of UV Absorbers

| | Formulation No./Name | | |
|---|---|---|---|
| | 80 | 81 | 82 |
| COMPONENT | MC80 | UV-24 | UV-531 |
| TEGO RAD 2200 N | 1 | 1 | 1 |
| KTO/46 | 5 | 5 | 5 |
| SR-238 | 44 | 44 | 44 |
| SR-368 | 10 | 10 | 10 |
| CN-120 | 40 | 40 | 40 |
| TOTAL | 100 | 100 | 100 |
| MC80 | 5 | | |
| UV24 | | 5 | |
| UV-531 | | | 5 |
| TPST | 2 | 2 | 2 |
| Perg I-6B | 3 | 3 | 3 |

UV-24 is the shortened name for CYASORB UV-24, which is 2,2′-dihydroxy-4-methoxybenzophenone. UV-531 is the shortened name for CYASORB UV-531 FLAKE, which is 2-Hydroxy-4-n-octoxybenzophenone. Both are products of Cytec Corporation of Stamford, Conn. MC80 is the shortened name for UVINUL MC80, which is octyl methoxycinnamate, and is a product of BASF Corporation of Japan.

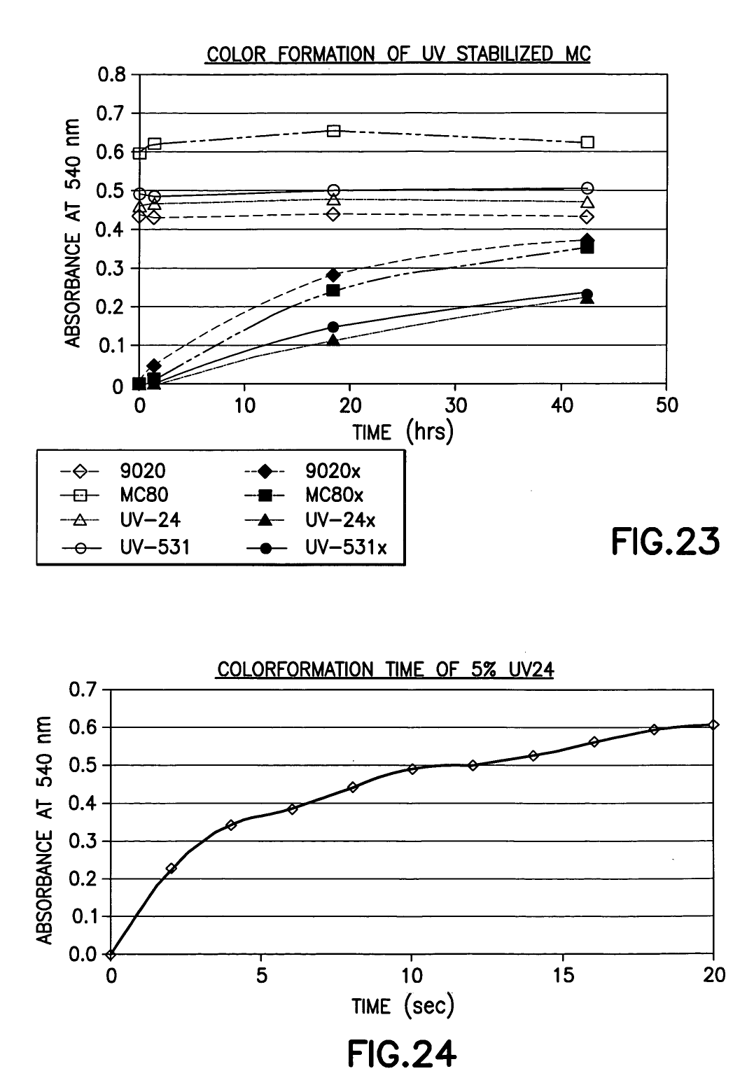

The UV stabilized formulations exhibited slower color formation times with lower ultimate colors for equivalent UV dose compared to unstabilized formulations. Results are depicted in FIG. 23. However the longer color formation time (or higher fluence) was considered to be outside of the required cycle time for the manufacturing specification. Furthermore, the high fluence rates required to write into these coatings caused some undesired physical deformations (such as shrinkage and warp), as well as differences in the properties of the coating between exposed and unexposed areas. As an example, the color formation time of formulation 81 is shown in FIG. 24. Even at about one inch away from the XENON lamp, exposure times of more than ten seconds were required to obtain color formation greater than 0.5 AU.

9. Photoacid Generators Reexamined

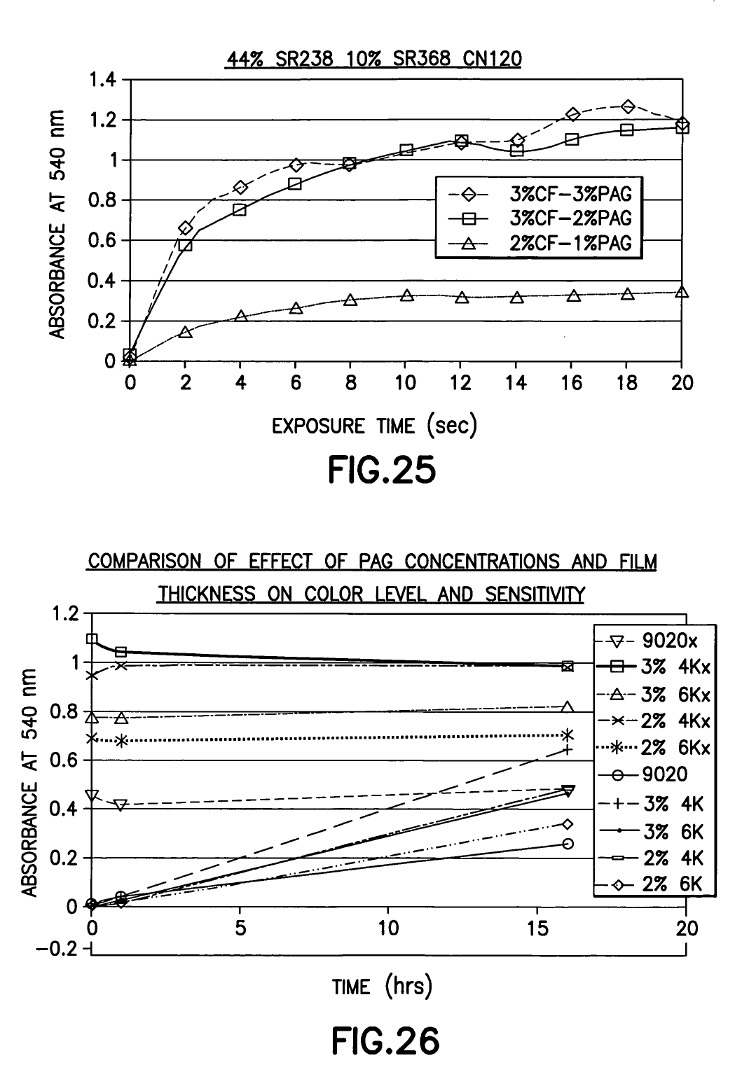

Since the addition of UV absorbers directly into the coating 100 was causing long writing times for only minimal gain in light stability, re-examination of various photoacid generators and their concentrations was undertaken. It was noted that higher concentrations of photoacid generators tended to lead to faster writing times for a fixed color former concentration. It was considered that the photoacid generator could potentially be controlled to provide for generation of a desired color level in an acceptable cycle time. However, for various reasons (including economic), use of a minimal amount of photoacid generators was desired. One of the first steps was to optimize color formation versus a ratio of photoacid generator to color former and coating 100 thickness. Results of a study are depicted in FIG. 25, and show that a ratio of 3:2 colorformer:TPST is preferable over a 1:1 ratio.

Results of a study (shown in FIG. 5) shows that the thickness of the coating 100 plays a role in color formation and light sensitivity. In the study, samples of a formulation were coated onto discs 10 by spincoating at 4K rpm and 6K rpm. This resulted in coatings 100 of different thicknesses. Discs 10 were cured for two seconds, about one inch away from the lamp, in a nitrogen environment. Exposed regions were imaged for ten seconds, also at about one inch away from the XENON lamp. Control samples based on a formulation including SR-9020 were produced using spincoating at 4K rpm. The control samples were exposed for 10 seconds at a distance of five inches from the lamp (since higher fluence was determined to cause fading in the formulation including SR-9020).

The results indicate that color formation takes place throughout the thickness of the coating 100, rather than with a heavy bias towards the surface. Therefore, it was considered desirable to optimize viscosity and spin speed to provide for the desired optical density with a minimum film thickness. This study provided a collateral benefit of also confirming that for 3% color former, 2% and 3% concentration of photoacid generator leads to the same ultimate color, but at different rates of formation.

10. Absorbance Spectra of Photoacid Generators and Films

At this point, it was considered that adequately stable triphenyl sulfonium triflate (TPST)-based formulations using UV absorbers might be impractical as being difficult to achieve. It appeared that the UV absorbers were simply absorbing the same wavelengths used for imaging, and not selectively absorbing the UVA-UVB from sunlight and fluorescent lighting. Therefore, the absorbance spectrum of the photoacid generators and the coating formulations were examined in order to refine wavelength regions that might be critical in these processes.

TPST was considered to be the simplest and shortest UV absorbing sulfonium-based photoacid generator available. Diphenyl iodonium hexafluorophosphate (DPI HXFP) was also considered to be a simple short UV absorbing photoacid generator. The absorbance spectra, of these two photoacid generators, shown in FIG. 5, have a maximum at approximately 200 nm, with a tail into the mid-UV.

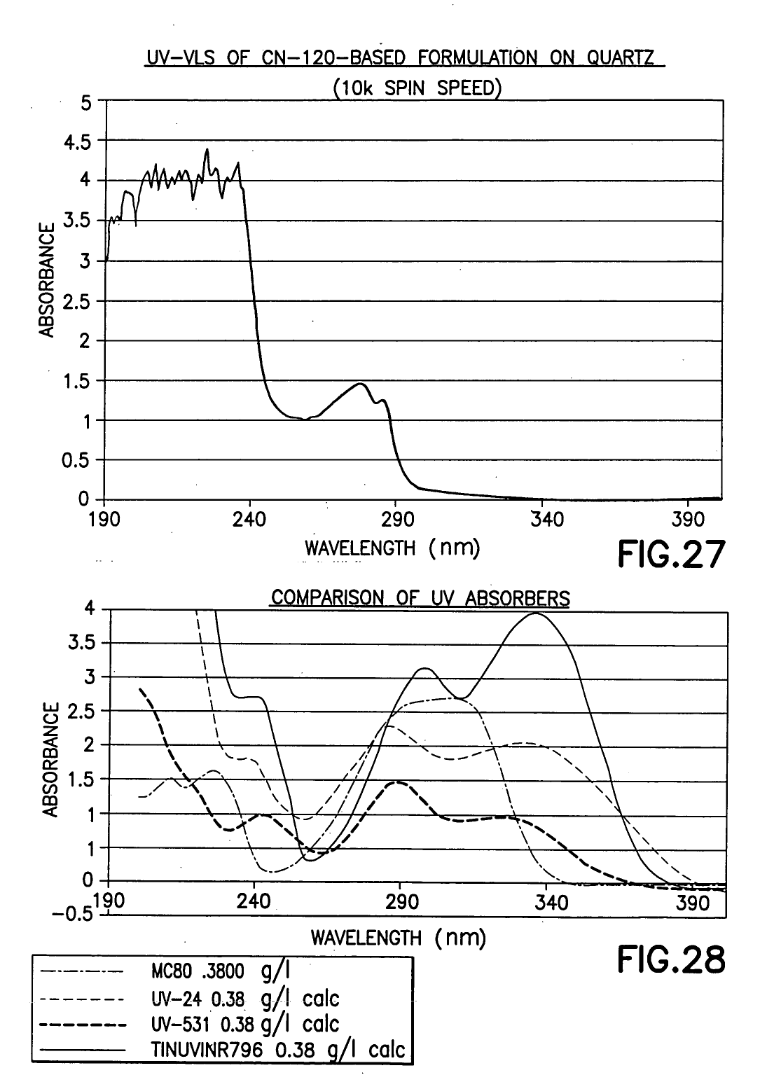

The spectrum of the CN-120-based formulation is shown in FIG. 27. Unlike the earlier formulations that were all aliphatic, these formulations had a considerable UV absorption in the mid-UV range, from about 250 nm to about 300 nm. It was also clear that the majority of the sensitive range of wavelengths for photoacid generators shared the high absorbance range of the acrylate matrix. Therefore, it was considered to be quite possible that the wavelengths most responsible for color formation through the depth of the coating 100 were not the short wavelengths (<250 nm), but the mid to long wavelengths, where the matrix optical density is low.

Since the short wavelengths were inefficient for image formation in the UV stabilized formulations, the ability to generate short UV in the laboratory as an advantage for imaging a much greater speeds than sunlight or fluorescent light can not be exploited. Therefore, use of higher intensities must be relied upon to image faster than the background color develops. One could conclude that the addition of UV absorbers slows down imaging to the same degree as background color formation form fluorescent lights and sunlight. Therefore it was considered that if UV fluence of 10,000 times greater than the ambient sunlight could be produced, and imaging could be performed in three seconds, this would be the equivalent of the sun generating the color in 30,000 seconds, or about 8 hours. Given that an unacceptable level of background color may be as low as 5% of the maximum color, the effective sunlight exposure forming an unacceptable level of background color could only be about 30 minutes. Therefore, it was considered that even using a fluence of 10,000 times, or greater, than the ambient sunlight (an unacceptably high dose from a materials stability standpoint), then light stability would only be extended to about 5 hours.

In looking at the UV absorbance spectrum of the matrix and UV absorbers, as shown in FIG. 28, one potential approach for overcoming problems with light stability was to look not for the shortest absorbing photoacid generator, but possibly for a photoacid generator with a maximum absorption wavelength closer to the mid-UV, where the coating 100 exhibited some degree of transmissive behavior. It was hoped that this would provide for UV blocking protection for the UV-A and UV-B regions, while sponsoring some imaging speed through effective use of UV-C radiation. A series of photoacid generators with longer UV transition were screened with this in mind. As used herein, it is considered that the wavelengths of UV-A are generally between about 320 nm to about 400 nm; UV-B wavelengths are generally about 270 nm to about 320 nm, and UV-C wavelengths are generally below about 270 nm. These bands of wavelengths, and other bands of wavelengths, may also be referred to as a “set of wavelengths.”

11. Photoacid Generator Screening For Imaging Speed

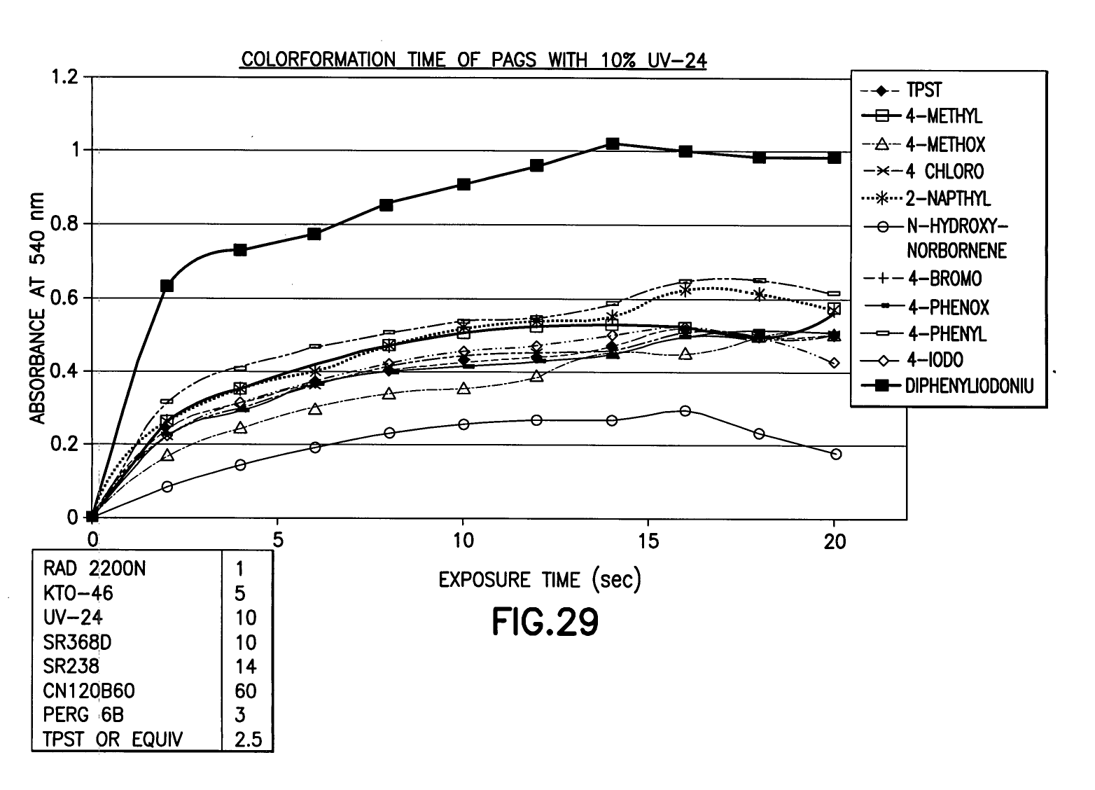

A formulation using 10% UV-24 as a UV absorber was prepared. The concentration of each photoacid generator was adjusted to be equivalent to 2.5% TPST on a molar basis. FIG. 29 shows the color formation curves for each formulation prepared. The samples shown in FIG. 29 were exposed at a distance of one inch from the XENON lamp. Some photoacid generators demonstrated faster color formation (writing) times than TPST, most notably the 4-phenoxy derivative.

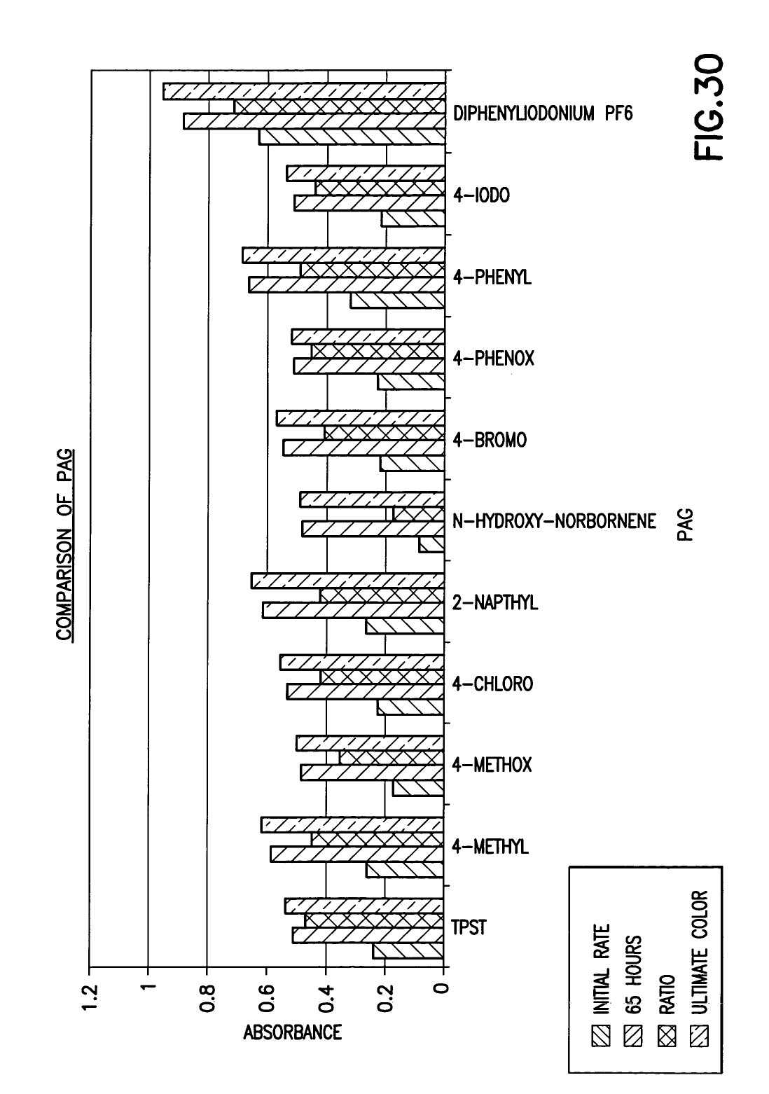

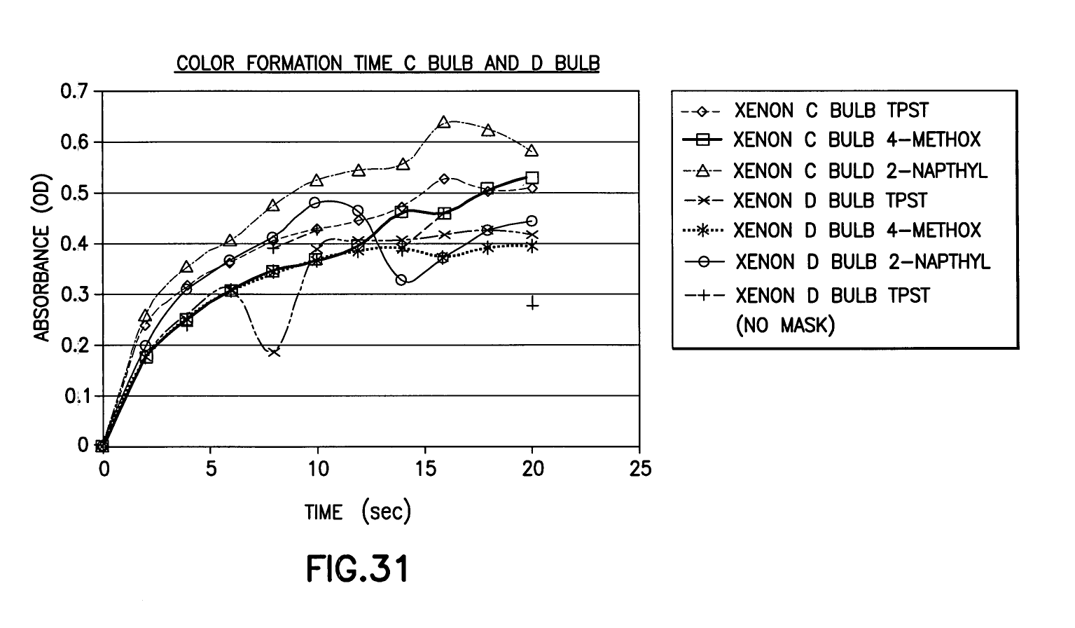

While these different photoacid generators provided for different writing speeds and color density, a more important performance parameter was considered to be whether or not the photoacid generators would provide for increased writing speed or color density without increased susceptibility to fluorescent and sunlight exposure. To examine this, discs 10 of each photoacid generator formulation were prepared and exposed for about 65 hours under the fluorescent light fixture. FIG. 30 shows that while each photoacid generator gave different writing speeds and ultimate colors, none significantly outperformed TPST in terms of the ratio between color formation time and subsequent fluorescent light stability. In fact, the data seemed to support that writing time with the XENON lamp was a direct predictor for subsequent light stability. Therefore, it was apparent that most of the light used to image from the XENON lamp is not the short UV (having wavelengths below about 250 nm) but the UVB (about 270 nm to about 320 nm) portion of the spectrum. This conclusion is also supported by the observation that the XENON “D” bulb does not improve writing times, as shown in FIG. 31. Although the “D” bulb produced more UV-C radiation than the “C” bulb, no increase in color formation time was noted.

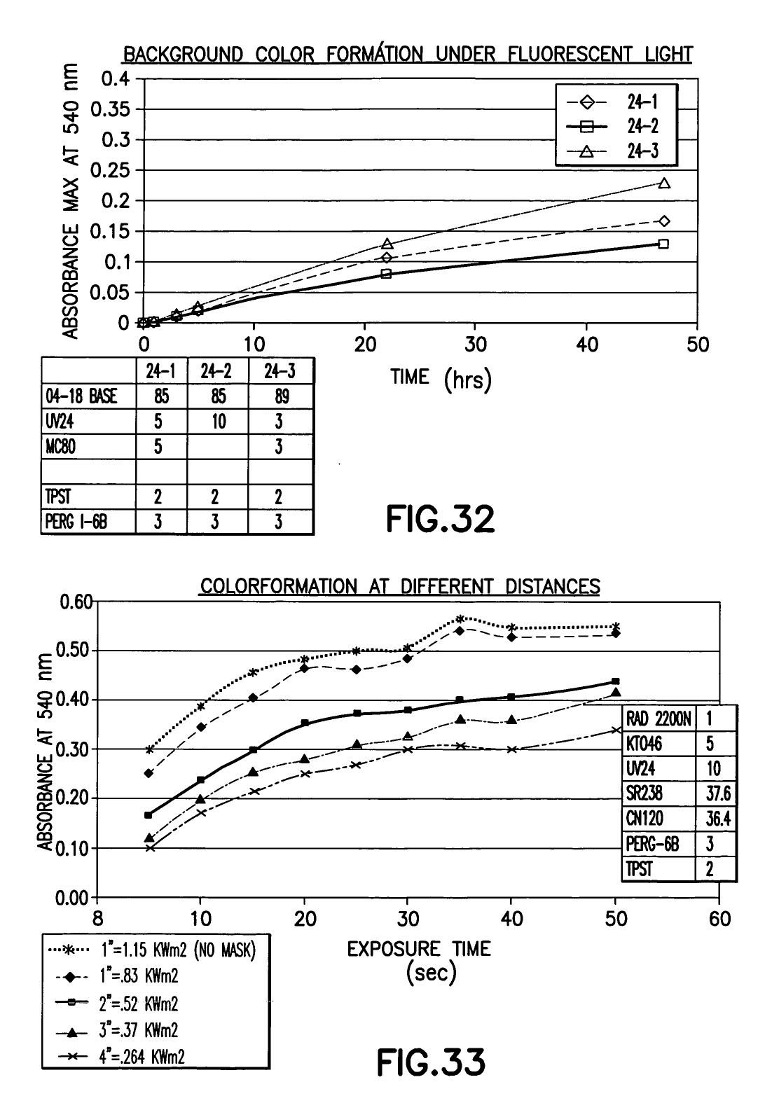

The use of higher concentrations of UV-24, as well as a combination of UV-24 and another absorber, MC80, were examined. The results, depicted in FIG. 32, show that higher concentrations of UV-absorber decrease sensitivity and that UV-24 alone is superior to a combination with MC80 at the same weight loading.

A further experiment was conducted to measure color formation times for a 10% UV-24 formulation. The UV-B power levels were measured at various distances from the lamp housing through a plastic mask. Also, at the closest distance of about one inch, a quartz mask was used to increase the UV-B power, mostly at the short end of the spectrum. The results, depicted in FIG. 33, show that for a 10% UV absorber formulation, the XENON lamp was not capable of developing an adequate fluence rate to produce an acceptable optical density within the desired cycle time close to three seconds. In fact, most of the coating 100 samples cracked or warped significantly. Also, it was noted that the elimination of the plastic mask lead to approximately 40% more UV-B, but only a slight increase in writing speed, again supporting the theory that the coating was optically dense in the short UV (<300 nm).

12. Color Enhancing Additives

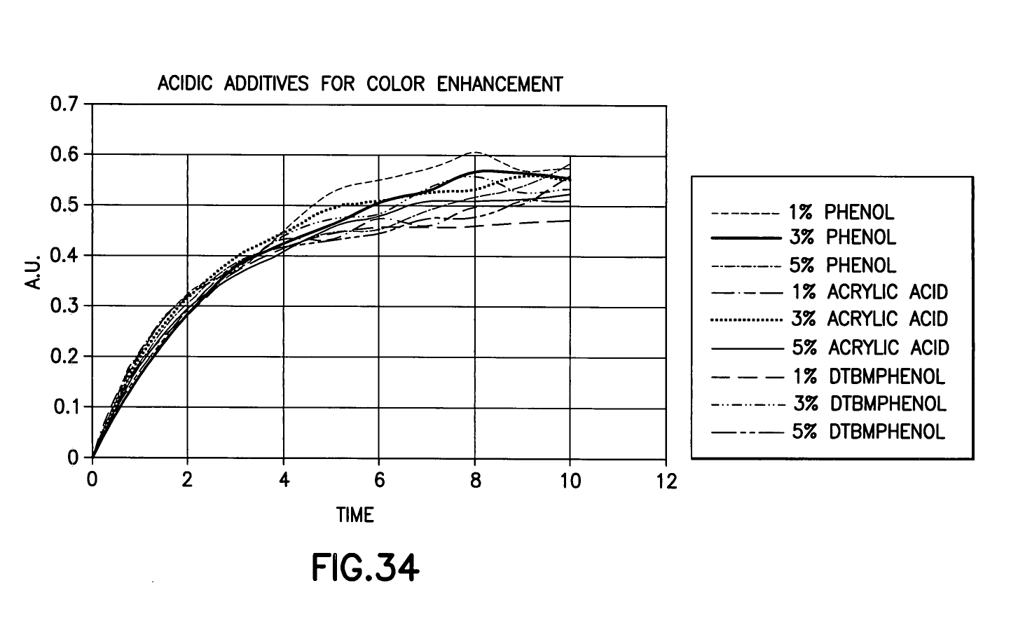

Several additives were tried in an attempt to decrease writing time in the UV absorber loaded coatings without a proportional increase in fluorescent and sunlight sensitivity. The first attempt involved a re-examination of color enhancing additives to make the acid generated more efficient. These efforts focused on the use of acids to “prime” the coating for color formation. The matrix used was formulation 10, which contained alkoxylated monomers. As shown in FIG. 34, both the concentration and composition of the acid used did not dramatically effect the writing speed, or ultimate color of the coatings. An additional experiment was tried using 2-acrylamido-2-methyl-1-propanesulfonic acid, a crosslinkable sulfonic acid. However, even at 1% loading, this acid was too strong and turned the coatings red without any UV exposure. Therefore, it seemed unlikely that doping with acids of various strengths or concentrations would help with color formation.

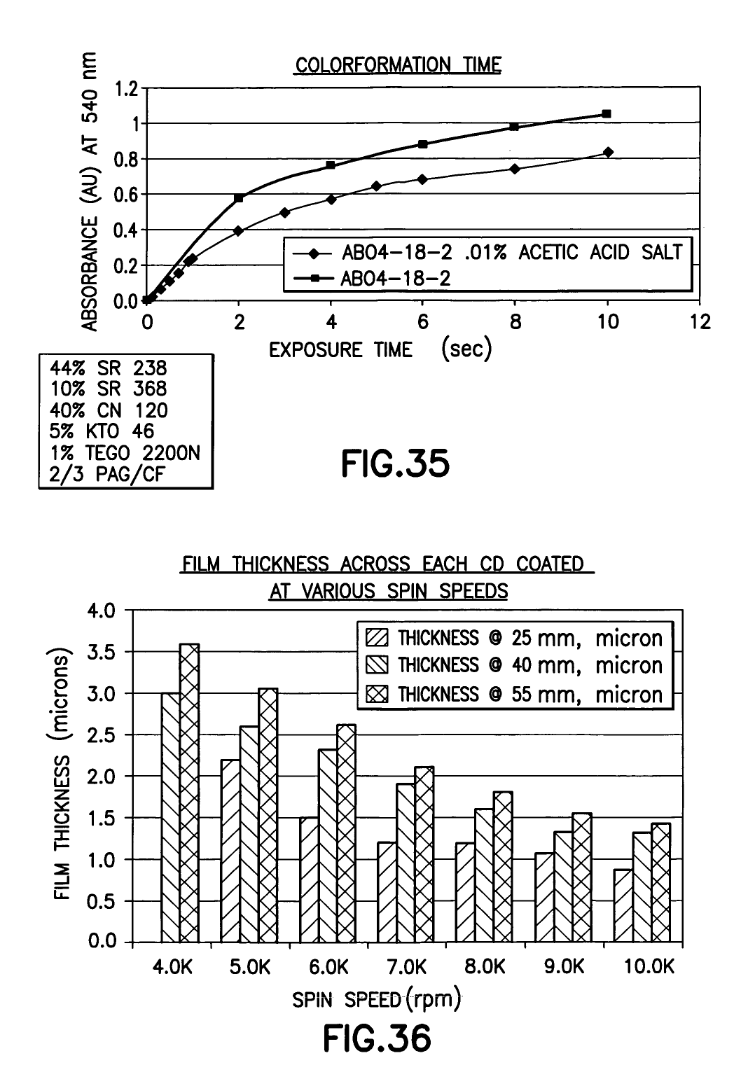

An additional approach to decreasing light sensitivity was evaluated, where a buffered system would be used. Using a buffered system, it was thought that low doses of UV would generate small amounts of additional acid which would be absorbed by the buffer. In this case, as triflic acid is an extremely strong acid, almost any base would be capable of scavenging (neutralizing) the acid generated. Initial experiments used acrylated amines, such as CN-384 from Sartomer Corporation. These amines proved to be too strong a base, and color formation was completely inhibited. In subsequent experiments, when smaller amounts of CN-384 were used, the background color was kept low, but the image stability was terrible and the color faded under ambient conditions in 24 hours or less. Therefore, use of a weak base was examined. Examples of weak bases included acetic acid and sodium salt. Unfortunately, these compounds were not very soluble in acrylates, and only 0.1% loading was achieved. However, even at this low loading, an effect was observed. The salt did act as a buffer, but it also reduced the rate of color formation and the overall color of the coating as well. Aspects of the use of buffers are depicted in FIG. 35.

13. Spin Coating, Film Thickness and Optical Density.

The purpose of this experiment was to correlate coating spin speed (rpm), optical density (absorbance at 540 nm) and film (coating 100) thickness (microns). Clear polycarbonate disks 10 were coated on a spin coating machine, known as the Headway Spin Coater. Formulation 3 was used, which had a viscosity of approximately 60 cps. Disks 10 were coated and spun for 10 seconds at 4,000 to 10,000 rpm (1.0K) increments. The disks were cured for two seconds using the XENON Pulse Lamp, in a nitrogen environment, and an L-37 UV filter. Half of each disk 10 was then exposed for 10 seconds under the lamp. UV scans were taken of each disk on both the cured and exposed sides and film thickness measurements were taken.

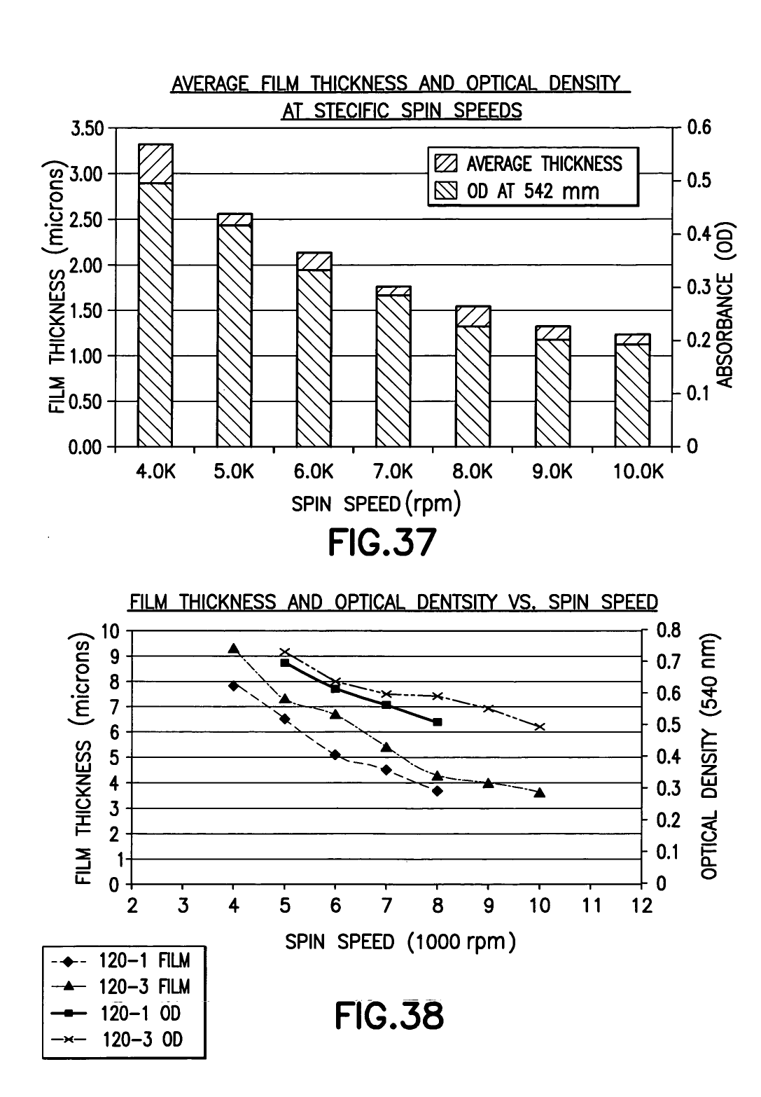

Measurements revealed that the film thickness varied from thinner to thicker from the dispense area out to the edge of the disc. The optical density of the discs 10 also scaled directly with thickness for various spin speeds. It was apparent that at the highest speeds (greater than about 8K rpm) these was a diminished effect on film thickness, as expected. Results are depicted in FIG. 36. In FIG. 36, the thickness of the film at selected distances from the dispense area is shown. Assessments of optical density and film thickness for various spin coating speeds is shown in FIG. 37.

Formulations 58 (375 cps) and 61 (504 cps) were coated at incrementing spin speeds 5-10K. Optical Density and film thickness determinations were performed, and the results are shown in FIG. 38. As expected, the more viscous formulation produced a thicker film. Also of interest is that both of these more viscous formulations produced a more linear response of film thickness to spin speed. In the finished product, methods for controlling color may include controlling exposure time or varying the formulation, however, it is considered that will be less attractive that varying film thickness will typically be preferable. That is, varying film thickness has a beneficial aspect of permitting an end user to dispense a minimum amount of material needed for a given color density, thereby providing for reduced costs and reducing light sensitivity.

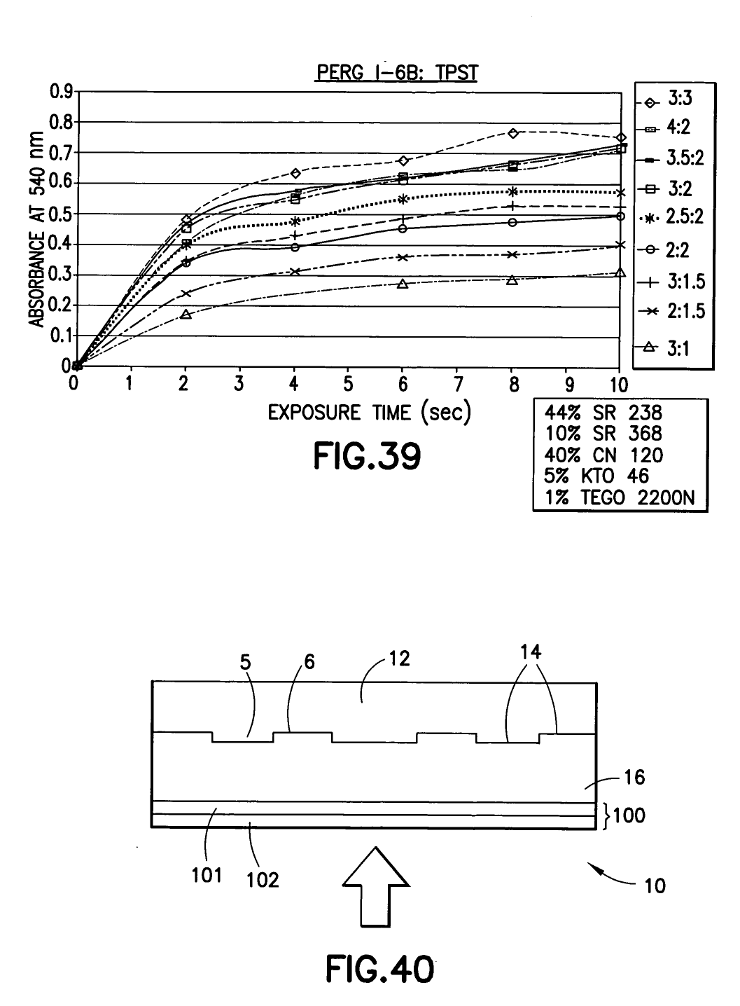

A further optimization of photoacid generator concentration was undertaken, and is depicted in FIG. 39. FIG. 39 shows the relation ship between photoacid generator (TPST) and color former (PERGASCRIPT I-6B) concentrations and optical densities for a constant film thickness. Optical densities were measured on discs 10 cured for 2 seconds, in a nitrogen environment at about one inch from the lamp. These samples were then exposed at one inch from the lamp, for the indicated times.

B. Multiple Coating Development

It became clear that an acceptable balance between cycle time, UV fluence and subsequent light sensitivity was not going to be reached in a single coating formulation. It was considered that an alternative could be the use of two coatings, one designed to give fast color formation and image stability, and a second overcoat to give the desired UV stability. The second overcoat could provide for further beneficial effects, such as scratch resistance and added environmental stability to humidity and bases.

FIG. 40 depicts a cross section of an embodiment of an optical media 10. In FIG. 40, the disc 10 contains pits 5 and land 6 as data features. In this embodiment, the disc 10 is formed of a substrate 16 and includes a reflective layer 14. The color forming coating 100, as described in the foregoing, it shown as being formed of two components. The first component of the color forming coating 100 is the color forming layer 101. The second component of the color forming coating 100 is the overcoat 102.

1. Color Coating and Overcoat Development

The first step in development of the color forming coating 100 was to evaluate the properties that could be divided between the color forming layer 101 and the overcoat layer 102 to provide for simplified formulations. For the color forming layer 101, adhesion to polycarbonate, good color formation, photoacid generator and color former solubility, were desired. For the overcoat 102, good curing to a hard mar resistant surface, high optical density in the V, and adhesion to the underlying color forming layer 101 were desired. Both layers 101, 102 would ideally cure quickly without nitrogen, be low shrinkage, and work together to increase environmental stability of the image (i.e., resistance to the influence of heat, humidity or the introduction of additional chemicals).

Considering prior development, the CN-120-based formulations produced the best environmental results, but exhibited higher optically denser for the color forming wavelengths than all of the aliphatic formulations such as formulations 1 and 9. However, since the addition of an overcoat 102 might be used to enhance the stability of the image in heat/humidity testing, non-CN-120 formulation were again examined, with a goal of decreasing writing times and decreasing shrinkage.

Initial experiments showed that the removal of the wetting agent from the color forming layer 101 would be necessary to let the second coating 102 wet and adhere to the color forming layer 101. A quick series of formulations were screened. These are presented in Table 19.

TABLE 19
Initial Color Coating Formulations for Two Layer System

| Color Forming Layer | | | Overcoat | |
|---|---|---|---|---|
| C1 | C2 | C3 | O1 | O2 |

Wetting Agent

| | | | | | |
|---|---|---|---|---|---|
| TEGO RAD 2200 N | 0 | 0 | 0 | 2 | 2 |

Photoinitiator

| | | | | | |
|---|---|---|---|---|---|
| KTO/46 | 5 | 5 | 5 | 5 | 5 |

Diluents

| | | | | | |
|---|---|---|---|---|---|
| SR-238 | 10 | 35 | 35 | 20 | 30 |

Main Components

| | | | | | |
|---|---|---|---|---|---|
| SR-9021 | | | 30 | | |
| SR-368D | 20 | 30 | 30 | 73 | 30 |
| CN-120B60 | 65 | 30 | | | 33 |
| TOTAL | 100 | 100 | 100 | 100 | 100 |
| UV-24 | | | | 10 | 10 |
| TPST | 2.5 | 2.5 | 2.5 | | |
| Pergascript Red 6B | 3.5 | 3.5 | 3.5 | | |

Formulations C1 and C2 contained reduced CN-120 content and increased SR-368 content for increased clarity in the UV and decreased shrinkage for adhesion. Formulation C3 contained SR-9021 and SR-368 to provide for a low shrinkage, high adhesion, fast curing, and UV transmissive coating. Formulations O1 and O2 contained a SR-238 and SR-368 combination to provide for good adhesion and cure, with CN-120 in formulation O2 for additional hardness and UV opacity. In formulations O1 and O2, UV absorber UV-24 was used at 10% loading. An immediate observation was that, as before, the photoacid generator was minimally soluble in the alkoxylated monomer SR-9021. (As may be apparent, formulations designated with a “C” indicate a formulation for the color forming layer 101, while an “O” designation indicate a formulation for the overcoat layer 102.)

Sample discs 10 were prepared by spin coating color forming layers 101 with formulations C1, C2, and C3 onto substrate 16 at 4K rpm, curing in a nitrogen environment, through a L37 UV filter with a “D” bulb, at a distance of about one inch, for three seconds. Imaging through a quartz mask was performed at about five inches from the lamp for 10 seconds. The overcoat layers 102 (formulations O1 and O2) were applied over the color forming layer 101 by spincoating at 2.5K rpm. The overcoat layers 102 were cured in a nitrogen environment, using a L37 UV filter with a “D” bulb at about one inch from the lamp for 3 seconds. Color forming layers 101 made of formulations C2 and C3 wet and spun nicely, while formulation C1 did not perform as well. Both formulations O1 and O2 for the overcoat layer 102 wet nicely and coated all the color forming layer 101 well. All finished discs 10 were mar resistant to a plastic pen tip.

A tape pull test utilizing a 2.5 mm spacing blade was performed using SCOTCH tape as a light adhesive tape. (PERMACEL #99 did not adhere well enough to the coating to be used). Color forming layer 101 formed of formulation C1 failed, while color forming layers 101 formed of formulations C2 and C3 passed the test. Both overcoat layers 102 (O1 and O2) adhered to the color forming layers 101 without any problems. When adhesion of the overcoat layer 102 was problematic, it was noted that failures occurred at the interface of the polycarbonate layer 16 and the color forming layer 101 (as expected).

From these initial experiments, a candidate two layer coating 100 was designed. These formulations are presented in Table 20. The color forming layer 101 was modified to decrease the concentration of CN-120 and to increase transparency and adhesion. The photoacid generator to color former ratio was increased to 3:4.5 to increase writing speed and color intensity. The overcoat layer 102 was a formulation of SR-368 and SR-238.

TABLE 20
Initial Two Coating System

Formulation No.

| Component | C4 | O1 |
|---|---|---|
| Wetting Agent | | |
| TEGO RAD 2200 N | 0 | 2 |
| Photoinitiator | | |
| KTO/46 | 5 | 5 |
| Diluents | | |
| SR-238 | 20 | 20 |
| Main Components | | |
| SR-368D | 40 | 73 |
| CN-120B60 | 35 | |
| TOTAL | 100 | 100 |
| UV-24 | | 10 |
| TPST | 3 | |
| Pergascript Red 6B | 4.5 | |

2. Initial Testing

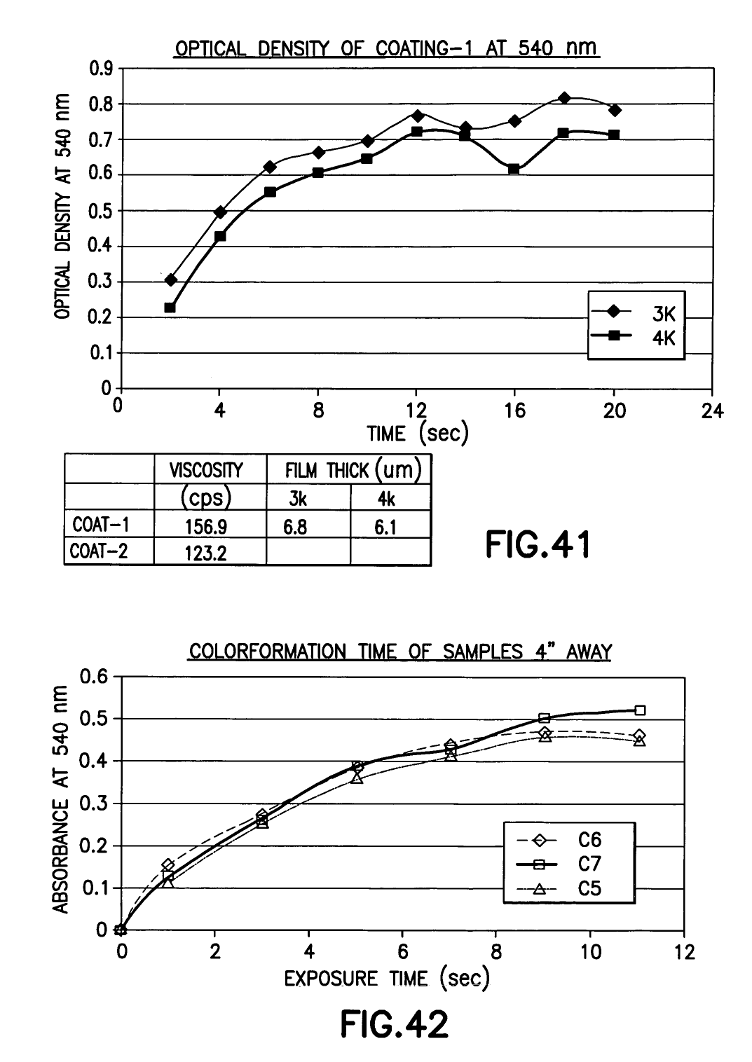

Experiments proceeded for testing the two layer coating 100. Discs 10 were coated with color forming layer 101 by spin coating at 3K and 4K rpm, as shown in FIG. 41. The discs 10 were imaged at about 5″ from the lamp for various times to examine color intensity. The overcoat 102 was then applied by spincoating at 3K rpm. The use of nitrogen and filters were also examined in this study. Nitrogen was not required to cure the color forming layer 101 to an acceptable level to provide for application of the overcoat 102. It is considered that foregoing use of nitrogen for curing the color forming layer 101 may have the added advantage of forming a seamless bond between the color layer 101 and the overcoat 102. The overcoat 102 was then cured at about one inch from the lamp for 1.5 seconds without nitrogen and without the use of a filter, thus giving the full spectrum of lamp radiation to enhance surface cure. The underlying color forming layer 101 did not appear to form any noticeable color from the curing of the topcoat 102.

The 3:4.5 photoacid generator to color former ratio proved to be high and lead to very strong color. Optical densities of approximately 0.8 were achieved in short times at 5¼ inches on the XENON “D” bulb.

More importantly, a qualitative exposure test (63 hours) using the fluorescent light fixture showed that the overcoat performance in the light test was far superior to the single coating solution. Also of interest was that images which appeared too dark (too much contrast) at first, now appeared better with some background color which reduced the contrast.

Most importantly, separation of the UV stabilizing layer and color forming layer 101 allows the efficient use of shorter UV wavelengths (<320 nm) for color formation. This allows for efficient exposure of the color forming layer 101 using these wavelengths, then shielding the layer 101 from these and wavelengths found in typical illumination such as sunlight and fluorescent lighting.

However, it was noted that using this combination of layers 101, 102 required further investigation into adhesion properties. The color forming layer 101 did not adhere to the underlying polycarbonate 16, failing the tape pull test using the light adhesive tape. The adhesion failure was only encountered at the interface of the polycarbonate 16 and color forming layer 101, so an assessment of color forming layer 101 to overcoat layer 102 adhesion was not possible.

3. Environmental Testing

At this point, the knowledge gained from the preliminary two coating experiments was condensed and provided a basis for the development of a further series of formulations. These formulations were to be examined for quantitative environmental testing, and are set forth in Table 21.

Formulation C5 was the previous SR-9021 based formulation 3 (Table 14) which had excellent properties but failed environment testing. It was considered that an overcoat 102 might improve the environmental stability of a color forming layer 101 which used formulation C3, and provide enough protection to avoid the use of the high shrinkage, UV absorbing CN-120. Formulation C6 was a modification to Formulation C5, where SR-368 was used in place of SR-494. It was theorized that this substitution would decrease the alkoxylation content and lead to a harder but still low shrinkage film 101 or color forming layer 101. Formulation C7 was a modified formulation containing CN-120, SR-368, SR-238 designed to meet adhesion requirements. It was considered that a color forming layer 101 containing formulation C7 should pass environmental testing with ease, albeit at the expense of writing time and shrinkage. It was expected that formulation O3 would yield a hard, UV absorbing overcoat which may have shrinkage issues, due to the CN-120. Formulation O4 was predominantly formed of SR-368, with use of SR-339 as the diluent for added UV absorption. Formulation O5 was a SR-9021 based overcoat with CN-120 added for hardness. Formulation O5 was devised with the hope that the SR-9021 would manage shrinkage without sacrificing hardness and scratch resistance. Overcoats 102 were formulated using both 10% and 20% UV-24. The 20% loadings noticeable affected the viscosity.

TABLE 21
Formulations from Preliminary Two Coating Experiments

| | Formulation No. | | | | | |
|---|---|---|---|---|---|---|
| Component | C5 | C6 | C7 | O3 | O4 | O5 |

Wetting Agent

| | | | | | | |
|---|---|---|---|---|---|---|
| TEGO RAD 2200 N | 0 | 0 | 0 | 1 | 1 | 1 |

Photoinitiator

| | | | | | | |
|---|---|---|---|---|---|---|
| KTO/46 | 5 | 5 | 5 | 5 | 5 | 5 |

Diluents

| | | | | | | |
|---|---|---|---|---|---|---|
| SR-238 | 25 | 20 | 35 | | | 14 |
| SR-339 | | | | 34 | 10 | |

Main Components

| | | | | | | |
|---|---|---|---|---|---|---|
| SR-9021 | 35 | 35 | | | | 50 |
| SR-494 | 35 | | | | | |
| SR-368D | | 40 | 30 | 10 | 84 | |
| CN-120B60 | | | 30 | 50 | | 30 |
| CN-132 | | | | | | |
| TOTAL | 100 | 100 | 100 | 100 | 100 | 100 |
| UV-24 | | | | 10-20 | 10-20 | 10-20 |
| TPST | 2 | 2 | 2 | | | |
| Pergascript Red 6B | 3 | 3 | 3 | | | |
| Viscosity | 61 | 83 | 68 | 134 | 200 | 162 |
| 20% UV 24 | | | | 102 | 404 | 236 |

In terms of solubility for the photoacid generator and the color former, both formulations C5 and C7, which contained alkoxylated SR-9021, had problems dissolving the solids without heat and ultrasound. Both C5 and C7 required filtration. Formulations O4 and O5 had trouble solubilizing the 20% concentration of UV-24. Formulations O4 and O5 were also filtered.

The color coat formulations were applied by spin coating at 4K rpm and then cured in ambient air at about one inch under the lamp, using the L37 filter for 2 seconds. It was noted that the discs 10 cured with a varying amount of “pinkness.” The pinkness ranged from no color for C5, to very slight color for C6, to slight color for C7. It was hypothesized that this most likely tracked the optical density of the coatings, since C7 had the highest aromatic content, C6 contained SR-368 which absorbs some UV, and C5 was the most UV transmissive of the coatings.

Imaging was performed at about 4″ from the lamp, with the “D” bulb for 10 seconds, through a chrome-on-quartz mask. Top coats 102 were applied by spin coating at 4K rpm and cured at about one inch from the lamp, using a “D” bulb with full spectrum. Curing was for 1.5 seconds (for the 10% UVA set) or 2.0 seconds (for the 20% UVA set).

Environmental testing was performed at about 70° C. and 90% relative humidity for 78 hours. Overcoats 102 which contained 20% UV absorber either partially or completely delaminated. The mechanism appeared to be shrinkage or swelling of the overcoat 102, which then caused delamination of the color coating 101 from the polycarbonate layer 16 of the disc 10. The second observation was that the composition of the color layer 101 was the major driving factor in determining image stability. Formulation C7 outperformed versions C6 and C5 by a wide margin. Coating C5 completely failed as before, regardless of the over coating 102 used. Coating C6 was better than C5, but still not even close to C7, again regardless of the over coating 102. Formulation C7 outperformed the other coatings 101 even without an overcoat 102. Results are depicted in FIG. 42.

Regarding overcoat 102 applications having 10% loading, each sample appeared to remain stable in terms of adhesion and hardness. Further, a trend of underlying image stability was noted in regard to the 1c undercoated samples. That is, formulation O3 performed better than O4, which performed much better than O5, which performed better that no overcoat 102. This again tracks with the lack of alkoxylation and potentially the glass transition temperature and hydrophobicity of the coating 100.

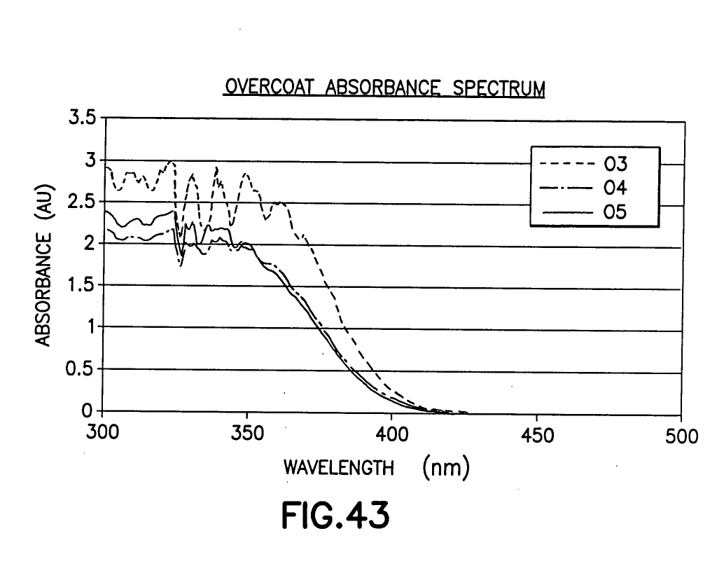

All the samples performed very well under the fluorescent lamp fixture as determined by visual inspection. After a week of exposure to the fluorescent light some background color developed, and after several weeks of exposure to the fluorescent light the image was still discernable, but degraded due to background color intensity. The 20% loading samples performed well for limiting background color development, were considered to be of limited use due to the environmental issues discussed above. The CN-120 based formulation O3, which had the highest aromatic content, gave the highest optical density in a coating 100, and provided for the best performance in the lightfastness as well. Absorbance spectra for the overcoat formulations O3, O4, O5 are depicted in FIG. 43.

4. Adjustments to Two Coating Formulations

A series of acrylated urethanes from Sartomer Corporation were also tested in order to examine their applicability to use in the coating 100. The series is shown in Table 22. All of the coatings using acrylated urethanes gave soft, easy to mar finishes that did not look as though they would perform well. No further testing was performed.

TABLE 22
Evaluation of Acrylated Urethanes in an Overcoat

Formulation No.

| Component | O6 | O7 | O8 | O9 |
|---|---|---|---|---|
| Wetting Agent | | | | |
| TEGO RAD 2200 N | 0 | 0 | 0 | 1 |
| Photoinitiator | | | | |
| KTO/46 | 5 | 5 | 5 | 5 |
| Diluents | | | | |
| SR-238 | 20 | 20 | 20 | |
| SR-339 | | | | 20 |
| Main Components | | | | |
| CN963B80 | | | | 50 |
| CN965 | 50 | | | |
| CN966B85 | | 50 | | |
| CN981B88 | | | 75 | |
| SR368D | 25 | 25 | | 20 |
| TOTAL | 100 | 100 | 100 | 96 |
| UV-24 | | | | 10 |
| TPST | 2 | 2 | 2 | |
| Pergascript Red 6B | 3 | 3 | 3 | |

CN965 is an aliphatic polyester based urethane diacrylate oligomer. It is a flexible oligomer offering good weatherability. CN966B85 is an aliphatic polyester based urethane diacrylate oligomer blended with 15% SR238, hexanediol diacrylate. CN981B88 is an aliphatic polyester/polymer based urethane diacrylate oligomer blended with 12% SR238, hexanediol diacrylate monomer. All three are products of Sartomer Corporation.

Since it appeared that the CN-120 formulations were not going to be replaced by any other monomer class, further experimentation was undertaken to adjust for other components and to improve aspects of performance. The formulations and with an explanatory note for the rationale behind each adjustment are presented in Table 23.

TABLE 23
Adjustments to CN-120 Formulations

| | Formulation No. | | | | | | | | |
|---|---|---|---|---|---|---|---|---|---|
| Component | C8 | C9 | C10 | C11 | C12 | O10 | O11 | O12 | O13 |

Wetting Agent

| | | | | |
|---|---|---|---|---|
| TEGO RAD 2200 N | 1 | 1 | 1 | 1 |

Photoinitiator

| | | | | | | | | | |
|---|---|---|---|---|---|---|---|---|---|
| KTO/46 | 5 | 5 | 5 | 5 | 5 | 7.5 | 7.5 | 7.5 | 8 |
| CN-384 | | | | | | 10 | | | |

Diluents

| | | | | | | | | | |
|---|---|---|---|---|---|---|---|---|---|
| SR-506 | | | | 15 | 35 | | | | |
| SR-238 | | | 35 | 20 | | | | | |
| SR-339 | 35 | 35 | | | | 30 | 39 | 30 | 26 |

Main Components

| | | | | | | | | | |
|---|---|---|---|---|---|---|---|---|---|
| SR-368D | 30 | 30 | 30 | 30 | 30 | 10 | 10 | 18 | 20 |
| CN-120B60 | 30 | | | 30 | 30 | | | | |
| CN-120M50 | | 30 | 30 | | | 41.5 | 22.5 | | 25 |
| SB520M35 | | | | | | | 20 | 43.5 | 20 |
| TOTAL | 100 | 100 | 100 | 100 | 100 | 100 | 100 | 100 | 100 |

PIGMENTS

| | | | | | | | | | |
|---|---|---|---|---|---|---|---|---|---|
| UV-24 | | | | | | 10 | 10 | 10 | 10 |
| TPST | 2 | 2 | 2 | 2 | 2 | | | | |
| Pergascript Red 6B | 3 | 3 | 3 | 3 | 3 | | | | |
| Viscosity | 93.19 | 93.54 | | | | 128 | 88 | 217 | 187 |
| Adhesion | Terrible | Terrible | moderate | Terrible | Terrible | GOOD | GOOD | GOOD | GOOD |
| Cure/hardness | good | good | | | | good | soft | soft | good |

Synergists cause terrible loss of color in environmental testing, probably due to acid migration and quenching

Explanatory notes for Table 23:

| | |
|---|---|
| C8 | Reduced SR-238 content with SR-339, reduced shrinkage, |
| | writing time might go up |
| C9 | Eliminated SR-238, with SR-339, reduce shrinkage, |
| | increase in writing time |
| C10 | Reduced SR-238 with SR-339, reduced shrinkage, |
| | writing time might go up |
| C11 | Reduced SR-238 with SR-506 reduced shrinkage, |
| | no increase in writing speed |
| C12 | Eliminate SR-238 using SR-506 to reduce shrinkage, |
| | increase Tg, and retain writing speed |
| O10 | Eliminate SR-238 to increase optical density and |
| | reduced shrinkage, also use synergist for curing. |
| O11 | Addition of Acid functionality to improve ink |
| | resistance, no synergist |
| O12 | All acid topcoat, low shrinkage, hard, UV absorbing. |
| O13 | Harder version of O11 |

The study led to the recognition that a moderate reduction in SR-238 concentration in the color coatings led to loss of adhesion to polycarbonate. However, the overcoat layers 102 could be based on SR-339 as the diluent, which would provide for excellent UV absorbing properties, reduced shrinkage, and lower skin irritation. This study also provided for an observation that inclusion of an amine synergist in the topcoat 102 still leads to complete loss of an image as a result of environmental testing in as little as 24 hours. This was considered unfortunate since addition of a synergist to the topcoat 102 led to fast and complete curing at 7.5% loading of KTO-46.

SR-339, 2-phenoxyethyl acrylate, is a low volatility monofunctional, aromatic monomer which offers good adhesion properties. CN120M50 is a difunctional bisphenol A based epoxy acrylate blended with 50% SR-339, phenoxy ethyl acrylate. CN120M50 provides a good balance of water properties and high reactivity. SB520M35 is a moderately functional, carboxylic acid containing acrylate oligomer blended in SR-339, phenoxy ethyl acrylate monomer. Reactive solids are 100%. SB520M35 offers a fast cure rate, excellent adhesion to metals and plastics, and good wetting and flow characteristics. SB520M35 also contains carboxylic acid functionality, which leads to improved amine fading resistance. These three acrylates are products of Sartomer Corporation.

After the various screening studies were completed, concluding testing was performed on a preferred color coat formulation with two preferred overcoat formulations. The overcoat formulations selected were chosen because the inclusion of an acidic oligomer, such as SB-520, had not been tested in the environmental studies, nor had the utility of the acid in imparting resistance to ink fading been confirmed. The final formulations are shown in Table 24.

TABLE 24
Final Formulations for Two Coat System

Formulation No.

| Component | C13 | C14 | O14 | O13 |
|---|---|---|---|---|
| Wetting Agent | | | | |
| TEGO RAD 2200 N | | | 1 | 1 |
| Photoinitiator | | | | |
| KTO/46 | 5 | 5 | 8 | 8 |
| CN-384 | | | | |
| Diluents | | | | |
| SR-506 | | | | |
| SR-238 | 35 | 35 | | |
| SR-339 | | | 26 | 26 |
| Main Components | | | | |
| SR-368D | 30 | 30 | 20 | 20 |
| CN-120B60 | 30 | 30 | | |
| CN-120M50 | | | 45 | 25 |
| SB520M35 | | | | 20 |
| TOTAL | 100 | 100 | 100 | 100 |
| PIGMENTS | | | | |
| UV-24 | | | 10 | 10 |
| TPST | 2 | 2.5 | | |
| Pergascript Red 6B | 3 | 4 | | |
| Viscosity | 68 | | | 187 |

Two concentrations of photoacid generators and color formers were studied, since the final photoacid generator and color former ratio and concentrations weren't precisely established as yet. Two spin speeds were used for both coatings, which were 3K and 4K rpm. Bottom coats were cured for three seconds through an L37 filter, without nitrogen. Exposure was for 10 seconds at about 4″ from a Xenon “D” bulb. Top coats were cured in three seconds without filter or nitrogen.

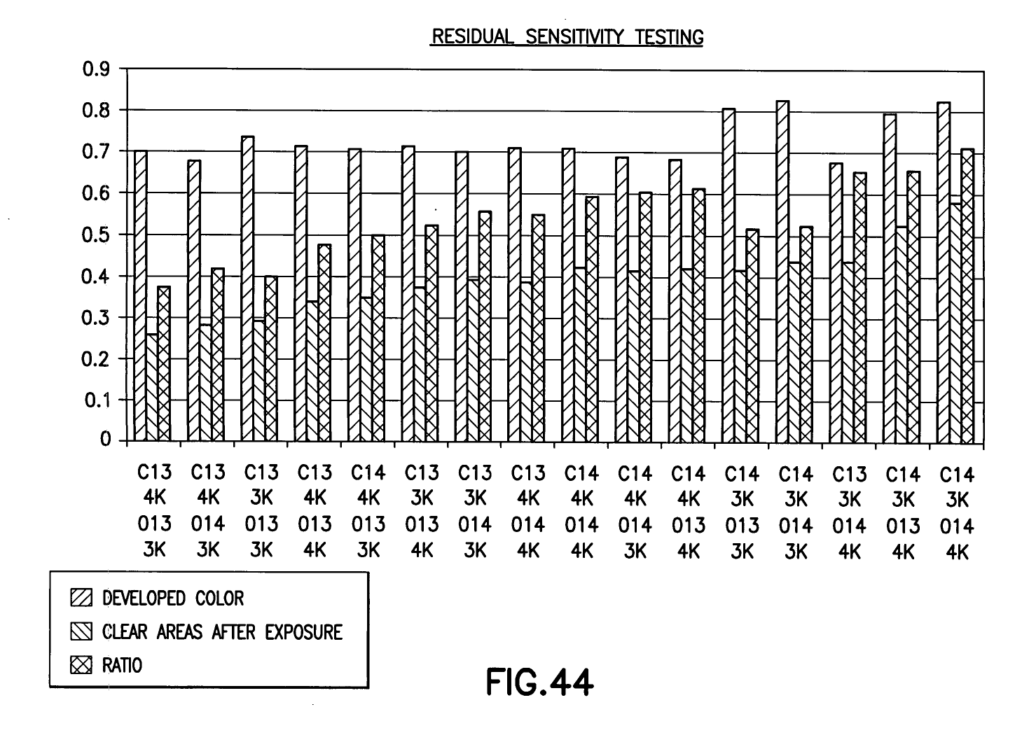

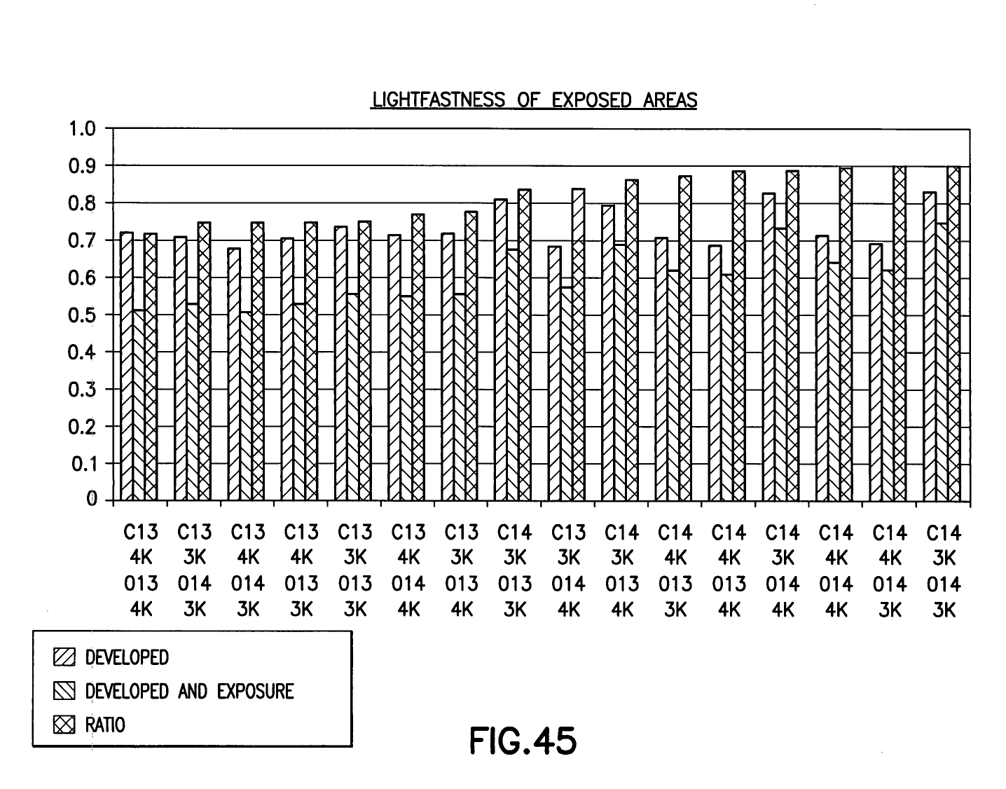

Residual sensitivity of the coating 100 is shown in FIG. 44. The samples break up into two main groups depending on photoacid generator concentration. It was noted that in both cases, Overcoat (O13) appeared to provide better UV protection than Overcoat (O14). The formulation C13 appeared to have the least residual sensitivity and appeared to provide the best optical density ratio for unexposed areas to exposed areas. Further, it was noted that the results for this ratio may, however, include some bias. This bias may result from not exposing the C14 formulation for an adequately long time so as to more fully develop the ultimate color, and thereby effectively reducing the developed color of the C14 formulations. Also, as might be expected, the coatings 101 with the highest amounts of photoacid generators and color formers retained a larger amount of their color upon prolonged light exposure. This effect is shown in FIG. 45.

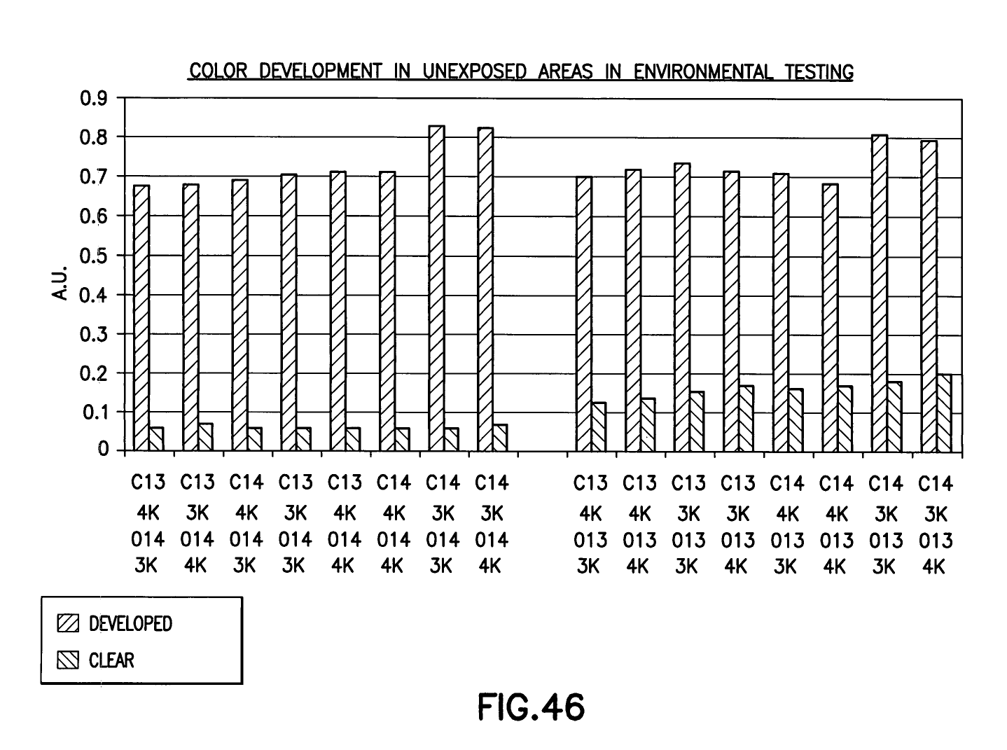

Environmental testing at 70° C. and 90% relative humidity showed that acid migration from the topcoat to the bottom coat is possible. Results are provided in FIG. 46. A clear split in the level of background color is seen in the formulations which do not contain acid (Overcoat O14) and the acid containing coating (Overcoat O13). Therefore, the utility of the acid in the amine/ink test will have to be confirmed before SB-520 or equivalents are included in the formulation. If necessary, a trade-off/optimization study may be performed to minimize color development form this topcoat 102 while still imparted ink resistance.

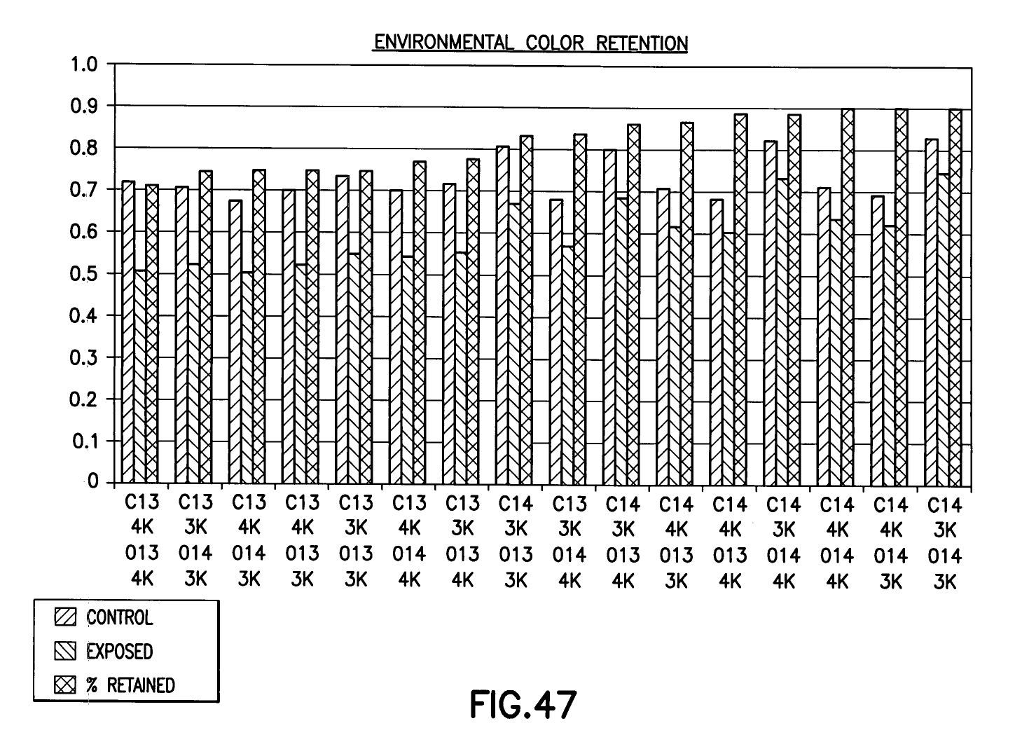

Finally, the level of color retained after environmental exposure was substantially governed by the photoacid generator and color former concentrations, and not the thickness of the film 101 or compositions used in the overcoat 102. Results are provided in FIG. 47. Results show that optimization of the photoacid generator and color former ratios and concentrations in order to achieve the desired color density and writing cycle time will affect much of the lightfastness and environmental stability.

5. Amine Testing

Amine testing was repeated using the new formulation. At first, the applications of new formulations for the color forming layer 101 appeared to hold up to the amine test without an overcoat 102 and without any degradation. However, a DVD 10 marked with a first pattern of images showed some significant fading after prolonged storage in a first DVD storage case 180 with the insert materials included. The storage case 180 used was actually one purchased from a retailer, and considered representative of a commercially available DVD storage case 180. This provided a hint that perhaps the previously conducted triethyl amine (TEA) based test was inadequate for the revised formulations. Therefore, a new test was performed using a larger amount of TEA in a standard plastic DVD box 180 similar to the first DVD storage case 180. A large piece of filter paper 181 was used to replace the insert, and 1 ml of TEA was distributed around the filter paper 181. This test failed to induce any fading in the pattern of images in the coating 101. It was then thought that perhaps a more volatile and mobile base was needed, such as ammonia.

A first attempt at this test consisted of placing a 200 μl drop of concentrated ammonium hydroxide in the middle of the filter paper 181 and sealing the discs 10 in a storage case 180. This led to complete destruction of the images on all discs 10, with or without any overcoating. The amount of ammonium hydroxide used proved to be excessive and practically was most likely well beyond what would be encountered in a package. Accordingly, a second test was performed using 25 μl of ammonium hydroxide. Within two hours the discs 10 without an overcoat 102 and the overcoat 102 without acid were both completely faded (the overcoat may have been slightly better), while the overcoat 102 containing acid did retain most of its original color, except for the areas closest to the ammonium hydroxide spot (which were around the stacking ring). Over the next several hours, these discs 10 also deteriorated significantly from the inner ring radially outward. Again, the amount of ammonium hydroxide used may have been excessive when compared to the environment of a typical optical media package 180, such as for a CD or a DVD.

The test was repeated with 10 μl of concentrated ammonium hydroxide. The disc 10 without the overcoat 102 deteriorated within an hour, as before. However, this time the disc 10 with the overcoat 102 formed from the O14 formulation retarded the fading by a few hours. The disc 10 with the overcoat 102 formed from the O13 formulation was essentially unchanged and only showed signs of fading near the middle of the disc 10 after a day.

Three more samples were placed in the original 200 μl packages after the packages had been sitting closed for a few days. After 24 hours, the unprotected disc 10 showed moderate fading, while the discs 10 having overcoat layers 102 were both still robust. In order to complete further testing, additional DVD storage cases 180 were obtained. Samples of each overcoated disc 10 were placed into the new packages to see if more gradual fading would be induced. Neither overcoat samples showed any signs of fading after three days.

6. Quantitative Study

Metalized substrate 16 were coated using the color coating formulation containing a photoacid generator to color former ration of 2.0% TPST:3.5% CF. The components for each of the formulations tested in the quantitative study are presented in Table 25. The formulations were applied to the substrate 16 by spin-coating at 4K rpm for 10 seconds. The disks 10 produced were cured under the L-37 UV filter, in a nitrogen environment, and using the XENON D-bulb for 2 seconds at a distance of about one inch. Each disk 10 was then exposed under the D-bulb for 10 seconds at a four inch distance to produce color. Finally, a topcoat 102 was manually applied to each disk 10 using various formulations on the HEADWAY. This topcoat 102 was cured under the D-bulb for 3 seconds at a distance of one inch.

TABLE 25
Formulations for the Quantitative Study of Amine Degradation

| | Formulation No. | | | | | | |
|---|---|---|---|---|---|---|---|
| Component | O14 | O13 | O15 | O16 | O17 | O18 | O19 |

Wetting Agent

| | | | | | | | |
|---|---|---|---|---|---|---|---|
| TEGO RAD 2200 N | 1 | 1 | 1 | 1 | 1 | 1 | 1 |

Photoinitiator

| | | | | | | | |
|---|---|---|---|---|---|---|---|
| KTO/46 | 8 | 8 | 8 | 8 | 8 | 8 | 8 |
| CN-384 | | | | | | | |

Diluents

| | | | | | | | |
|---|---|---|---|---|---|---|---|
| SR-339 | 26 | 26 | 26 | 26 | 23.5 | 21 | 16 |

Main Components

| | | | | | | | |
|---|---|---|---|---|---|---|---|
| SR-368D | 20 | 20 | 18 | 20 | 20 | 20 | 20 |
| CN-120M50 | 45 | 25 | 17 | 35 | 45 | 45 | 45 |
| SB520M35 | | 20 | 30 | 10 | | | |
| Acrylic Acid | | | | | 2.5 | 5 | 10 |
| TOTAL | 100 | 100 | 100 | 100 | 100 | 100 | 100 |

PIGMENTS

| | | | | | | | |
|---|---|---|---|---|---|---|---|
| UV-24 | 10 | 10 | 10 | 10 | 10 | 10 | 10 |

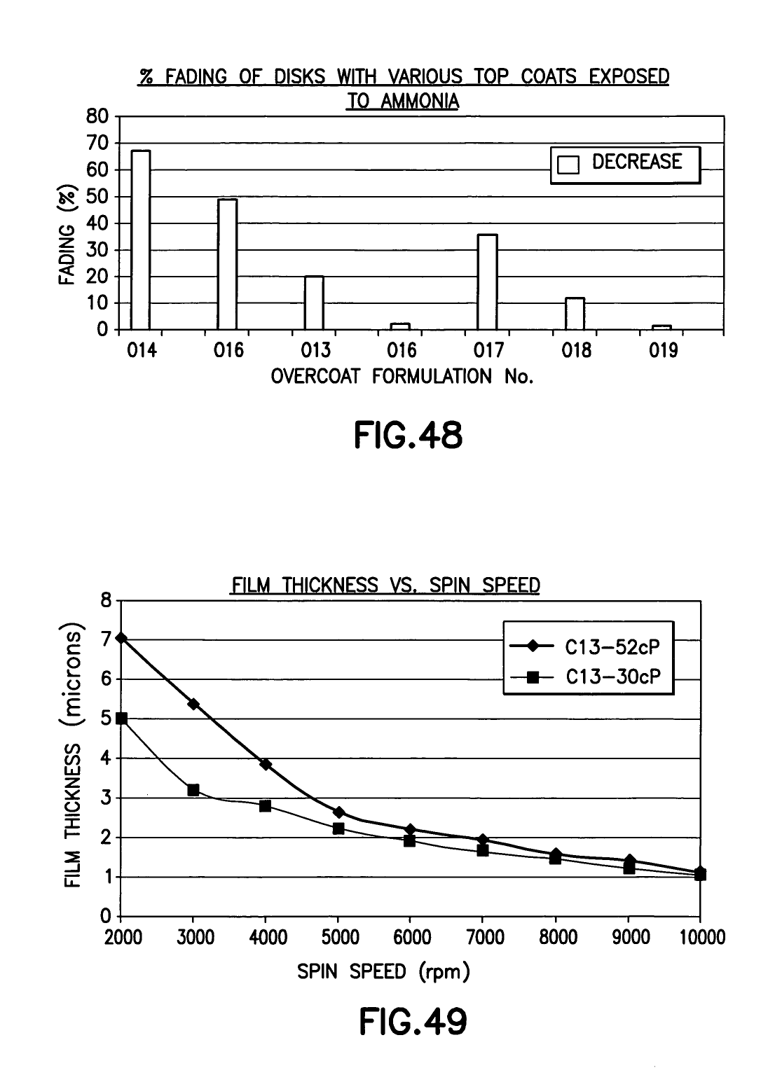

Optical density of each disk 10 was measured using an Ocean Optics Spectrometer. The absorbance at 540 nm was measured. The disks 10 were placed into individual DVD cases 180 and exposed to 10 μl of ammonium hydroxide. The ammonium hydroxide was placed in the center of a piece of filter paper 181 that had been fixed to the inside cover of each case 180. The cases 180 were closed and left to sit. Periodically, each disk 10 was removed from each case 180, and optical density measurements were performed to evaluate the loss of color. Resulting data is presented in FIG. 48.

7. Physical Properties of the Coatings

A modified version of the formulation for the color forming layer 101 was prepared by diluting the formulation with 30% by weight of a 5% KTO-46 in SR-238 diluent. Film thickness versus spin speed curves were generated for both formulations. Each formulation was then spun coat onto borosilicate glass discs from 2K-10K rpm in intervals of 1K rpm. The color forming layer 101 on the discs 10 was then cured for two seconds under L37 with the Xenon D bulb in a nitrogen atmosphere. Tape was then applied to the disc 10 to remove the coating and then tested on the WYKO to determine the thickness of the film 101 in two different areas on the disc. FIG. 49 shows the results of the average film thickness for each spin speed. This experiment shows that the original color coat, C6, has a greater film thickness when applied using spin speeds (S.S.) from about 2K-5K rpm. After that, however, the two samples proved to be very similar.

8. Viscosity vs. Temperature

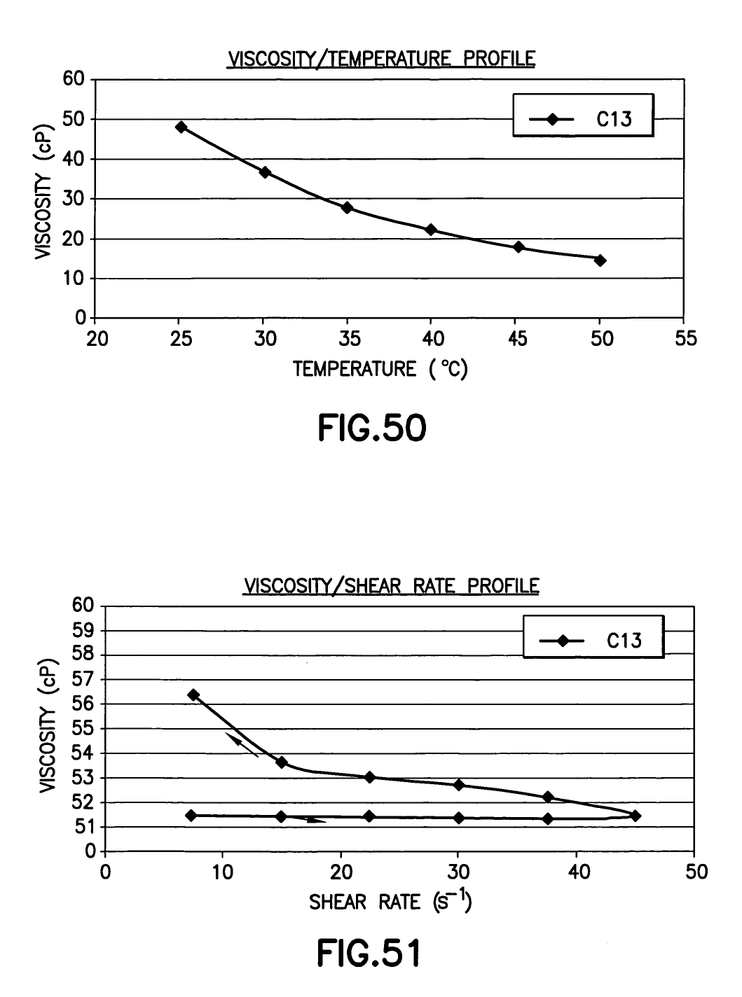

In typical replication machines, the lacquer for the color coating can be dispensed at different temperatures. Accordingly, the viscosity as a function of temperature was determined. Viscosity measurements were performed a temperature range of about 25° C. to about 50° C. in intervals of about 5° C. Measurements were performed with the Brookfield LVDV-III+CP rheometer and spindle CPE-40 at 4.75 rpm. The viscosity and temperature profile is shown in FIG. 50 for color coat C6. As expected, the viscosity of the lacquer decreases with increasing temperature.

9. Viscosity vs. Shear Rate

The spin-coating process imposes varying shear rates upon the lacquer. Since viscosity is a function of shear rate, obtaining this profile was also desired. Certain practical limitations prevented determining the exact values of the shear rates during spincoating. However, a range of viscosity and shear rate measurements were taken to assess properties of the lacquer. The measurements were performed over a range from a low rate to the maximum shear rate available using the Brookfield LVDV-III+CP and spindle CPE-40. The maximum shear rate achieved with this particular lacquer was 45/second. It is considered that if higher shear rates are desired, exchanges of some of the hardware components in the spin coating system may be performed. For example, using spindles CPE-51 and CPE-52 should provide for higher shear rates than the CPE-40 spindle. These spindles are compatible with this rheometer and are capable of producing higher shear rates.

Therefore, a program was designed to obtain low and high shear rates by varying the speed of the spindle. Speeds from 1K to 6K rpms, in intervals of 1K rpm, were used to increase the shear rate. Then, the speeds were taken from 6K rpm back down to 1K rpm. The rheogram in FIG. 51 shows the viscosity and shear rate relationship.

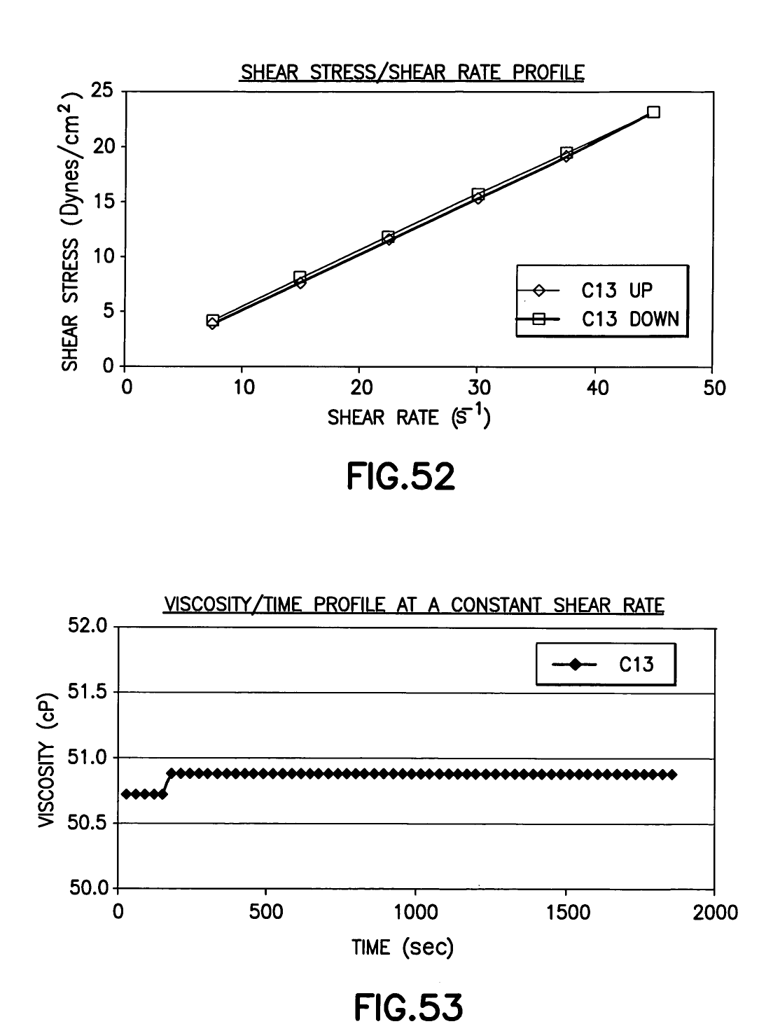

FIG. 51 shows that the bottom layer 101, (containing formulation c6), viscosity was nearly constant with increasing shear rates. However, with increased time of shearing, the viscosity increased. The increasing shear curve implied the formulation is a Newtonian fluid. However, the decreasing curve implied the fluid rheology is time dependent. Another type of graph that shows how the fluid behaves is a shear stress and shear rate profile is provided in FIG. 52. In FIG. 52, the linear relationship between shear stress and shear rate confirms that the fluid is Newtonian, in both shearing directions.

Another experiment was conducted to see if the color coat rheology was time dependent, which the decreasing viscosity and shear rate curve showed could be possible. To investigate this, viscosity measurements were taken while the shear rate and temperature were kept constant over a period of time. Again, the LVDV-III+CP and spindle CPE-40 were used. The spindle speed was set to 2K rpm. The time profile shown in FIG. 53 verifies that the viscosity will remain constant with time, concluding that formulation C6 exhibits Newtonian flow behavior.

10. Color Formation with Various Lamps.

Color formation experiments were done with the 9 samples shown in Table 26 with three different light sources. Each of the photoacid generator and color former combinations shown were included in the coating base for formulation C7 (containing 5% KTO, 35% SR-238, 30% SR-368D, and 30% CN-120B60). Three sets discs 10 containing the formulations were made and exposed separately using the XENON D Bulb, XENON C Bulb, and HONLE lamp. Exposure times ranged from 1 to 10 seconds in intervals of 1 second. A metallized substrate 16 was placed beneath each disc 10 to provide a reflective background. All samples were prepared by spincoating the formulations onto clear polycarbonate substrate 16, at speeds of 4K rpm on HEADWAY. The formulations were cured in a nitrogen environment, using a XENON D Bulb and the L37 UV filter for two seconds.

TABLE 26
Formulations for Color Formation
Experiments with Varying Lamps

| | 1 | 2 | 3 | 4 | 5 | 6 | 7 | 8 | 9 |
|---|---|---|---|---|---|---|---|---|---|
| TPST | 2 | 2 | 2 | 2.25 | 2.25 | 2.25 | 2.5 | 2.5 | 2.5 |
| PERG I-6B | 3 | 3.5 | 4 | 3.38 | 3.94 | 4.5 | 3.75 | 4.38 | 5 |

This study was designed to test several variables. The first was the effect of modifying the ratio of photoacid generator to color former. Typically, a 2:3 ratio had been used, but this was not known to be the preferred ratio. Second of all, preferred concentrations of photoacid generators and color formers were to be evaluated. This included assessing the effect varying concentrations had on color formation time. Further, the use of different bulbs on color formation time was to be evaluated. The XENON “D” and “C” bulbs put out different amounts of short UV. It was recognized that the effect of short UV on color formation was not characterized well. In addition, the HONLE “H” bulb was a continuous wave mercury vapor solution with a line spectrum quite different from a xenon lamp, and it was considered that testing this lamp could prove informative. The HONLE lamp being available from Hönle UV America, Inc., of Marlboro, Mass.

11. Photoacid Generator to Color Former Ratio

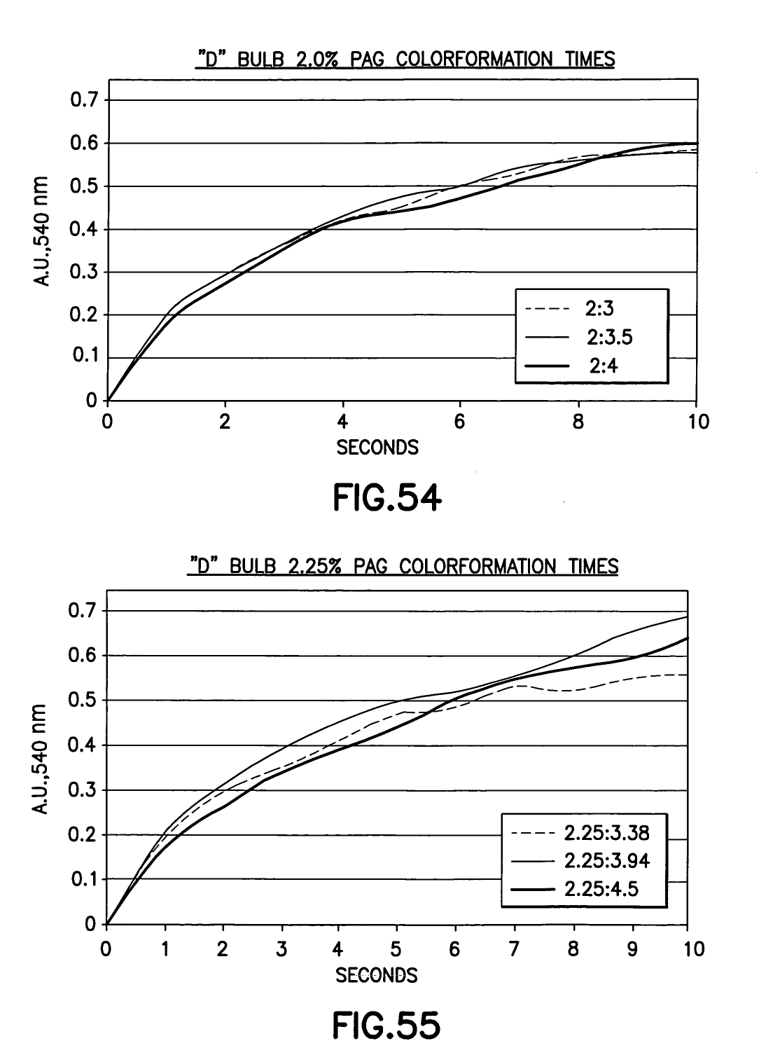

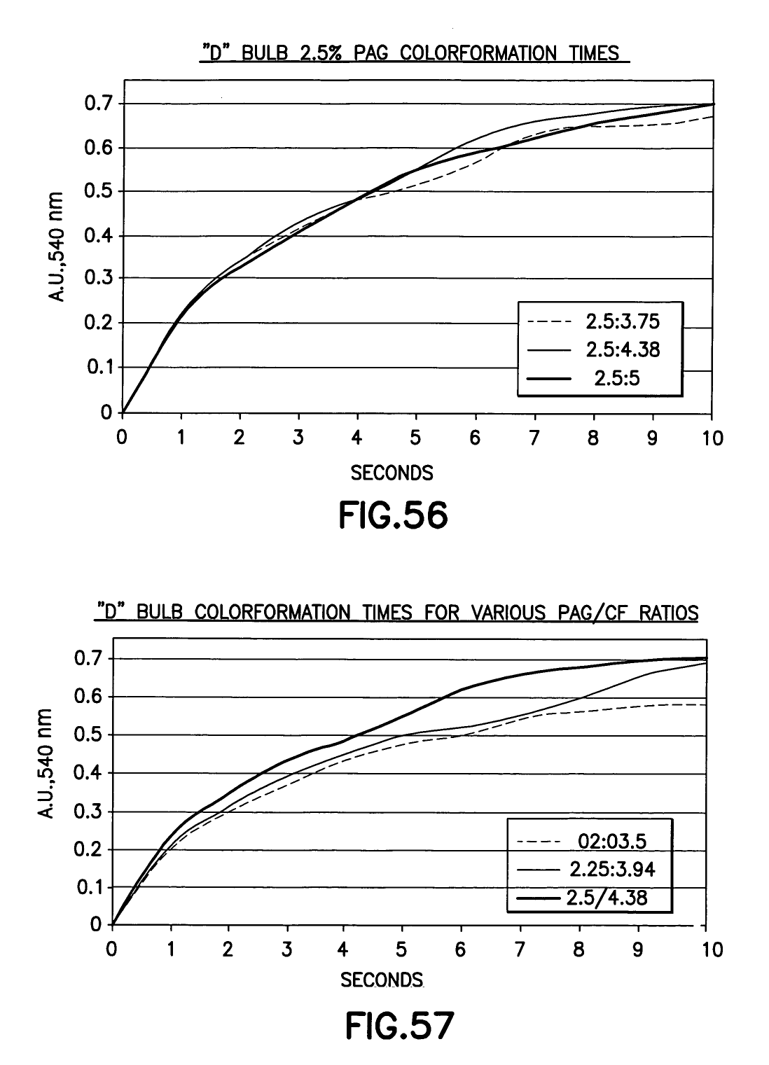

FIGS. 54-57 illustrate the effect of photoacid generator to color former ratio on color formations. Looking at each different photoacid generator concentration as a set, it appeared that a general trend is followed. This trend is shown in FIG. 54, and is considered to indicate that color formation in samples having a ratio (or equivalent thereof) of 2:3.5 performs better than ratios of 2:3, which perform better than ratios of 2:4.

It was considered that the apparent poorer color formation for the higher color former ratio could have been due to higher absorption of UV light, resulting from unactivated color formers in the formulation. While this trend appeared to hold for each concentration of photoacid generators, it was noted that a higher color former concentration may lead to better environmental or lightfastness. Also, it was noted that the difference in performance between these ratios was small, so any added benefit from a higher color former ratio would most likely be justified.

Assuming that the optimal ratio of photoacid generator to color former is close to 2:3.5, a direct comparison of the effect of photoacid generator concentration on color level can be made. The increase in color tracks roughly with the increase in photoacid generator to color former concentration.

12. Lamp Effects

The efficiency of writing for the three lamps was examined using both 2:3 and 2:4 photoacid generator to color former ratios. For simplicity, the lamps were compared at the 2.5% photoacid generator: 5% color former loadings, and the times were converted to fluence values using the combined UVA and UVB intensities measured on the GIGAHERTZ OPTIK power meter. The power levels are shown in Table 27.

TABLE 27
Lamp Power Levels

| | kW/m² | | |
|---|---|---|---|
| | C @ 4″ | D @ 4″ | H @ 5″ |
| UVA | 0.73 | 0.62 | 0.40 |
| UVB | 0.40 | 0.44 | 0.57 |
| UVA + B | 1.13 | 1.06 | 0.97 |

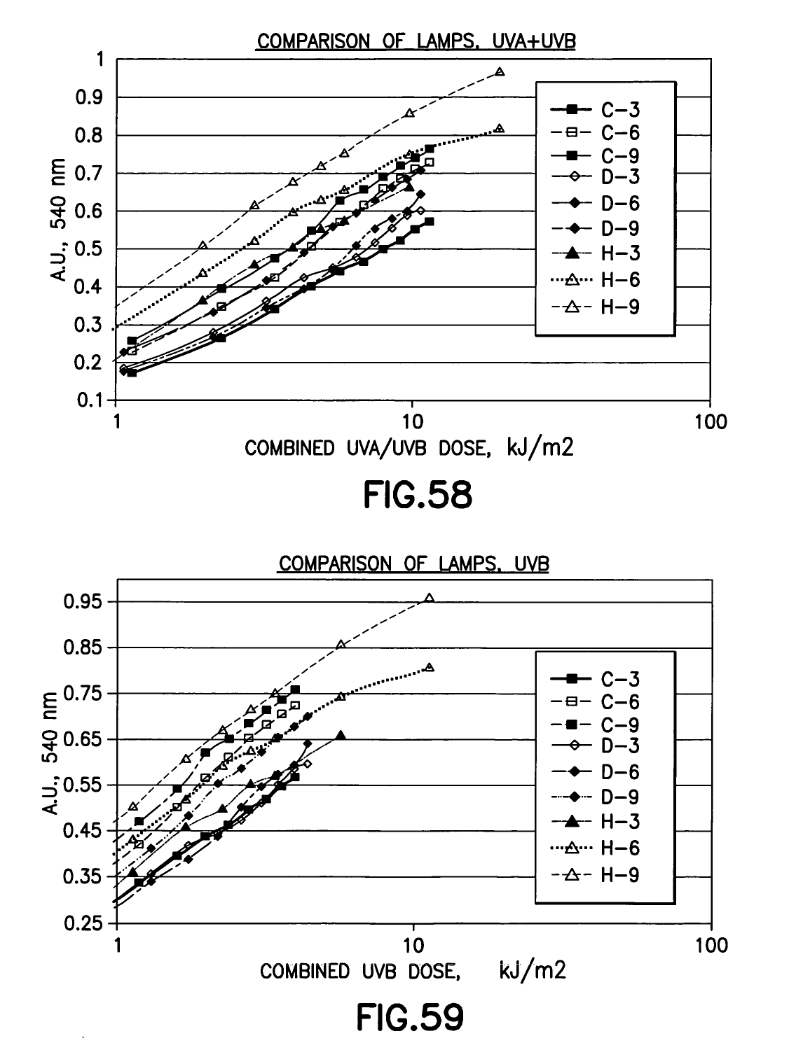

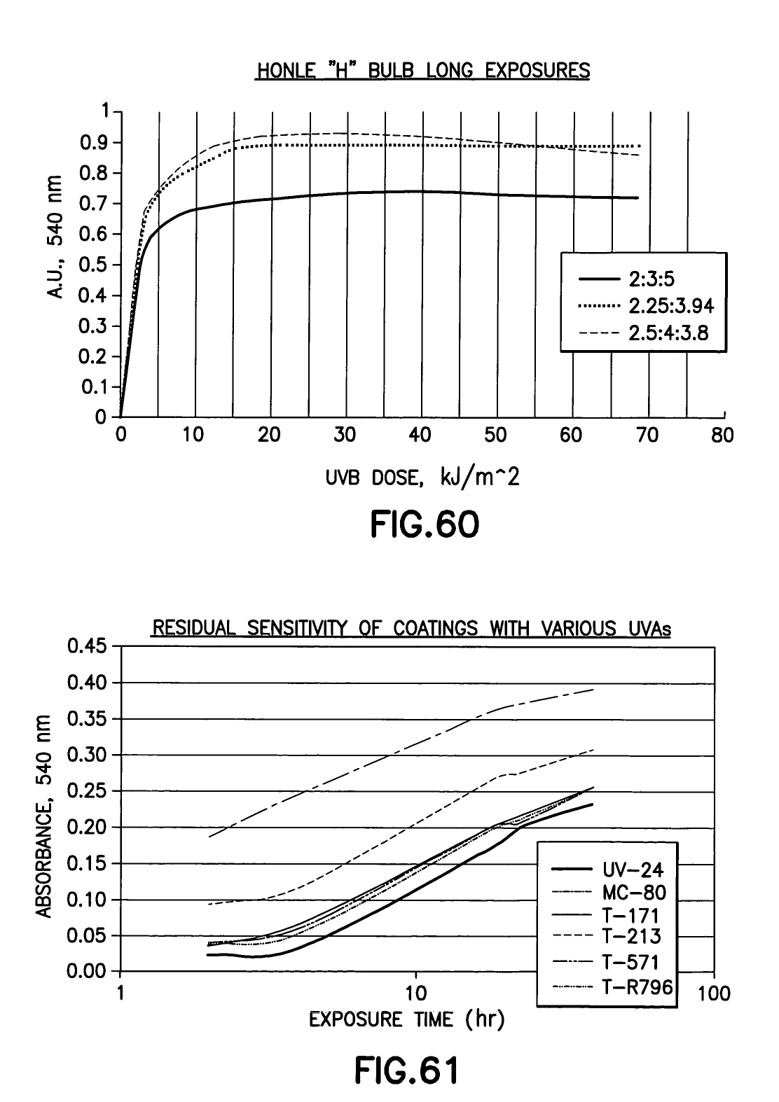

In general, the HONLE “H” bulb performed best on a fluence basis for the combined UVA/UVB levels, as shown in FIG. 58. However, it should be noted that the HONLE did put out more UVB than either XENON bulb. When only the UVB levels were used to plot the curves, as shown in FIG. 59, the HONLE lamp showed less of an advantage, but still appeared to be superior to the XENON bulbs. At any level, the HONLE and “C” bulbs are superior to the “D” bulb. Finally, the HONLE “H” bulb was used to perform long exposures to examine the maximum useful fluences for imaging the coatings. As seen in FIG. 60, a typical formulation begins to reach a maximum after about 5 kJ/m² of UVB exposure. In some embodiments, a full spectrum of UV is used to cure the overcoat 102.

13. Overcoating: Light Fastness of the Overcoat with Various UV Absorbers

Overcoat (O1) formulations were made with various UV absorbers at 10% concentration. The various absorbers used are shown in Table 28. TINUVIN-327 did not go into solution, and the formulation using TINUVIN-R796 crystallized after 24 hours. TINUVIN-R796 is 2-(2′hydroxy-5′methacryloxyethylphenyl)-2H-benzotriazole, and is a reactive UV absorber capable of crosslinking into the coating.

TABLE 28
UV Absorbers Used in Overcoating

| UV | Formulary | Physical | Edge |
|---|---|---|---|
| Absorber | Viscosity (cps) | Form | Cure |
| UV 24 | 145 | Powder | No |
| MC80 | 99 | Liquid | Yes |
| T-171 | 110 | Liquid | Yes |
| T-213 | 141 | Liquid | Yes |
| T-327 | did not dissolve | Powder | Yes |
| T-571 | 119 | Liquid | Yes |
| T-R796 | Crystallized | powder | Yes |

Clear polycarbonate disks 10 were coated with formulation C6 and cured for 2 seconds in a nitrogen environment and using a L-37 UV filter at a one inch distance from the XENON C Bulb. The disks 10 were then imaged for 10 seconds at a distance of four inches from the lamp. Each topcoat 102 was applied over three disks 10 containing images. The disks 10 were cured under the XENON for 3 seconds at a distance of 1 inch. Each of the discs 10 cured nicely and exhibited good surface quality. Each of the formulations edge cured with the exception of the UV-24 formulation. The formulation containing MC80 had a pink coloration after curing.

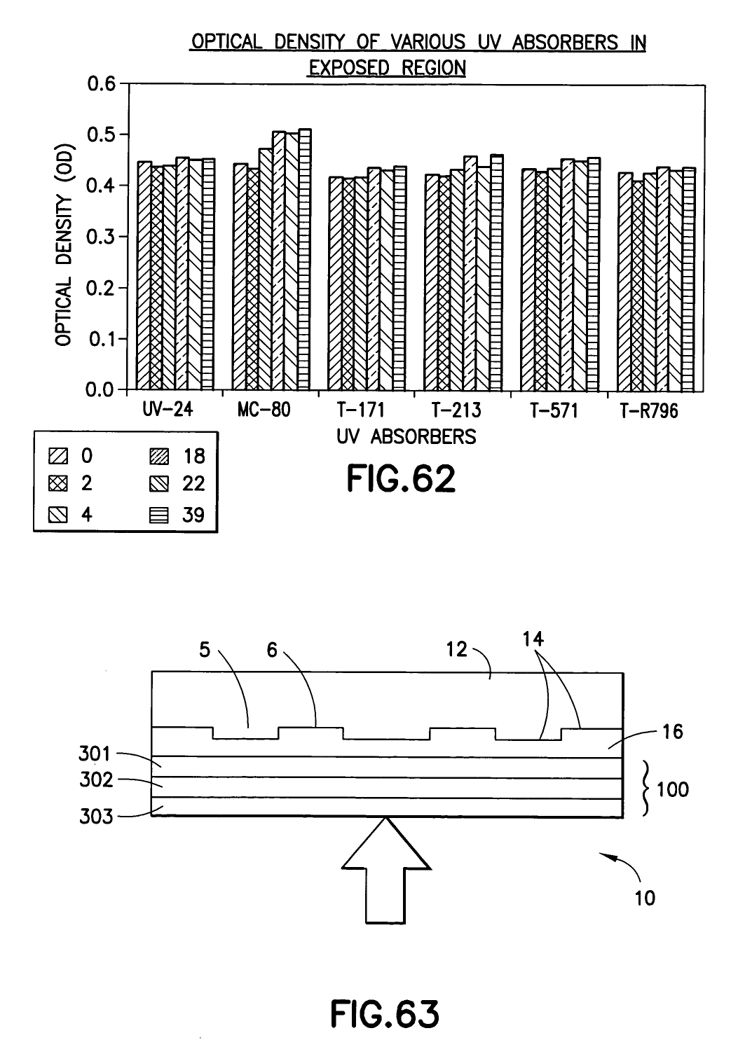

Viscosity was measured for each of the formulations and optical density was measured on both cured and exposed regions of the disk 10. The disks 10 were placed in a light chamber and periodically removed and measured for optical density at 540 nm. Results are depicted in FIG. 61. It was noted that the UVA composition had almost no effect on the lightfastness of the exposed areas of the disks 10, as shown in FIG. 62.

The result of the foregoing development work is that a variety of formulations, and techniques for development of further formulations has been developed. These formulations, and the techniques for development thereof, provide for color forming materials that can be cured with wavelengths of light, and stimulated with wavelengths of light to produce and retain images, patterns, and other desired markings. These formulations may be advantageously applied over data features appearing in optical media. Most advantageously, aspects of the images may be controlled so as to avoid interference with readout apparatus used to interpret data stored in the data features. It should be recognized that the foregoing is illustrative of the formulations, and not limiting of embodiments that may be practiced. For example, it is considered that the introduction of other constituents, such as acid functionality to act as base scavengers in the overcoat 102 may further aid in the stability of image retention.

Having discussed aspects such formulations, and the development thereof, further aspects of the application and use of these formulations will now be discussed.

C. Embodiments of Coatings on Optical Media 10

It should be apparent to one skilled in the art that formulations having efficacy for use as described herein are not limited to the foregoing embodiments. Accordingly, further discussion of the coating 100, and properties thereof, are not limited by the particular aspects of the foregoing embodiments.

1. Two Layer Coating

Referring to FIG. 2 and FIG. 40, a review of the two embodiments of a coating 100 thus far is provided. In FIG. 2, a single layer coating is shown, wherein color forming materials are included with other components to produce a coating 100. In this embodiment, the coating 100 provides color forming attributes, as well as environmental stabilizers (such as UV absorbers) to provide for coating 100 stability during normal use. FIG. 40 provides a second embodiment, wherein components are separated into two layers 101, 102. In FIG. 40, the coating 100 is formed of a color forming layer 101 and an overcoat 102. In this second embodiment, components of the color forming layers 101 are advantageously separated from components in the overcoat 102, thus providing for improved performance in regards to some of the properties of the coating 100.

2. Multiple Layer Coating

Further, non-limiting, embodiments are presented in FIGS. 63-65. In a further embodiment, shown in FIG. 63, multiple layers are employed. In one embodiment depicted by FIG. 63, the first layer 301 and the second layer 302 are color forming layers 101, where each color forming layer 101 produces a distinct color, such as red in the first 301, and green in the second 302. The third layer 303 is deployed as an overcoat 102, which is designed to protect against environmental factors. In another embodiment, the optical media 10 shown in FIG. 63 is formed so that the first layer 301, the second layer 302, and the third layer 303 are applications of formulations for single layer embodiments. In these other embodiments, each layer 301, 302, 303 produces a distinct color, such as one of red, green, and blue.

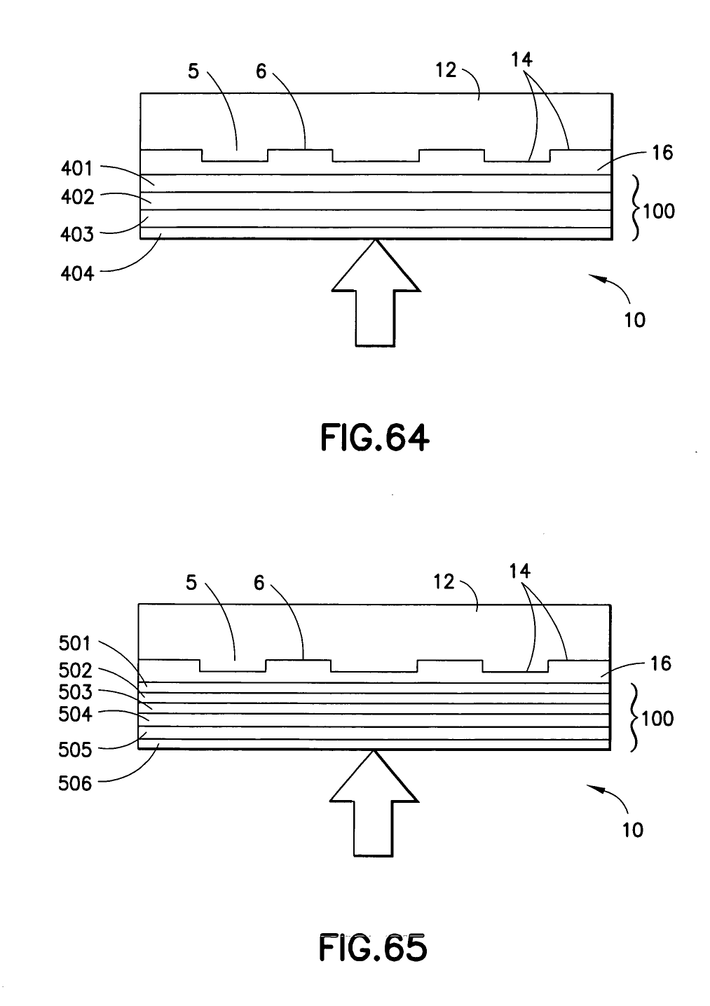

In FIG. 64, a coating 100 containing four layers is shown. In one embodiment, the first layer 401 is a color forming layer 101, while the second layer 402 is a protective overcoat 102. The third layer 403 is also a color forming layer 101, while the fourth layer 404 is another protective overcoat 102. Alternatively, each of the first layer 401, the second layer 402, and the third layer 403 are color forming layers 101, while the fourth layer 404 is a protective overcoat 102. In this alternate embodiment, the color formed in each of the first three layers may correspond to a primary color, such that upon completion of imaging, a multi-color image is apparent.

In FIG. 65, a further embodiment of a coating 100 is shown. In one instance, alternate layers 501, 503, 505 are color forming layers 101, while overcoat layers 102 are included as layers 502, 504, 506. In this embodiment, each of the alternate layers 501, 503, 505 correspond to a specific color, such as one of the primary colors. Imaging of each of the layers 501, 503, 505 provides for the collective appearance of a multi-color image.

3. Multi-Color Disc

To make a disc with multicolor images on it, multiple color forming layer 101 were applied. A study was performed to make a red and orange multicolor disc. The formulations used throughout the study are shown in Table 29.

TABLE 29
Color Forming Layers in a Multi-Color Disc

| Color | Red | Orange |
|---|---|---|
| Perg Red | 4 | |
| Perg Orange | | 3 |
| TPST | 2 | 3 |
| Base | 1b | 1b |
| KTO | 5 | 5 |
| SR-238 | 35 | 35 |
| SR-368D | 30 | 30 |
| CN-120B60 | 30 | 30 |

First, a metallized disc was spun coat at 4000 rpm for 10 seconds with the orange formulation. The orange formulation was then cured with the Xenon ‘C’ bulb for 3 seconds 1″ away under windown glass. A quartz mask was then placed over the disc 10 and exposed for 10 seconds 4″ away with the same Xenon ‘C’ bulb. The resultant disc 10 had an orange image on it with a clear background. Next, the disc 10 was taken and spun coat again with the red formulation at 4000 rpm for 10 seconds on the Headway. The red formulation was the cured for 3 seconds with the Xenon ‘C’ bulb 1″ away under window glass. Finally, a mask 925 was placed over the disc 10 and exposed for 10 seconds 4″ away with the Xenon ‘C’ bulb. The final product was a disc 10 with red and orange colored images on it with a clear background.

Spectra of the orange and red formulations were taken. These samples were spun coat on clear polycarbonate disc at 4000 rpm and cured and exposed as described above. Also, spectra of the different combination of layered colors were taken, whether the disc 10 was layered with a first coat of orange or red, and then with the other color on top.

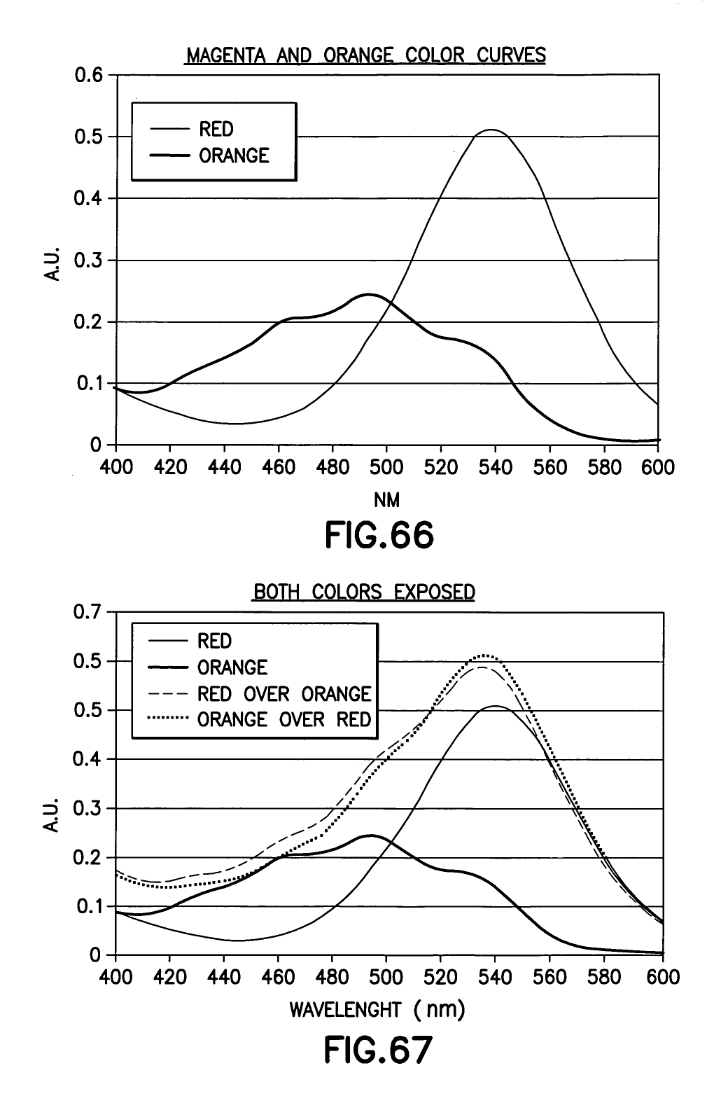

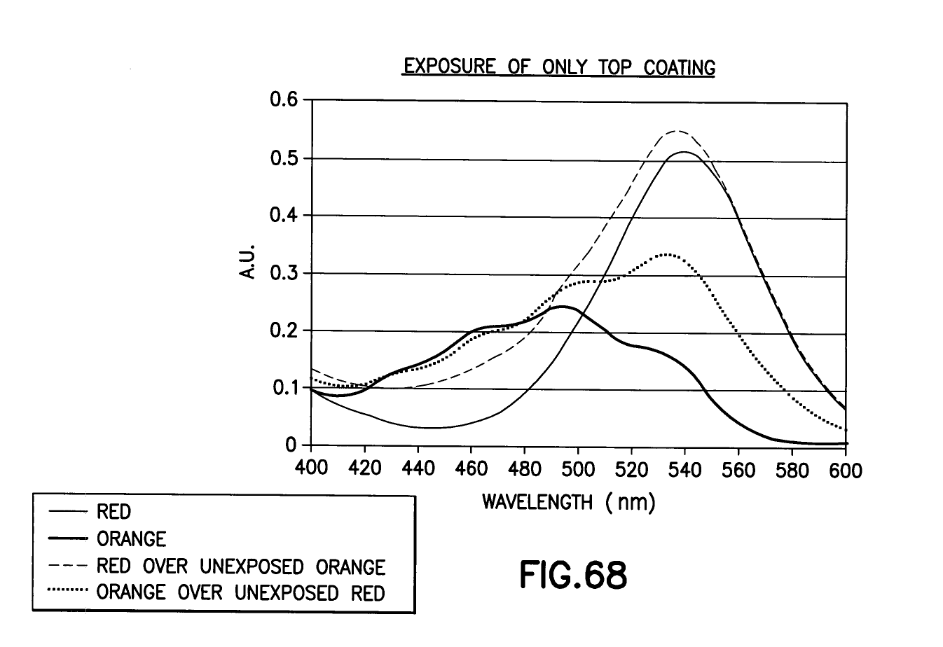

FIG. 66 depicts the spectra of a red disc 10 and an orange disc 10, where each color has been evaluated separately. FIG. 67 shows that when the red layer and the orange layer are exposed together, the spectrum of the color obtained is essentially the same. This is without regard for the order with which the coatings are placed. Further, FIG. 68 shows that the top layer 101 in a series of layer 101 can be selectively exposed without fully developing the underlying layer. One may note the majority of the color developed in the top layer 101, while the underlying layer 101 remains relatively unexposed.

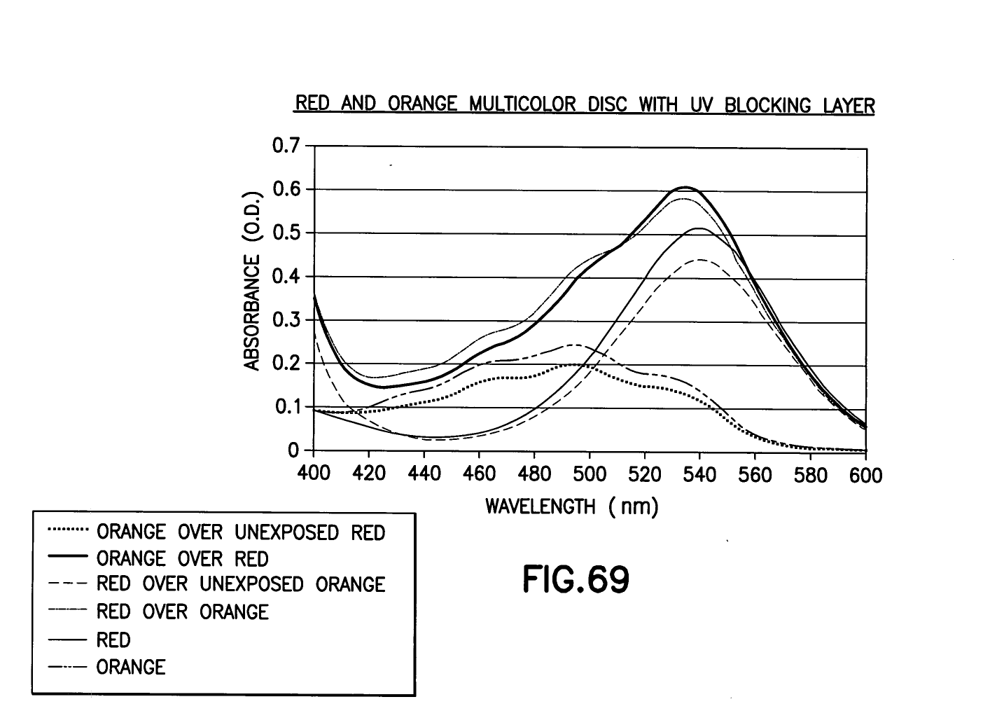

If desired, the selective development of the upper color layer 101 can be enhanced by adding a UV blocking layer 102 between the color forming layers 101. Table 30 provides a formulation for a UV blocking layer. This formulation was spun coat between the orange and red color forming layers 101. In this example, the UV blocking layer 102 allowed even better reproduction of only the single topmost color. Again, exposure of both color forming layers 101 led to the same total color regardless of the order in which the layers 101 were applied. Results are depicted in FIG. 69.

TABLE 30
UV Blocking Layer Used in Multi-Color Disc Study

| Wetting Agent | |
|---|---|
| TEGO RAD 2200 N | 1 |
| Photoinitiator | |
| KTO/46 | 8 |
| Diluents | |
| SR-339 | 26 |
| Main Components | |
| SR-368D | 20 |
| CN-120M50 | 45 |
| TOTAL | 100 |
| PIGMENTS | |
| UV-24 | 10 |

As should be apparent, the foregoing embodiments make use of coatings that include color forming layers 101, overcoat layers 102, single layers 100, and a variety of combinations thereof. As one can surmise, many combinations may be developed. These can provide for a variety of effects, such as single or multi-color images.

Further, one can also surmise that staged application an imaging of layers in a coating 100 may provide certain advantages. For example, a first layer 401 may be applied and then have an image recorded therein. Subsequently, a protective overcoat layer 102 is applied as a second layer 402, and a third layer 403 is applied as a second color forming layer 101. The second layer 402 is used to limit exposure of the first layer 401 during the imaging of the second color forming layer 403, by use of materials that absorb imaging wavelengths. In this manner, one image is recorded in the first layer 401, with a second image recorded in the third layer 403. Recording of the second image proceeds without interference with aspects of the first image. Similar techniques may also be used with single layer formulations where color forming materials are mixed with UV (or other wavelength) absorbers. Multiple wavelengths for curing and imaging may be used. In summary, a variety of application techniques, formulations, curing and imaging techniques may be used to achieve multiple effects in the collective appearance of an image.

II. FORMING A MARKING

A. Equipment for Forming a Marking

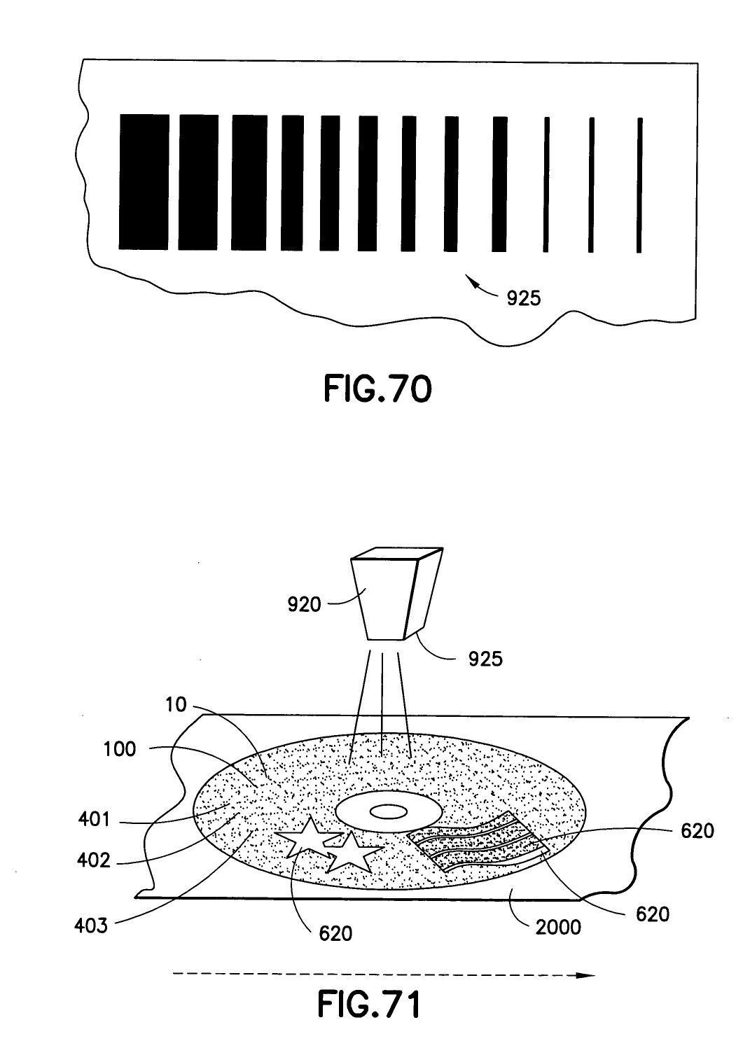

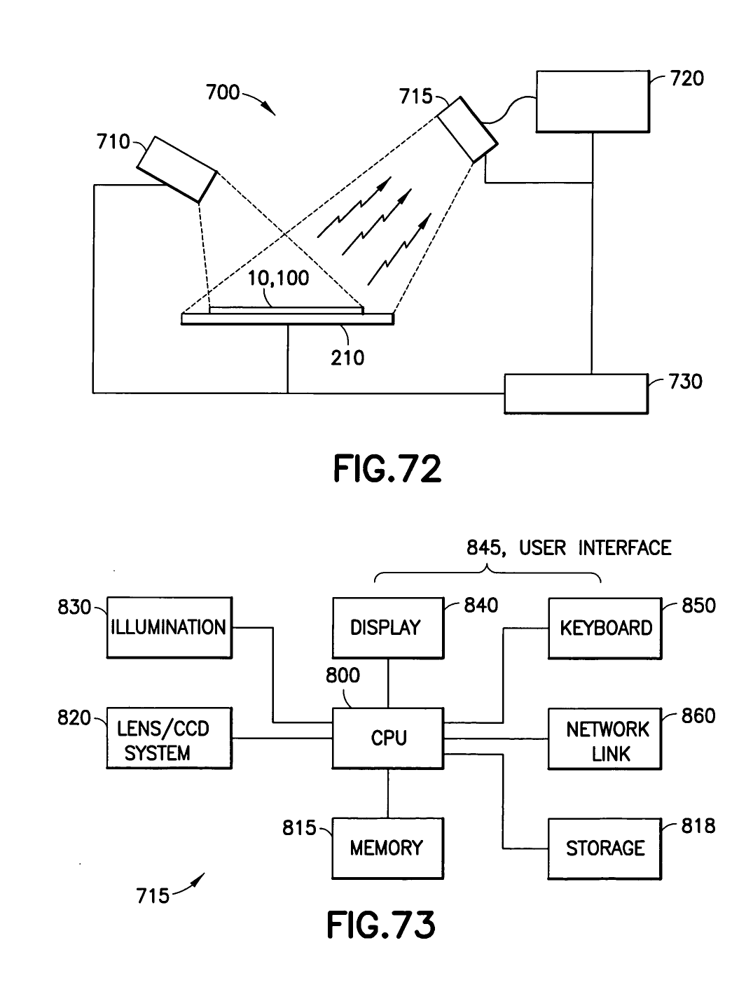

The selective irradiation of color forming materials in the coating 100 with a second light is used to record images or markings into the optical media 10. In the preferred embodiment, wavelengths of UV are used to provide for the second light. The selective irradiation may be used to provide for varying degrees of contrast with the unexposed, or lesser exposed, regions of the optical media 10. That is, varying shades within an image may be created. For example, increased UV exposure in one part of the coating 100 will cause greater absorption than exhibited in another part of the coating 100. Shading effects, or any other marking technique, may therefore be achieved using image creating units such as a positive, negative, or electronic photomask, a direct writing laser (a laser galvo system) or through other techniques. FIG. 70 depicts a magnified view of a portion of one example of a photomask 925 suited for developing a shading effect. A marking be realized as a single marking (e.g. a marking in a single color forming layer 101), of through the collective appearance of a series of markings (e.g., a series of markings in various color forming layers 101). One embodiment of an electronic photomask 925 makes use of a programmable liquid crystal display, which preferably exhibits a high optical density at wavelengths of about 355 nm. In some embodiments, the electronic photomask 925 is reconfigured between marking routines, thereby providing for unique markings upon each of the optical media 10 in a series.

One convention used herein is that regarding the terms “image” and “marking.” Where these terms are used together, image may be taken to mean a production of the marking, where the marking is the manifestation (i.e., record) of the image within the coating 100. It should be recognized that the two terms are closely related, and may be considered interchangeable as appropriate.

B. Types of Markings

A marking is formed using a convention that may include, but is not limited to, incorporation of text information, such as alphanumeric characters, symbols, graphic information, such as a logo, a barcode, or any other information or symbols that may be suitable for including in the marking. The marking may further include embedded information and authentication signatures, and can include at least one digital watermark or other type of covert marking. The marking may appear at wavelengths above or below the band of visible wavelengths. For example, the marking may be invisible to an unaided human observer.

In some embodiments, the marking is self-destructing. For example, the marking disappears when introduced to ambient environmental conditions, such as ambient lighting. Use of a self-destructing marking may be particularly useful for some applications, such as in some embodiments of authentication schemes.

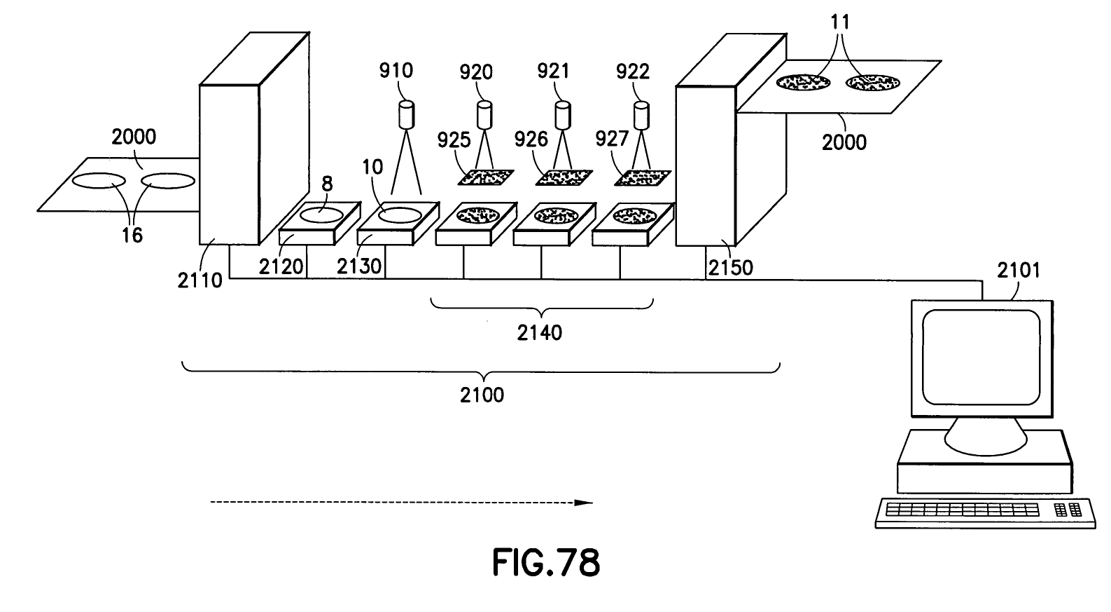

One example of a marked optical media is depicted in FIG. 71. FIG. 71 depicts an optical media 10 where a series of layers collectively form a coating 100 thereon. In the embodiment shown, the optical media 10 is being produced in a production line 2000, wherein a direction of production is depicted by the dashed arrow. A source of imaging wavelengths 920 is depicted, as a lamp having a photomask 925 attached thereon, and is used to generate markings in the coating 100. In the embodiment shown, markings 620 are produced in the first color forming layer 401 of the coating 100. Additional lamps 921, 922 (shown at least in FIG. 78) may be used to produce markings 620 in the additional color forming layers 402, 403. In some embodiments, the source of imaging wavelengths 920 is a laser. In this embodiment, the lamp 920 is controlled by external apparatus, not shown here, for direct writing upon the optical media 10. In other embodiments, the source of imaging wavelengths 920 may include a direct writing laser, a pulsed UV lamp, other light sources, and any combination thereof.

The marking 620 may convey any desired information. For example, the marking 620 may present content that includes identification information (such as a serial number), authentication information, and/or instructional information. The content may also include advertising, branding, or promotional information, referred to collectively herein as “promotional information.” The information included in the marking 620 may include, but is not limited to, any of the foregoing types of information, or combinations. For convenience, the term “content” as used herein refers to content of the marking 620, and can be an image, alphanumeric text and other symbols, graphics, and combinations of images and symbols. The marking 620 may contain at least one digital watermark.

An example of a technique for varying the contrast in a transferred image includes engaging techniques used in grayscale printing. That is, using a collection of properly sized colored shapes or patterns, on uncolored background, or alternatively, uncolored shapes or patterns on fully colored background. Regulating the size and density of the shapes or patterns provides for control over the visual perception of color intensity in any specific region of the marking.

FIG. 70 provides an example of the technique where contrast may be established by use of a photomask. FIG. 70 depicts a blown up cutaway section of a corner of a photomask 925, wherein the perception of shading is established by controlling the size and orientation of the rectangles in the photomask 925. In another embodiment, shading may be achieved through controlling the duration, power level, or other factors, governing exposure with a UV laser 920 used for direct writing onto the optical media 10.

In one embodiment, a photomask 925 is used for exposure of the optical media 10. The photomask 925 is either placed directly in contact with the optical media 10, or used at some fixed distance from the optical media 10, such as on a lens over the lamp. The second light source 920 is accordingly focused to provide for desired effects in the marking 620. The replication equipment appropriately moves coated optical media 10 into alignment within the photomask 925 station, or marking station, to provide for high throughput. The cycle time for the generation of a marking in this manner is preferably about 3 seconds or less.

In other embodiments, an electronic photomask 925, such as a liquid crystal display (LCD) unit is used. In these embodiments, the electronic photomask 925 may be remotely programmed and controlled. Use of the electronic photomask 925 provides certain advantages, including but not limited to, ability to change images rapidly thus leading to increased throughput, and fewer moving parts thus providing for lower maintenance costs.

III. COATING INSPECTION

A. Exemplary Inspection Equipment

Once the coating 100 has been applied to the optical media 10, it may be inspected for conformity with desired specifications. In some embodiments, inspection is optional or omitted. In one embodiment, aspects of which are shown in FIG. 73, non-destructive inspection occurs at an optical inspection station 700. The optical inspection station 700 may include components, such as and not limited to, a laser 710, detection equipment 715, and a suitably configured processor 720. In this embodiment, laser light is directed to the coating 100 on the optical media 10. The detection equipment 715 detects reflected light, and provides a signal to the processor 720. The processor 720 makes a determination, or series of determinations, regarding characteristics of the coating. These characteristics may include, and are not limited to, thickness and uniformity. Other characteristics include, without limitation, transmission or contrast defects, coating defects including voids, dye comets, or dye spots, as well as radial deviation, dye density, or dye edge radius defects, or other deviation from applicable industry standards.

The determinations are used to provide acceptance or rejection of the coated optical media 10. The processor 720 provides a signal to a production line controller 730. Rejected optical media 10 are appropriately sidelined from the production line 2000 by the production line controller 730 for subsequent disposition, while accepted optical media 10 progress through production. In this embodiment, 100% of production optical media 10 are inspected. However, in other embodiments, certain segments of the production quantity may be inspected. For example, a statistically significant quantity, every other, or new batches of optical media 10 may be subjected to inspection. These optical media 10 may be sidelined from production for inspection routines, or inspection in the course of production.

A further inspection routine involves use of electronic imaging systems to evaluate marking quality. Again, each optical media 10, or some subset thereof, may be inspected. In these embodiments, equipment such as, but not limited to, a CCD array with appropriate illumination and a suitably configured microprocessor is used as detection equipment 715. An example of appropriate equipment includes VERICAM from Spectra Systems, Inc. of Providence, R.I.

In this embodiment, the detection equipment 715 may be situated over the optical media 10 in a fashion to obtain a clear view of the marking 620, with minimal reflection or other interference. In this embodiment, the detection equipment 715 includes a number of components that work together, as illustrated in FIG. 73. In FIG. 73, the exemplary marking detection equipment 715 includes a user interface 845 which incorporates components such as a display 840, a keyboard 850, and a network link 860 (which may use any one or more of available communication protocols and designs); also included are illumination 830, a lens/CCD system 820, memory 815, and storage 818. These various components are controlled by an integrated central processing unit 800 on board the detection equipment 715. The detection equipment 715 in this case may be portable or fixed. In one embodiment, the detection equipment 715 includes a microscope laser scanner.

In use, the illumination 830 is used to provide standard lighting conditions, wherein the CCD array 820 images the marking on the optical media 10. The qualities of certain features of the marking 620 are determined. For example, the color of the marking, the alignment of text with the inner or outer edges of the marking with the optical media 10, aspects of a digital watermark, or the placement of one marking 620 in relation to another marking(s) 620 are evaluated. The processor 800 compares observed qualities to known or desired qualities, and provides a basis for rejection or acceptance of the optical media 10. A signal indicating acceptance or rejection can be sent to a separate production line controller 730 through the network link 860. Again, rejected optical media 10 are appropriately sidelined for subsequent disposition, while accepted optical media 10 progress through production.

Another inspection system that is suited for monitoring quality of the optical media 10 and the markings 620 thereon is commercially available from Xiris Automation, of Burlington Ontario, Canada. The XIRIS PI-1500 includes a three CCD chip camera module, top mounted with integrated light source and alignment mount; a flat panel computer screen; a vision processor unit; 8 digital inputs, 8 digital outputs; and complimentary software.

As another alternative, a portion of the production population the optical media 10 may be inspected by destructive means. In these embodiments, operators may cut segments of the optical media 10, or otherwise damage the optical media 10 to ultimately ascertain system performance information.

Another system for analyzing the quality of the optical media 10 produced in accordance with the teachings herein is the CATS SA3 System, available from AudioDev USA of Woodland Hills, Calif. This system tests the readability and playability of optical media by measuring numerous signals and parameters. The levels of these parameters can then be analyzed to draw conclusions about the stability of the disc manufacturing process and possible playability issues.

B. Coating Parameters and Radial Noise Study

Another study was conducted to evaluate performance of the optical media produced in accordance with the teachings herein. Disks 10 were coated on a HEADWAY PWM32-PS-R790 Spinner System with the HDP98 Fluid Dispenser and MA24WEA dispensing arm. Formulation 3 (9021) was used (see Table 14). Varying spin speeds and various coating parameters were employed to examine the effect of spin coating parameters on electrical specification of the disks 10. Programs using more than one, or incrementing spin speeds were tested. Preferred coating parameters were determined to use a single spin at 4K rpm for 10 seconds. The spin coating program used for the HEADWAY system is presented in Table 31.

TABLE 31
Headway System Program for Final Testing

| | | SPEED | RAMP | F 6 | ARM | SPEED | TIME |
|---|---|---|---|---|---|---|---|
| STEP | PURPOSE | (RPM) | (RPM/SEC) | (24 V) | DIRECTION | (%) | (SEC) |
| 1 | Start Program | 90 | 1000 | N | POS | 40 | 3 |
| 2 | Dispense lacquer | 90 | 1000 | Y′ = ON | NONE | | 3.5 |
| 3 | Spin for thickness | 4000 | 2000 | N | HOME | 40 | 10 |
| 4 | Terminate | 0 | 2000 | N | HOME | | 0.5 |

Increasing dispense time to maintain a 2.0 ml dispense volume (viscosity dependant) required a decrease in spin speed (rpm) used in steps 1 and 2. Dispense volume on the HEADWAY Spin Coating systems is a function of dispense time and dispense pressure. Therefore, dispense time was set to 3.5 seconds with a constant pressure of 50 psi which resulted in a dispense volume of 1.9-2.0 ml. This amount of lacquer provided the desired coating 100.

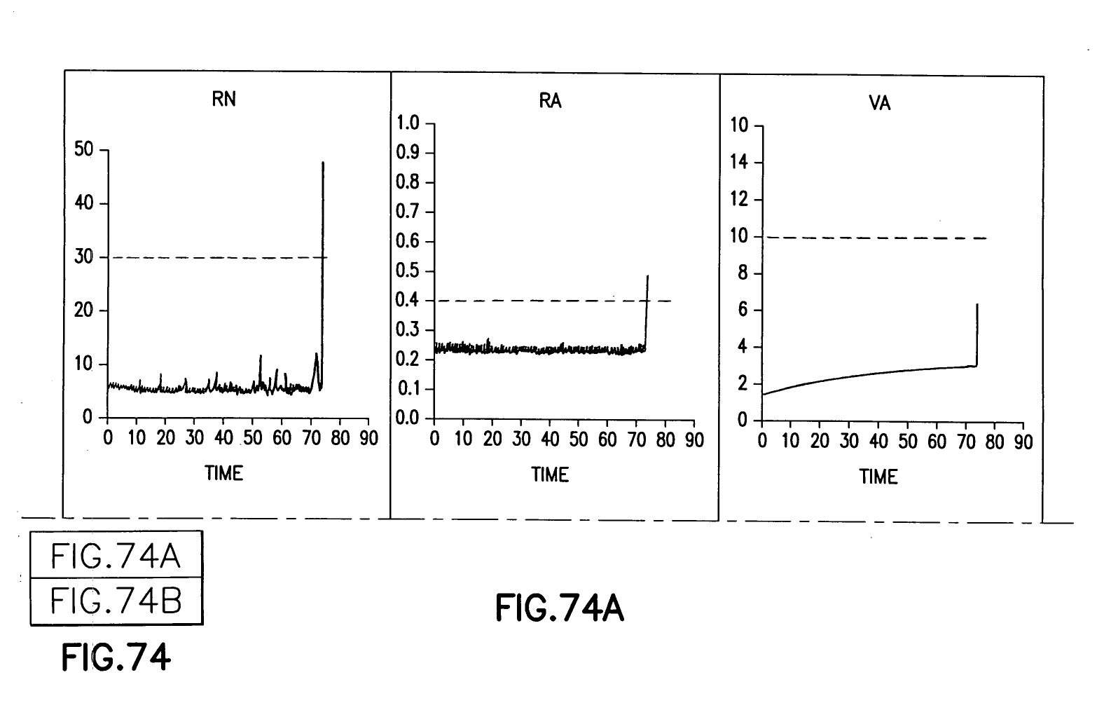

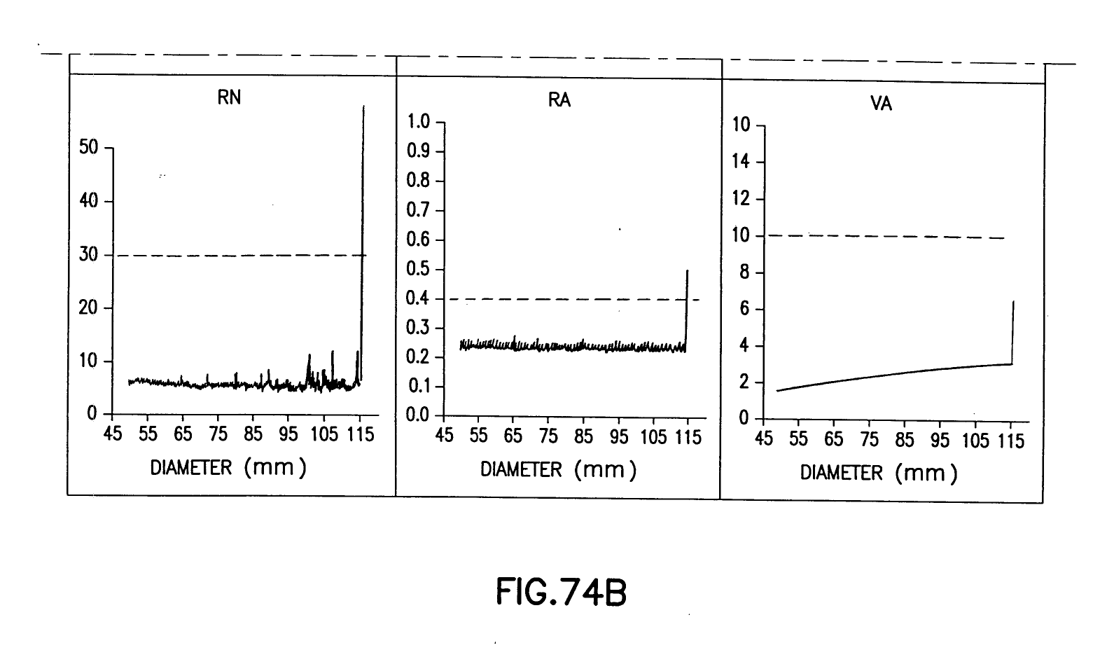

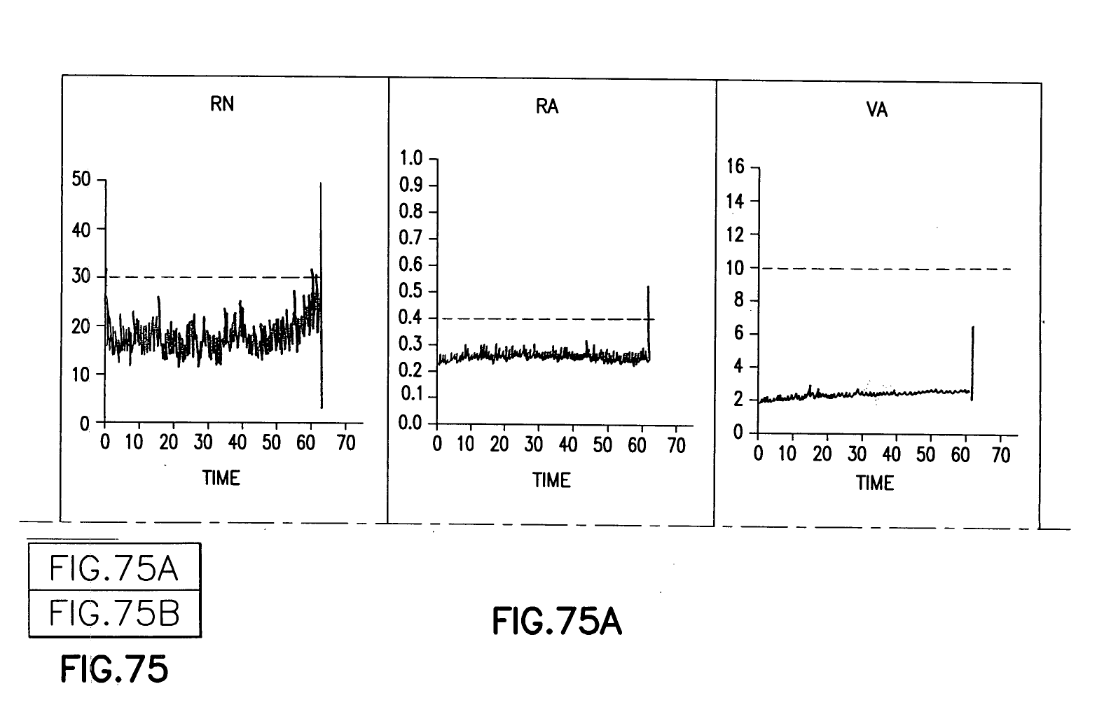

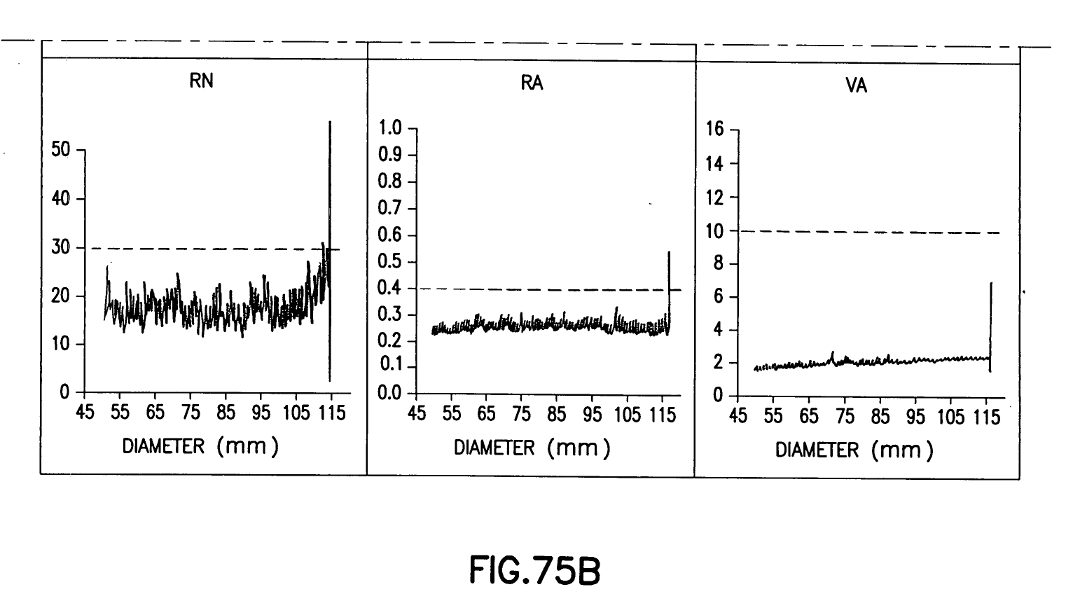

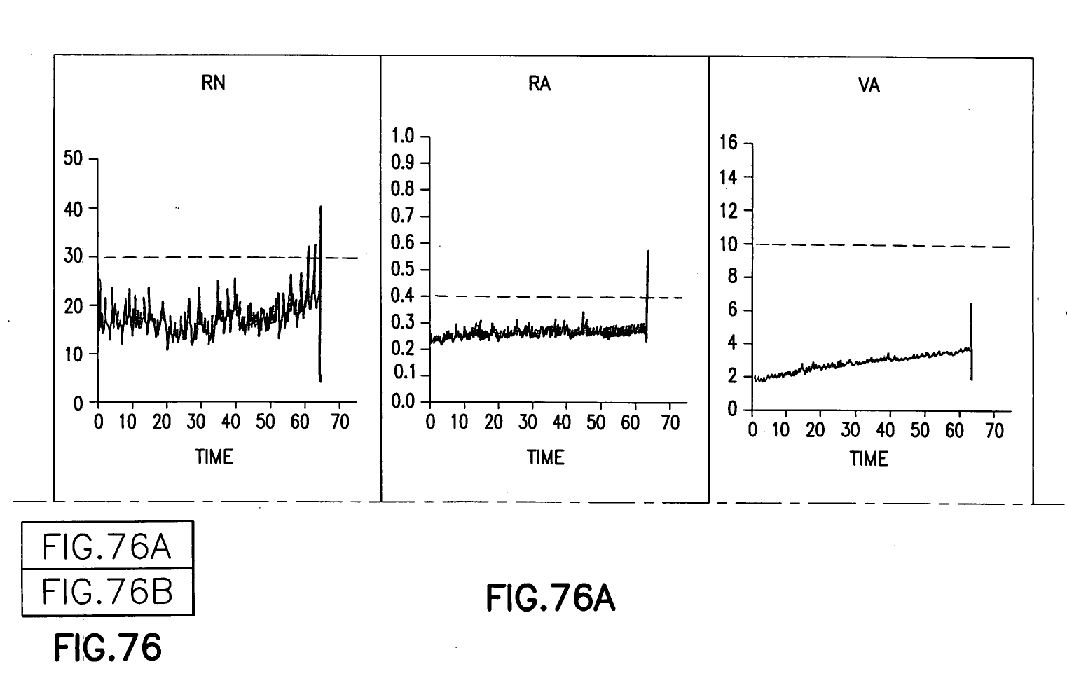

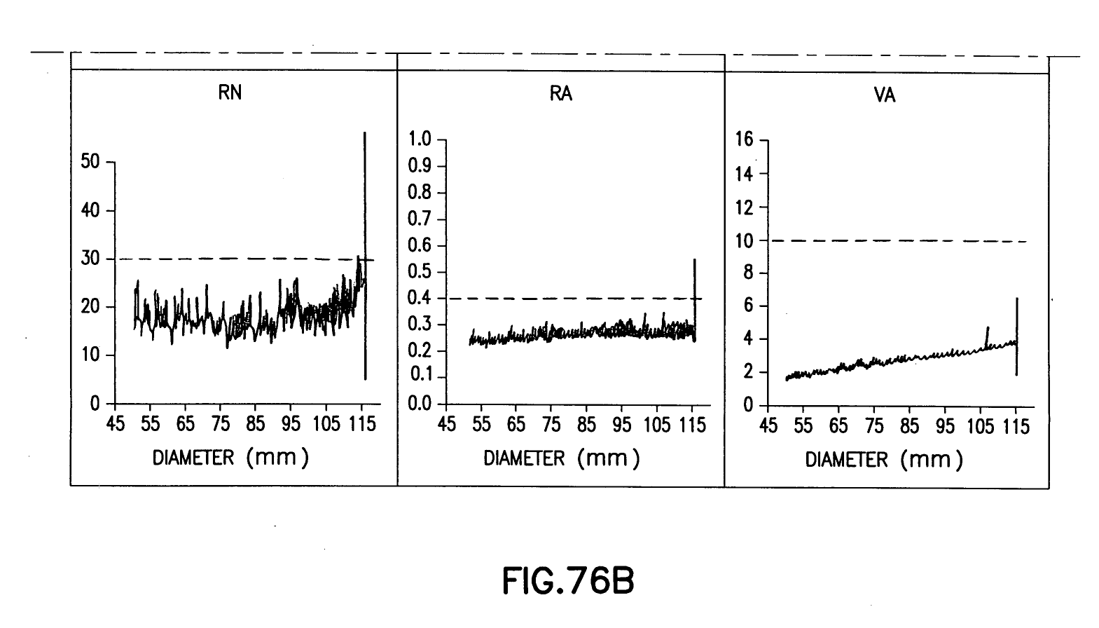

In order to examine the effect of the imaging process on performance parameters, a disk 10 was coated, cured and then tested on the CATS system. The same disk 10 was then imaged and tested on the CATS system a second time. There were no differences in the CATS test results. Data produced by the CATS system are included in FIG. 74, wherein data from an uncoated disk 10 is shown. Note the large spikes at the end of each test are due to data ending, which is not an inherent error in the disc 10 or the coating 100. FIG. 75 provides data for a coated disk 10 that had been cured, and had not been imaged. FIG. 76 provides data for a coated disk 10 that had been cured, and had been imaged.

A further study of radial noise was conducted as a part of the assessment of a system for manufacturing the optical media 10. This study is discussed in the section entitled “Systems for Manufacturing.”

C. Inspection Techniques

Techniques for inspection include completing inspections at various stages in the manufacture of the optical media 10. For example, a color forming layer 101 may be applied and cured over the reflecting layer 14 disposed upon a substrate 16, and then diverted to an inspection station 700. Upon successful inspection, in some embodiments, the substrate 16 is then be submitted for marking. In some other embodiments, the substrate 16 progresses to another station for application of the overcoat 102.

IV. SYSTEMS FOR MANUFACTURING

A. Exemplary Production Equipment

In a first embodiment, a production system, such as one similar to the SINGULUS SKYLINE system available from Singulus Technologies of Windsor Conn., is used to produce optical media 10. Appropriate modifications and enhancements have been incorporated into the system to provide for and enable the embodiment described herein. Aspects of the equipment are described herein, or considered generally within the skill of the art, and are accordingly not described in further depth.

In this exemplary embodiment, newly replicated discs 10 on a spindle come off of the replication line. The coatings 100 are applied using a spin-coating process, and then cured by exposure to a first light having wavelengths in the ultraviolet (UV) region. After appropriate application and curing, at least one image 620 is transferred into the coating 100, by use of exposure to a second light 920. In one embodiment, the second light 920 employs wavelengths of UV, and a photomask 925. In other embodiments, the second light 920 is directed to the coating 100 as a controlled direct writing laser. An inspection step is preferably included, either before or after the exposure to the second light 920, to ensure the coating 100 meets optical or other standards for the type of optical media 10. Production times may vary with factors, such as and not limited to, coating 100 composition, spin coating time, curing time, imaging time, and inspection time.

Aspects of this preferred embodiment for the production of marked optical media 10 include, and are not limited to, the following exemplary parameters: 1. A spin coating station having: manual adjustability through use of a micrometer screw, and automatic adjustability of the radial position of coating material dispense nozzle(s); use of a formulation having a viscosity of about, for example, 35 cps; use of a filtering system discriminating against particles down to about 0.2 micrometers; recycling of the spin-off lacquer; a dispensing volume of up to about 30 ml; a dispensing speed of between about 30 to 100 RPM; acceleration of up to about 2,000 RPSS; a spin speed of up to about 5,000 RPM; and a multi stage spin-up. 2. A UV curing station imparting about 300 mW/cm2 at wavelengths of about 365 nm. 3. An optical inspection station having an ability to detect surface defects in the form of height variations of about 100 nm and lateral variations of about 200 microns. 4. A photomask station imparting about 2 W/cm2 at wavelengths of about 350 nm (where about 5 J/cm2 are delivered in about 2.5 seconds, with an additional 0.5 seconds required for handling). 5. A laser characterized as providing a total deposited fluence of about 4 J/cm2, operating at a wavelength of about 355 nm, having a pulse energy limit of less than about 0.15 J/cm2 per pulse, with an average power of about 4 watts. In this non-limiting embodiment, the cycle time for installation of a marking as described herein, from beginning to end, is about or less than 7.5 seconds, with each individual step taking no more than 3 seconds.

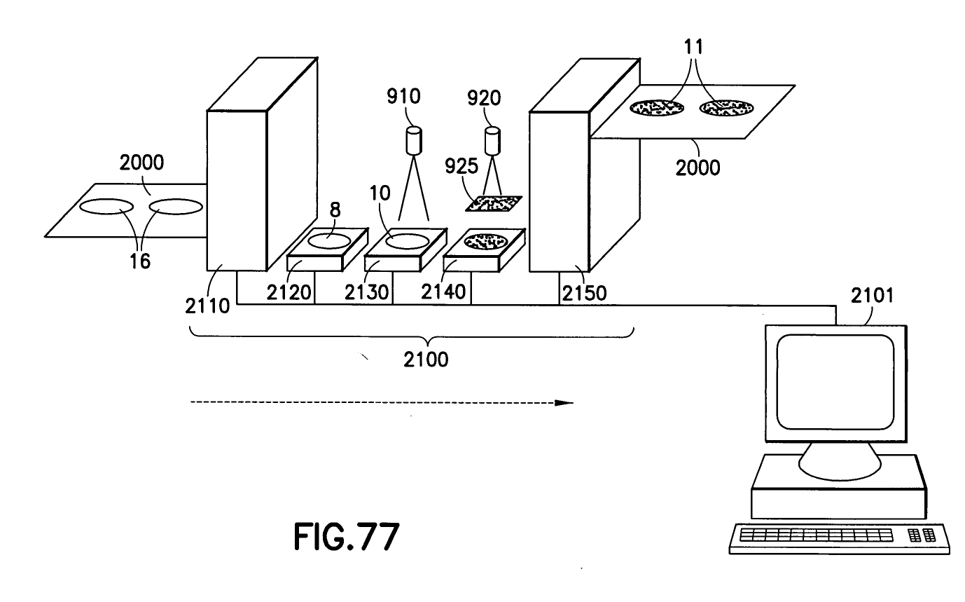

FIG. 77 provides an illustration of a commercial production environment, referred to as an “inline” system. In FIG. 77, aspects of an optical media replicator 2100, such as the SKYLINE system or an equivalent, is used to create coated optical media 10 that are characterized by at least one marking 620 in a single layer coating 100. In this embodiment, the optical media replicator 2100 accepts raw materials in a production line 2000 as appropriate (flowing in the direction of the dashed arrow) and produces finished optical media 11 having a marking as disclosed herein. In one embodiment, the system 2100 completes initial steps, such as applying a reflective layer 14 to a substrate 16, where prepared substrate 16 are produced using a preliminary station 2110. The preliminary station 2110 may be tasked with other production steps, such as the formation of the substrate 16. The preliminary station 2110 may scan substrate 16 for defects, and include further equipment as necessary to accomplish this task. Depiction of a preliminary station 2110 should therefore be understood as a representation that the system 2100 may incorporate additional equipment as necessary to produce a prior art optical media 8. The optical media 8 progress to a spin-coating station 2120 for application of a single layer of a formulation that will form the coating 100. The optical media 8 proceed to a curing station 2130, where exposure to a first light 910 cures the coating 100 as described elsewhere herein. Once the coating 100 on the optical media 8 is cured, the coated optical media 10 so produced proceed to a marking station 2140. At the marking station 2140, the optical media 10 are exposed to wavelengths of light from a second light 920. In the embodiment shown, the second light 920 makes use of a photomask 925 to produce a marking 620 in the coating 100 on the optical media 10. Final steps are completed in a finishing station 2150, as appropriate. Final steps may include, without limitation, use of inspection equipment 700 to accept or reject each of the marked optical media 11. Operation and other aspects of the production system 2100 may be governed by a system controller 2101, such as a processor 2101 executing an instruction set (software), or through other techniques, such as manual operation. One example of a system controller 2101 is an external personal computer 2101, connected to controls for the various components of the production system 2100. In other embodiments, aspects of the initial and final inspections are mingled with other production steps. For example, the optical media 10 may be inspected after each one of spin coating, curing and marking. A system such as the foregoing embodiment is preferably automated, or otherwise equipped to provide for rapid mass production.

FIG. 78 depicts aspects of one embodiment of a production system 2100 equipped for marking optical media 10 having a coating 100 with multiple color forming layers 401, 402, 403. In FIG. 78, the marking station 2140 includes a series light sources as the second light 920, which is also referred to as a “marking source”, “marking light”, or in other similar terms. In this embodiment, a first marking lamp 921 is used in conjunction with a first photomask 925, and imparts a marking 620 in a first color forming layer 401. A second marking lamp 921 is used in conjunction with a second photomask 926, and imparts a marking 620 in a second color forming layer 402. A third marking lamp 922 is used in conjunction with a third photomask 927, and imparts a marking 620 in a third color forming layer 403.

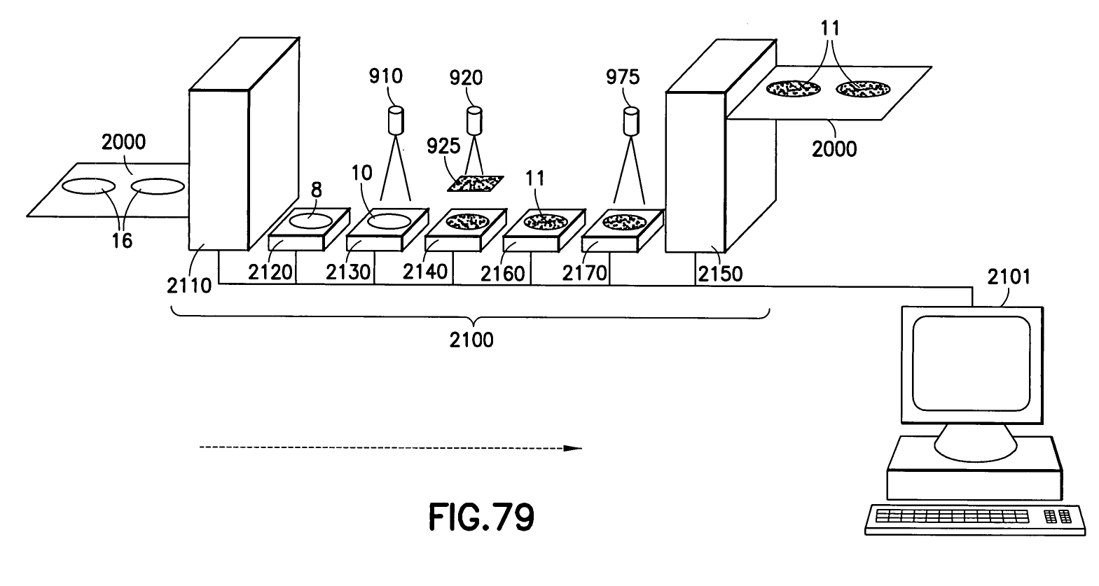

One further embodiment of a production system 2100 is depicted in FIG. 79. In FIG. 79, the production system 2100 is designed for the production of optical media 10 using a two layer coating 100. In this embodiment, the first spin-coating station 2120 applies a color forming layer 101. The color forming layer 101 is cured at the first curing station 2130. The cured color forming layer 101 is marked with a marking 620 at the imaging station, as described elsewhere herein. The marked optical media 11 then progresses to a second spin coating station 2160 for application of the overcoat layer 102. The overcoat layer 102 is cured at the second curing station 2170, using a second curing light 975. Final inspection, or other finalizing steps, are completed in the finishing station 2150.

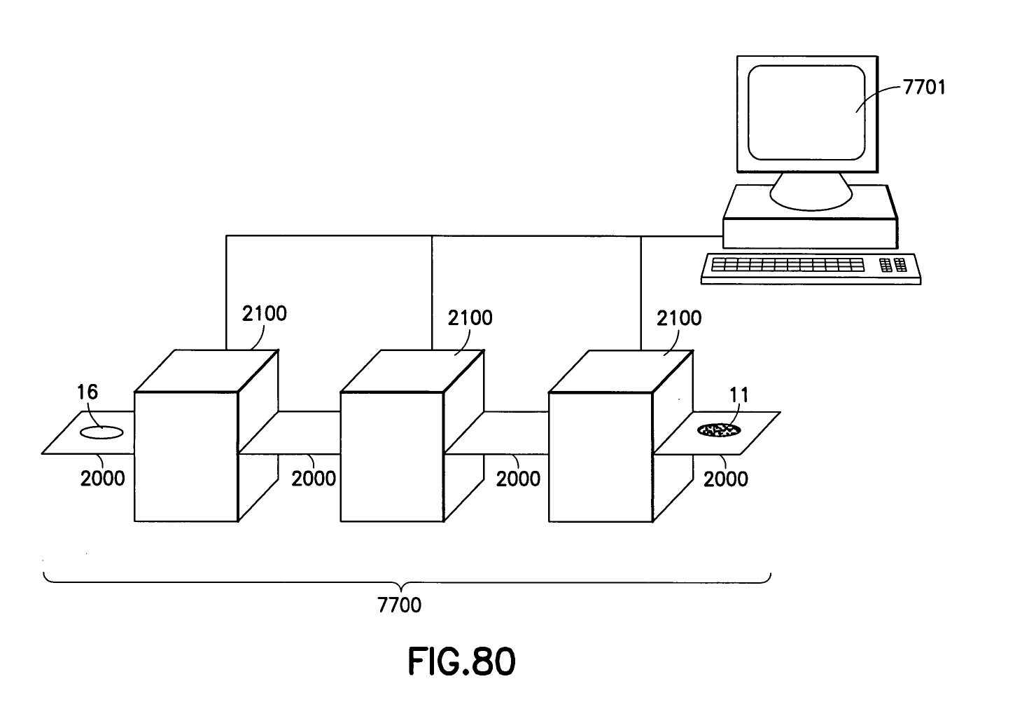

As one can imagine, aspects of the production system 2100, such as the components incorporated therein, can depend upon the design of the optical media 10, and the desired appearance of the marked optical media 11. A further example of a production system 7700, shown in FIG. 80, includes use of a series of production systems 2100, such as those shown in FIGS. 77 and 79. In this embodiment, a first production system 2100 is used to apply a first color forming layer 401, cure the layer 401, and then impart an image into the layer 401. A second production system 2100 applies a second color forming layer 402, cures the layer 402, and then imparts an image into the layer 402. A third production system 2100 applies a third color forming layer 403, cures the layer 403, and then imparts an image into the layer 403. Operation and other aspects of the production system 7700 may be governed by a system controller 7701 executing an instruction set (software), or through other techniques, such as manual operation. One example is an external personal computer 7701, connected to various other control systems 2101.

B. Exemplary Offline Production Equipment

In a further non-limiting embodiment, manual or semi-automated systems are used “offline” to manufacture coated optical media 10 and/or marked optical media 11. As one example of this embodiment, previously produced or commercially available optical media 8 are selected for receipt of a coating 100. A coating 100, as described herein, is applied to the optical media 8. The coating 100 process occurs in an environment where factors such as ambient dust or atmosphere are controlled as appropriate to limit contamination of the coating 100.

Examples of offline systems include systems such as those depicted in FIGS. 77-79, with the omission of the preliminary station 2110. In offline systems, steps are taken as described in the foregoing discussions to produce the coated optical media 10 and/or marked optical media 11 from existing optical media 8.

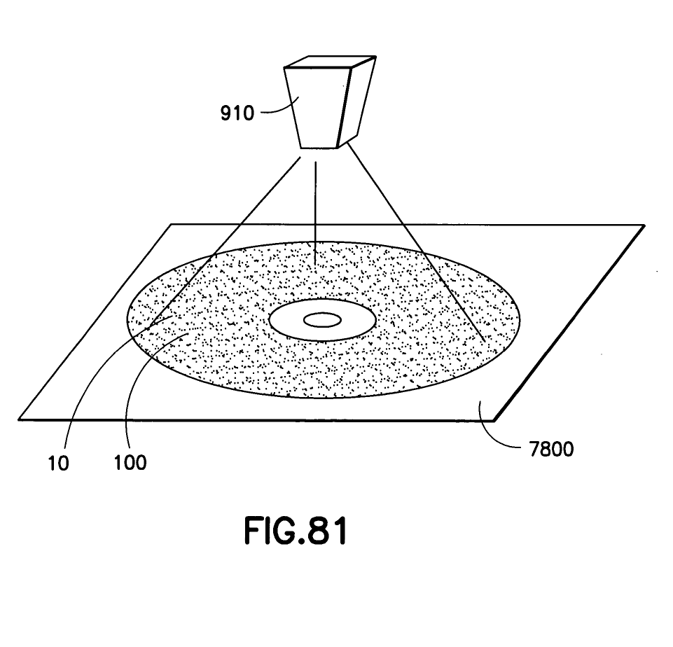

Manual or automated techniques are then used to align the coated optical media 10 with a curing light 910 for curing the coating 100. FIG. 81 depicts an embodiment of a curing station 7800 for manual curing. The coating 100 is then cured. The coated optical media 10 are then cooled or otherwise conditioned as appropriate. The coated optical media 10 then may enter a distribution chain, be directed to a marking station, or sidelined for subsequent marking by the manufacturer. Marking occurs in the manner described herein, and may involve use of photomask(s) 925, and/or direct writing lasers 920. The coated optical media 10 are thus in a prepared state for subsequent marking by the manufacturer, or others, such as a third party.

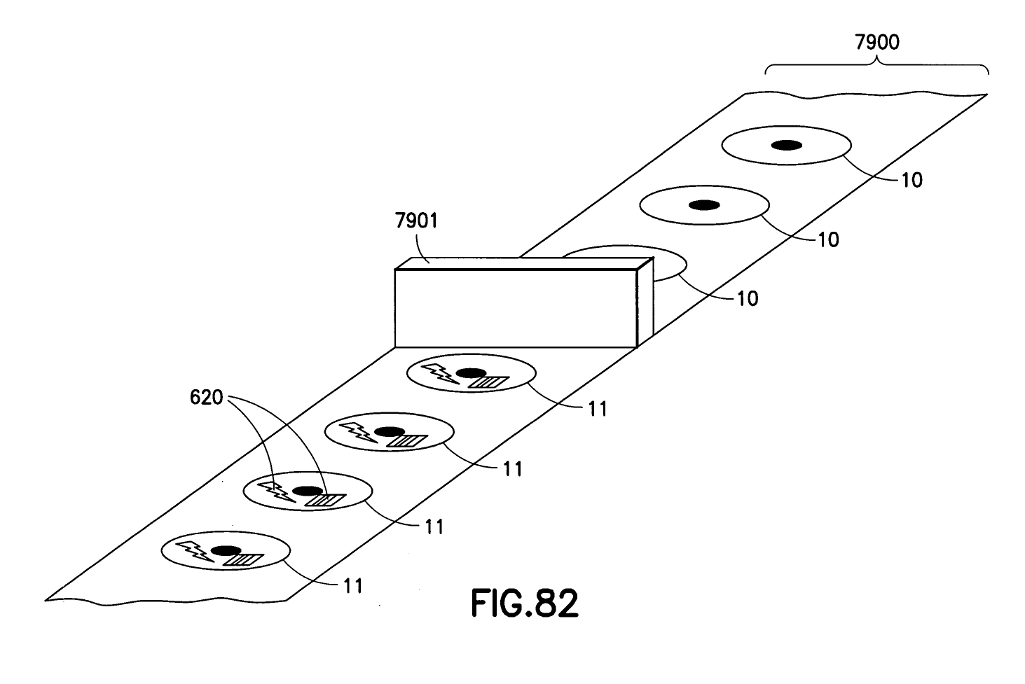

FIG. 82 provides an illustration of an offline marking technique, where coated optical media 10 are used to produce marked optical media 11. In this embodiment, the unmarked or “blank” coated optical media 10 are introduced into a production line 7900. The production line 7900, and equivalents thereto, are also referred to as a “station for receiving optical media 10.” The optical media 10 progress down the production line 7900 where an offline marking system 7901 containing at least a second light 920 is used to provide a marking 620 on the optical media 10. Other components in the offline marking system 7901 may include, but are not limited to, photomask equipment, alignment devices, a station for spin coating and curing of an overcoat layer 102, and other complimentary devices. A direct writing laser 920, and supporting equipment may be incorporated into the offline marking system 7901, in combination with or in place of a photomask. In some embodiments, the station for receiving optical media 7900 may simply be a tray having a fixed geometry in relation to the marking light 920.

Offline marking may occur at a variety of places within the distribution chain. For example, offline marking may be completed at the manufacturer of the optical media 10, a secondary manufacturing outlet, a commercial distributor, or by an end user. For example, prepared (coated) optical media 10 may be marked by a video rental store equipped with appropriate equipment. In this manner, the store operators may incorporate their own content, for example, promotional information, ownership information, or other information, such as terms of use. Accordingly, end users may also engage in marking their own optical media 10 through use of appropriate equipment. This feature may be attractive to small producers, or as a novelty to private users. Accordingly, in these further embodiments additional apparatus may be used for the marking of the optical media 10 and are within the contemplation of the invention disclosed herein. For example, an end user may be provided with an inexpensive kit, such as one containing software, a few sheets of an appropriate substrate for use in a laser printer to produce photomasks 925 from the software, and an appropriate light source (such as an array of diodes, or a black light) for use with the laser printer produced photomask 925.

C. Singulus Skyline Duplex Coating Parameters and Radial Noise

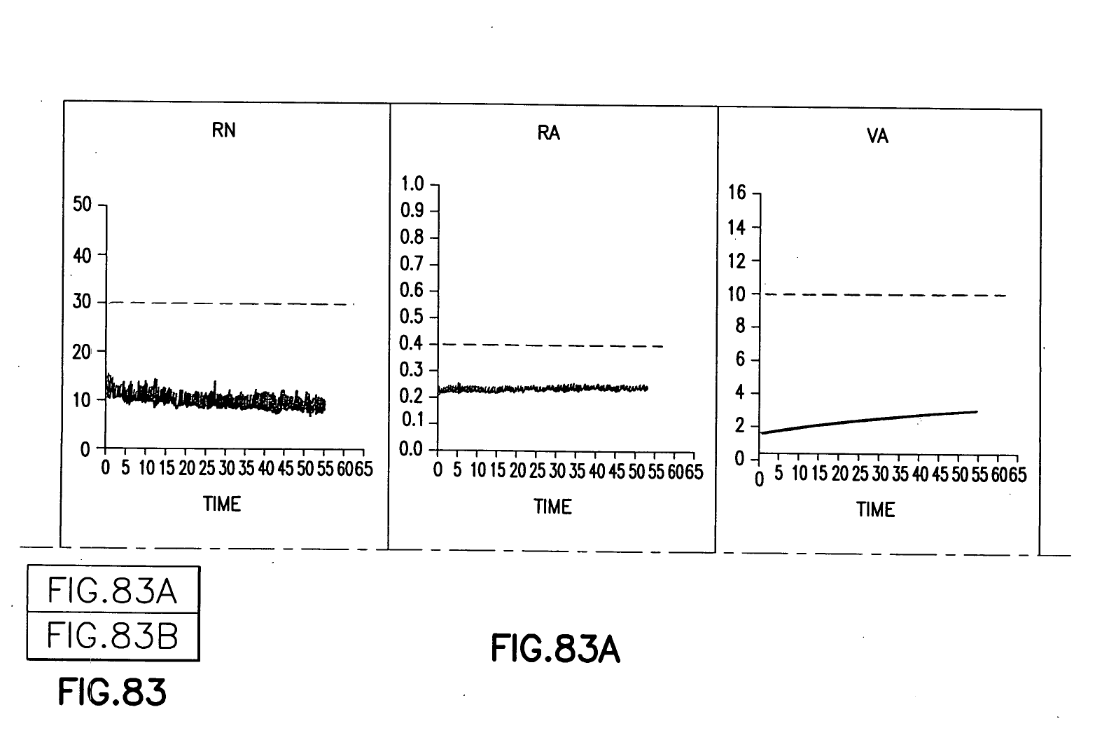

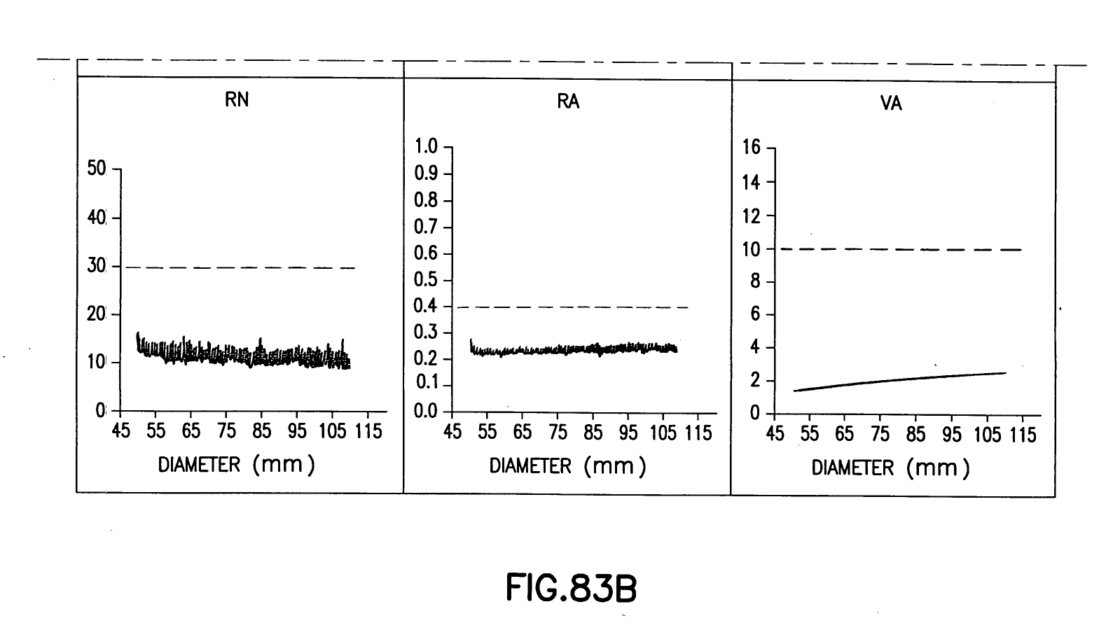

It was considered that the use of a commercial disc replication machine, such as the SKYLINE DUPLEX from Singulus Technology should allow for coating of discs within specifications, including radial noise. To test this, disks 10 were coated and cured with formulation 9021 using the Singulus SKYLINE DUPLEX machine. Subsequent evaluation showed that the coatings were within the radial noise specification of <30 nm. Measurements showed that the difference in radial noise between an uncoated disk and a coated disk using the Singulus SKYLINE DUPLEX machine was minimal. FIG. 83 depicts testing results from the CATS SA3 system for a disk 10 coated on the Singulus SKYLINE DUPLEX machine.

Analysis showed that the best coatings were obtained using a single spin and speed. The coating parameters used for the Singulus SKYLINE DUPLEX machine are given in Table 32. These settings can be applied to the application of either coating 101, 102, with coating 100 thickness controlled by lacquer viscosity or application temperature.

TABLE 32
Singulus Set Points for Disc Production
Set Points 1

| | Min | Max |
|---|---|---|
| Temperature | 20.00 | 40.00 |
| Lacquer Radius | 24.00 | 24.00 |
| Dosing Amount | 1.20 | 1.20 |
| Dosing Time | 0.50 | 0.50 |
| Time | 0.75 | 0.75 |
| Speed | 120 | 120 |
| Ramp Time | 0.45 | 0.3 |
| Time | 0.90 | 0.90 |
| Speed | 4500 | 4000 |
| Ramp Down Time | 0.25 | 0.25 |

D. Singulus SKYLINE DUPLEX and Lamp Curing

A study was completed to examine curing of coatings in the Singulus SKYLINE DUPLEX machine. In this study, the SKYLINE DUPLEX machine was loaded with the formulation Overcoat O1 and various lamps were tested for top and edge curing. A XENON C Bulb was used, and set at an exposure power of 1.0 kW. Exposed disks 10 were completely top and edge cured in 2.0 seconds. Time intervals of 1.0 seconds and 1.5 seconds were also evaluated, and did not cure the disks 10 sufficiently. The reflector plate on the paddle of the machine was blacked out using a felt-tip marker. Disks 10 were again evaluated, in otherwise same conditions with no apparent difference. The disks 10 cured top and edge completely.

An F-Bulb with metallized reflectors was also evaluated. Controls for the F-Bulb were set to the maximum exposure power of 5.0 kW and the maximum exposure time of 5.0 seconds. The exposed disks 10 did not top or edge cure. Next, a V-Bulb (gallium iodide) with metallized reflectors was evaluated. Controls for the V-Bulb were set to the maximum exposure power of 5.0 kW and the maximum exposure time of 5.0 seconds. Disks 10 did not top or edge cure sufficiently.

Variation on the formulation for overcoat O1 were evaluated. In these tests, the overcoat O1 formulation was made substituting a percentage of photoinitiator KTO/46 with Irgacure 819. Four formulations were made, as shown in Table 33.

TABLE 33
Variations on Photoinitiator Combinations in Overcoat O1

| Form. No. | Photoinitiator Combination |
|---|---|
| 1 | 5% KTO/46 and 3% Irgacure 819 |
| 2 | 3% KTO/46 and 5% Irgacure 819 |
| 3 | 2% KTO/46 and 6% Irgacure 819 |
| 4 | 1% KTO/46 and 7% Irgacure 819 |

The formulations of Table 33 were manually coated onto disks 10 using the HEADWAY spin coating machine. These were tested for curing at various time intervals on the SKYLINE DUPLEX machine using the V-Bulb (gallium iodide). Results are as provide in Table 34 (“NG” represents “no good”). All disks were completely edge cured, with the reflector remaining blackened.

TABLE 34
Curing Times for Overcoat O1 Variations

| Over-1 | Curing V-Bulb (gallium iodide) | | | | |
|---|---|---|---|---|---|
| photo-formulation | 1 sec | 2 sec | 3 sec | 4 sec | 5 sec |
| 5% KTO/3% 819 | | NG | | | OK |
| 3% KTO/5% 819 | | NG | good | excellent | |
| 2% KTO/6% 819 | NG | Ok | excellent | | |
| 1% KTO/7% 819 | NG | good | excellent | | |

Table 35 and Table 36 disclose preferred embodiments of the overcoat layer 102, and the color forming layer 101, respectively.

TABLE 35
Preferred Embodiment for Overcoat Layer

| OVERCOAT FORMULATION 14 | Wt % |
|---|---|
| COMPONENTS | |
| TEGO RAD 2200 N | 1 |
| KTO/46 | 8 |
| SR-339 | 26 |
| SR-368D | 20 |
| CN-120M50 | 45 |
| TOTAL | 100 |
| PIGMENTS | |
| UV-24 | 10 |

TABLE 36
Preferred Embodiment for Color Forming Layer

| COLOR FORMING LAYER | |
|---|---|
| FORMULATION C15 | Wt % |
| BYK-333 | 0.3 |
| KTO/46 | 10 |
| SR-238 | 10 |
| SR-285 | 15 |
| SR-494 | 32.35 |
| SR-9021 | 32.35 |
| TOTAL | 100 |
| PIGMENTS | |
| TPST | 3 |
| Pergascript Red 6B | 3 |

It can thus be appreciated that while the invention has been particularly shown and described with respect to preferred embodiments thereof, it will be understood by those skilled in the art that changes in form and details may be made therein without departing from the scope and spirit of the invention. For example, many variations may be undertaken in methods and apparatus for the application of the coating, the curing, the marking, and the quality control of the marking. Such examples include performing various steps in sequences other than disclosed herein, or performing certain steps, such as spin coating and curing in batches. It is considered that the techniques for the development of the overcoat and the color forming layers, as described herein, lend themselves to producing many other formulations suited for practice of this invention. Therefore, while the invention has generally been described in terms of the embodiments described herein, and variations thereof, this disclosure encompasses those embodiments and others not disclosed or only suggested herein.

1. A system for applying a marking to an optical media, the system comprising:
a unit for applying a coating comprising at least one photosensitive material to at least one readout area of the optical media;
a first light source for exposing the coating to wavelengths of light wherein the wavelengths of light cure the coating upon the at least one readout area;
a unit for creating an image of the marking; and,
a second light source for exposing at least a portion of the coating to the image for recording the marking into the coating.

2. The system as in claim 1, wherein the wavelengths produced by the first light source comprise wavelengths substantially separate from wavelengths of the second light source.

3. The system as in claim 1, wherein at least one of the first light source and the second light source comprise a wavelength filter.

4. The system as in claim 3, wherein the wavelength filter comprises a wavelength cutoff filter rated for wavelengths between about 340 nm to about 370 nm.

5. The system as in claim 1, wherein the coating comprises at least one each of a photoinitiator, a photoacid generator and a color former.

6. The system as in claim 5, wherein the photoinitiator comprises at least one of: a stable liquid mixture of trimethylbenzoyldiphenylphosphine oxide, α-hydroxyketones, and benzophenone derivatives; 2-Benzyl-2-dimethylamino-1-(4-morpholinophenyl)-butanone-1; Bis(2,4,6-trimethylbenzoyl)-phenylphosphineoxide; an eutectic liquid mixture of: 2,4,6 trimethylbenzophenone and 4 methylbenzophenone; a mixture of 50% 2,4,6-Trimethylbenzoyl-diphenyl-phosphineoxide and 50% 2-Hydroxy-2-methyl-1-phenyl-propan-1-one; 1-[4-(2-Hydroxyethoxy)-phenyl]-2-hydroxy-2-methyl-1-propane-1-one; isopropyl thioxanthone; a liquid mixture of about 70% Oligo [2-hydroxy-2-methyl-1-[4-(1-methylvinyl) phenyl] propanone and about 30% 2-hydroxy-2-methyl-1-phenyl propan-1-one.

7. The system as in claim 5, wherein the photoacid generator comprises at least one of: bis (4-tert-butylphenyl) iodonium p-toluenesulfonate; (tert-butoxycarbonylmethoxynaphthyl) diphenyl sulfonium triflate; (4-phenoxyphenyl) diphenyl sulfonium triflate; (4-tert-Butylphenyl) diphenyl sulfonium triflate; diphenyliodonium hexafluorophosphate; diphenyliodonium triflate; triphenylsulfonium triflate; 2-methyl-4,6-bis(trichloromethyl)-s-triazine; tris(2,4,6-trichloromethyl)-s-triazine; 2-phenyl-4,6-bis(trichloromethyl)-s-triazine; 2-(4-chlorophenyl)-4,6-bis(trichloromethyl)-s-triazine; (4-methylphenyl)diphenyl sulfonium triflate; and, diphenyl iodonium hexafluorophosphate.

8. The system as in claim 5, wherein the color former comprises at least one of COPIKEM 16 Red, COPIKEM 6 Green, COPIKEM 34 Black, PERGASCRIPT Red I-6B, BK-305 Black, S-205 Black, BK-400, PERGASCRIPT Orange I-G, PERGASCRIPT Green I-2GN, PERGASCRIPT Blue I-2RN, PERGASCRIPT Black I-2R and Red 520.

9. The system as in claim 5, wherein the coating further comprises a wetting agent.

10. The system as in claim 9, wherein the wetting agent comprises at least one of a polyether modified poly-dimethyl-siloxane; a crosslinkable silicone polyether acrylate; and a crosslinkable silicone acrylate.

11. The system as in claim 1, wherein the coating comprises a mixture comprising at least one acrylate.

12. The system as in claim 11, wherein the acrylate comprises at least one of: ethoxylated pentaerythritol tetraacrylate; 1,6 hexanediol diacrylate; tetrahydrofurfuryl acrylate; highly propoxylated (5.5) glyceryl triacrylate; 3 mole propoxylated glyceryl triacrylate; 3 mole ethoxylated trimethylolpropane triacrylate; tris (2-hydroxy ethyl) isocyanurate triacrylate; ditrimethylolpropane tetraacrylate; urethane diacrylate oligomer; isobornyl acrylate; a difunctional bisphenol A based epoxy acrylate; a low viscosity aliphatic diacrylate oligomer; tris (2-hydroxy ethyl) isocyanurate triacrylate; 2-phenoxyethyl acrylate; a difunctional bisphenol A based epoxy acrylate blended with 40% 1,6 hexanediol diacrylate; a difunctional bisphenol A based epoxy acrylate blended with 50%, 2-phenoxyethyl acrylate; and acrylic acid.

13. The system as in claim 11, wherein the acrylate comprises at least one non-alkoxylated monomer.

14. The system as in claim 1, further comprising a unit for applying a photoabsorptive material to the coating.

15. The system as in claim 1, wherein the coating comprises at least one of: 2,4-di-tert-butyl-6-(5-chlorobenzotria zol-2-yl) phenol; 2-(2H-benzotriazol-2-yl)-6-dodecyl-4-methyl-phenol; a mixture of reaction products of methyl 3-(3-(2H-benzotraizole-2-yl)-5-t-butyl-4-hydroxyphenyl) proprionate and PEG 300; branched and linear 2-(2H-benzotriazol-2-yl)-6-dodecyl-4-methylphenol; 2-(2′hydroxy-5′methacryloxyethylphenyl)-2H-benzotriazole; 2,2′-dihydroxy-4-methoxybenzophenone; 2-Hydroxy-4-n-octoxybenzophenone; and, octyl methoxycinnamate.

16. The system as in claim 1, wherein the system comprises an optical media replication system.

17. The system as in claim 1, wherein the format of the optical media comprises one of DVD 5, DVD 9, DVD 10, DVD 18, DVD-R, DVD-RW, CD-Audio, CD-Video, CD-R, CD-RW, CD-ROM, CD-ROM/XA, CD-i, CD-Extra, CD-Photo, Super-Audio CD, Blu-Ray, Mini-Disc and a hybrid format.

18. The system as in claim 1, wherein the applying unit comprises at least one spin coating station.

19. The system as in claim 1, wherein the image creating unit comprises a photomask comprising an image of the marking.

20. The system as in claim 1, wherein the image creating unit comprises a direct writing laser for forming an image of the marking.

21. The system as in claim 1, wherein the image creating unit comprises an electronically programmable photomask for forming an image of the marking.

22. The system as in claim 1, further comprising an inspection station for inspecting the quality of at least one of the substrate, the coating, the curing of the coating, and the marking in the coating.

23. The system as in claim 1, wherein the coating is applied to one of the substrate layer, the reflective layer, and the protective layer of the optical media.

24. The system as in claim 1, further comprising a system controller for operating the system.

25. The system as in claim 1, wherein the marking comprises at least one of: text information, alphanumeric characters, symbols, graphic information, embedded information, a digital watermark and a covert marking.

26. The system as in claim 1, wherein the marking comprises at least one of identification information, authentication information, instructional information, advertising, branding, and promotional information.

27. A system for applying a color forming coating to the readout area of an optical media, the system comprising:
a unit for applying the color forming coating to the readout area of the optical media, the coating comprising a photocurable component sensitive to a first set of wavelengths and a photosensitive color forming component sensitive to a second set of wavelengths substantially separate from the first set of wavelengths;
a light source for exposing the coating to the first set of wavelengths.

28. A system for marking the readout area of an optical media, the system comprising:
a station for receiving the optical media, the optical media comprising at least a color forming coating disposed thereon, the coating comprising a photocurable component sensitive to a first set of wavelengths and a photosensitive color forming component sensitive to a second set of wavelengths substantially separate from the first set of wavelengths, a unit for creating an image of a marking; and,
a light source for producing the second set of wavelengths and exposing at least a portion of the coating to the image for recording the marking into the coating.

29. The system as in claim 28, further comprising a unit for applying an overcoat over the color forming coating.

30. A method for marking a readout area of an optical media, comprising:
applying a coating comprising at least one color forming material to the readout area of the optical media;
exposing the coating to a first set of wavelengths;
curing the coating applied upon the at least one readout area;
selectively exposing portions of the coating in a pattern for recording the marking into the coating by using a second set of wavelengths substantially separate from the first set of wavelengths.

31. The method as in claim 30, wherein applying the coating comprises spincoating the coating onto the optical media.

32. The method as in claim 30, wherein applying comprises controlling the temperature of the color forming material.

33. The method as in claim 30, wherein applying comprises controlling the viscosity of the coating.

34. The method as in claim 30, wherein applying comprises controlling the thickness of the coating.

35. The method as in claim 30, wherein applying comprises replacing a component layer of the optical media.

36. The method as in claim 30, wherein curing comprises providing an environment comprising an inert gas.

37. The method as in claim 30, wherein the first set of wavelengths comprises wavelengths above about 370 nm.

38. The method as in claim 30, wherein the second set of wavelengths comprises wavelengths between about 270 nm to about 320 nm.

39. The method as in claim 30, wherein selectively exposing comprises using at least one of a photomask and a direct writing laser.

40. The method as in claim 30, wherein applying a coating further comprises applying at least one photoabsorptive material.

41. A computer program stored on computer readable media comprising a set of instructions for operation of a system for producing optical media comprising at least one marking disposed upon the readout side of the optical media, the instructions for:
applying a coating comprising at least one color forming material to the readout area of the optical media;
exposing the coating to a first set of wavelengths;
curing the coating applied upon the at least one readout area;
selectively exposing portions of the coating in a pattern for recording the marking into the coating by using a second set of wavelengths substantially separate from the first set of wavelengths.

42. The computer program as in claim 41, wherein the instructions for operation are executed by a system controller adapted for controlling the operation of the system.

43. The computer program as in claim 41, wherein the instructions for operation comprise instruction for operation of at least one of an inspection station, a spincoating station, a curing station and a marking station.

44. A system for applying a marking to an optical media, the system comprising:
a unit for applying at least one color forming layer to at least one readout area of the optical media;
a first light source for exposing the at least one color forming layer to a first band of wavelengths to cure the at least one color forming layer;
a second light source for selectively exposing at least a portion of the at least one color forming layer to a second band of wavelengths for recording the marking into the at least one color forming layer;
a unit for applying at least one overcoat layer to the at least one color forming layer; and,
a third light source for exposing the at least one overcoat layer to a third band of wavelengths for curing the at least one overcoat layer.

45. The system as in claim 44, wherein the overcoat layer comprises at least one of a photoabsorptive material and an acid scavenger.

46. The system as in claim 44, wherein the at least one overcoat layer exhibits a high degree of optical density at the second band of wavelengths.

47. A method for applying a marking to an optical media, the method comprising:
applying at least one color forming layer to at least one readout area of the optical media;
exposing the at least one color forming layer to a first band of wavelengths to cure the at least one color forming layer;
selectively exposing at least a portion of the at least one color forming layer to a second band of wavelengths for recording the marking into the at least one color forming layer;
applying at least one overcoat layer to the at least one color forming layer; and,
exposing the at least one overcoat layer to a third band of wavelengths for curing the overcoat layer.
